(19) United States
(12) Patent Application Publication
(10) Pub. No.: US 2022/0284182 A1
(43) Pub. Date: Sep. 8, 2022

(54) APPARATUS AND METHOD FOR FORMING PIVOT TABLES FROM PIVOT FRAMES

(71) Applicant: Finicast, Inc., Foster City, CA (US)

(72) Inventors: Cesar LEE, San Mateo, CA (US); Marco SANTIAGO, San Mateo, CA (US); Richard MAN, San Mateo, CA (US); Serena DO, San Mateo, CA (US); George KING, San Mateo, CA (US)

(21) Appl. No.: 17/669,274

(22) Filed: Feb. 10, 2022

Related U.S. Application Data
(60) Provisional application No. 63/154,412, filed on Feb. 26, 2021.

(51) Int. Cl. G06F 40/18

(52) U.S. Cl. CPC G06F 40/18

(57) ABSTRACT

A non-transitory computer readable storage medium has instructions executed by a processor to ingest source data tables received from a network connected source data machine. A pivot frame is derived from the source data tables. The pivot frame has an index column with index column values representing each unique combination of records in the source data tables, pivot dimension columns forming a deterministic matrix where each row of the deterministic matrix represents a unique combination of records in the source data tables, and a value column with individual values assigned to corresponding index column values. A definition of a desired pivot table is received from a network connected client machine. Pivot values are retrieved from the pivot frame that fulfill the definition of the desired pivot table to form a pivot table with unique pivot table row and column values. Index column values are associated with the unique pivot table row and column values. The pivot table is supplied to the network connected client machine.

### CROSS-REFERENCE TO RELATED APPLICATION

This application claims priority to U.S. Provisional Patent Application Ser. No. 63/154,412, filed Feb. 26, 2021, the contents of which are incorporated herein by reference.

### FIELD OF THE INVENTION

This invention relates generally to analyzing data in a computer network. More particularly, this invention is directed to techniques for forming pivot tables from pivot frames.

### BACKGROUND OF THE INVENTION

In the field of analytical data modeling, a “pivot table” is a powerful tool that can provide insights to the underlying data. A pivot table is a table of statistics that summarizes the data of a more extensive table (such as from a database, spreadsheet, or business intelligence program). This summary might include sums, averages, or other statistics, which the pivot table groups together in a meaningful way.

Existing pivot table implementations stay within the confines of aggregating rows of data from a single table and presenting them in another table (the “pivot table”) with limitations on how to aggregate the data and limited presentation and manipulation possibilities of the pivot table once it is created.

Thus, there is a need for improved mechanisms for forming pivot tables.

### SUMMARY OF THE INVENTION

A non-transitory computer readable storage medium has instructions executed by a processor to ingest source data tables received from a network connected source data machine. A pivot frame is derived from the source data tables. The pivot frame has an index column with index column values representing each unique combination of records in the source data tables, pivot dimension columns forming a deterministic matrix where each row of the deterministic matrix represents a unique combination of records in the source data tables, and a value column with individual values assigned to corresponding index column values. A definition of a desired pivot table is received from a network connected client machine. Pivot values are retrieved from the pivot frame that fulfill the definition of the desired pivot table to form a pivot table with unique pivot table row and column values. Index column values are associated with the unique pivot table row and column values. The pivot table is supplied to the network connected client machine.

### BRIEF DESCRIPTION OF THE FIGURES

The invention is more fully appreciated in connection with the following detailed description taken in conjunction with the accompanying drawings, in which:

FIG. 1A illustrates a system configured in accordance with an embodiment of the invention.

FIG. 1B illustrates processing operations performed in accordance with an embodiment of the invention.

FIG. 1C illustrates a pivot frame configured in accordance with an embodiment of the invention.

FIG. 2 illustrates a horizontal pivot header in accordance with an embodiment of the invention.

FIG. 3 illustrates a vertical pivot header in accordance with an embodiment of the invention.

FIG. 4 illustrates data processed in accordance with an embodiment of the invention.

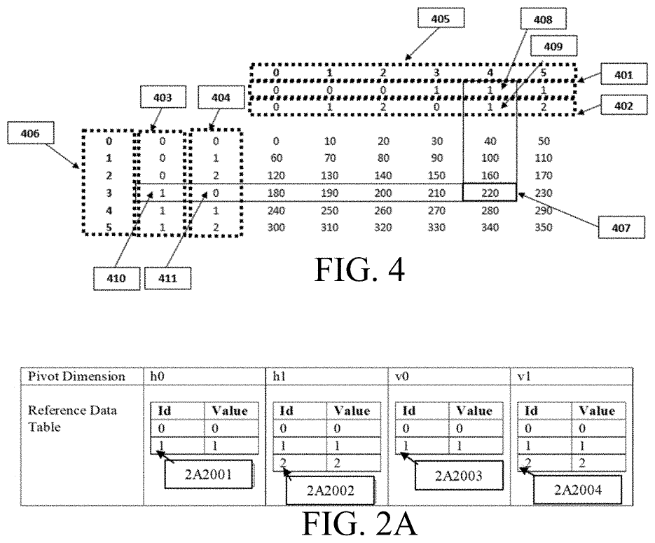

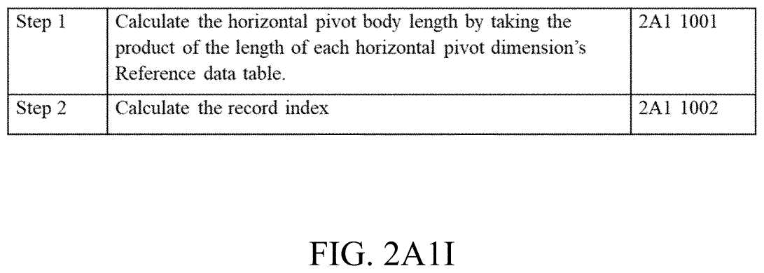

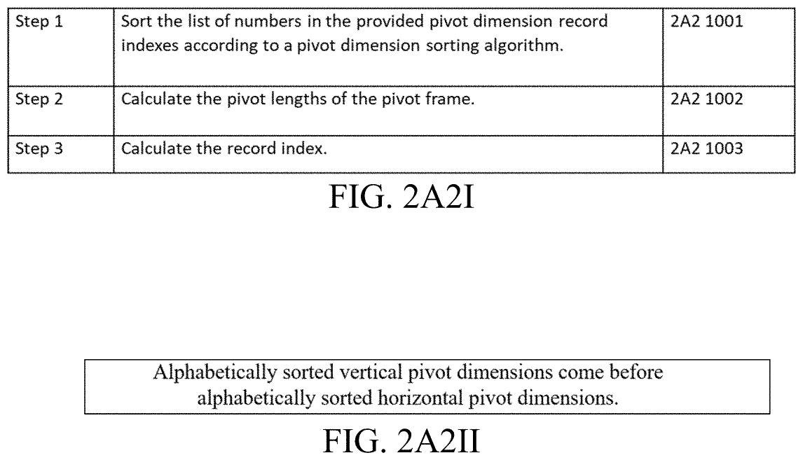

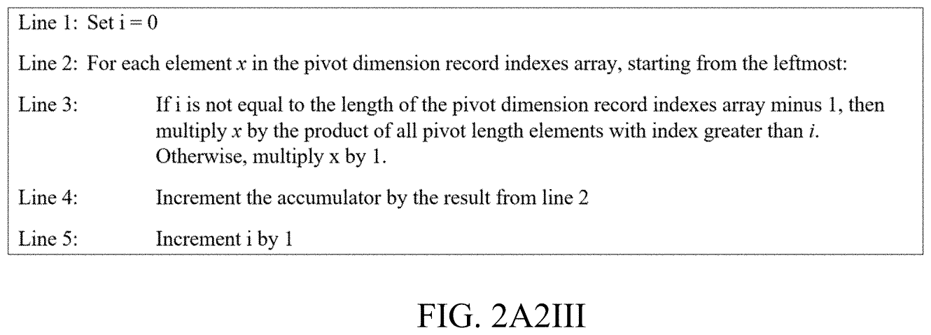

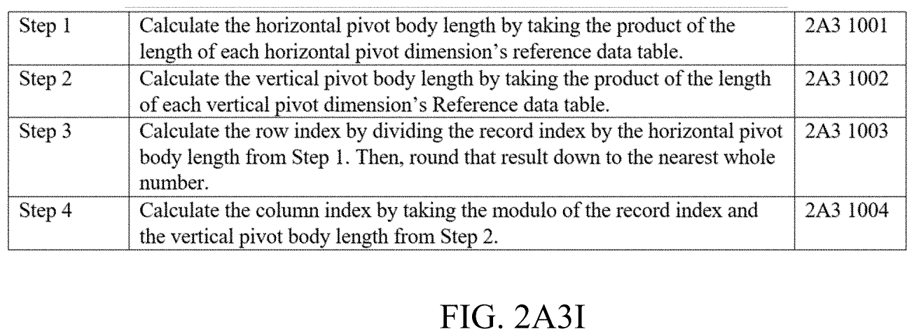

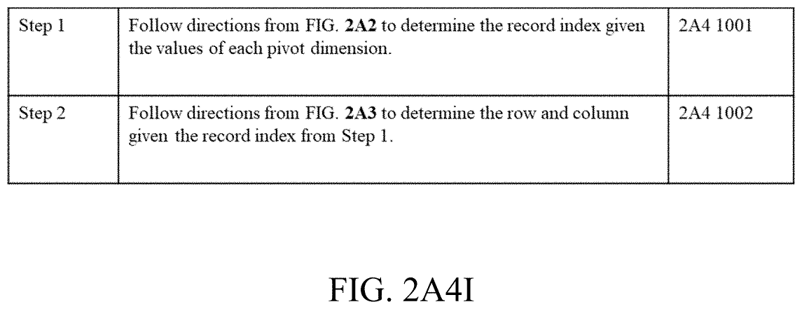

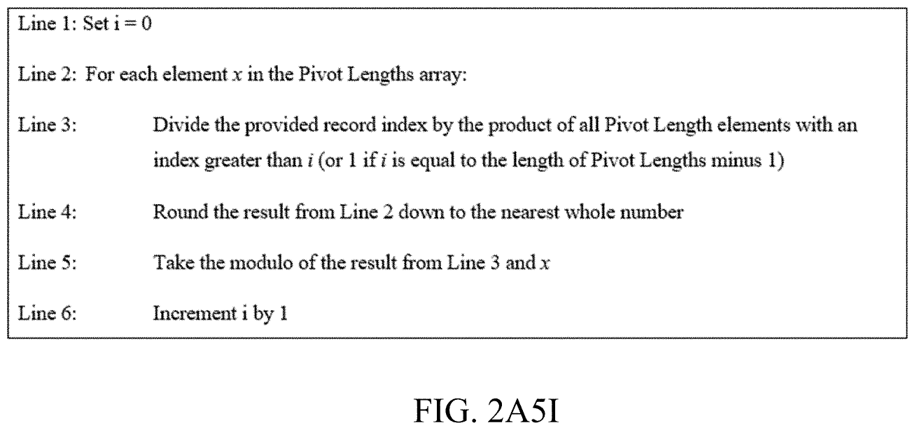

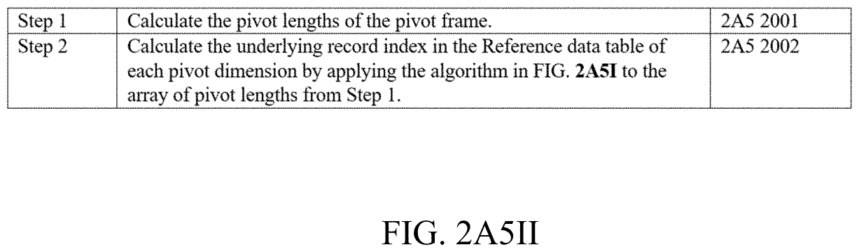

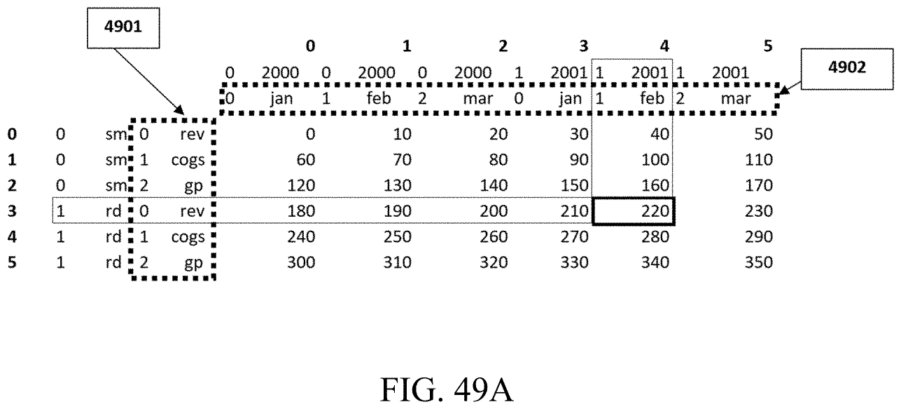

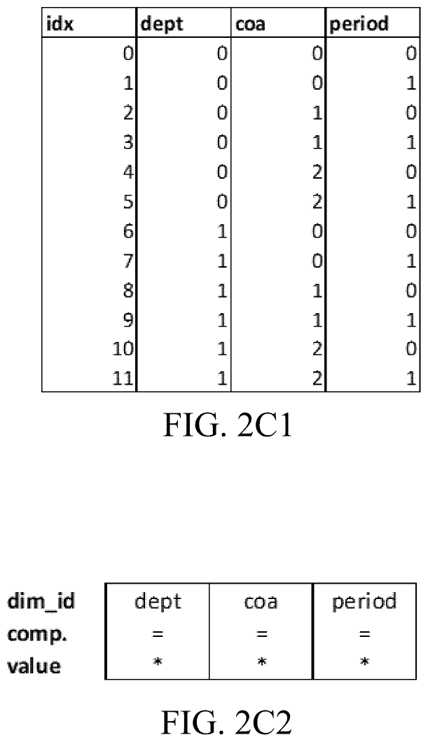

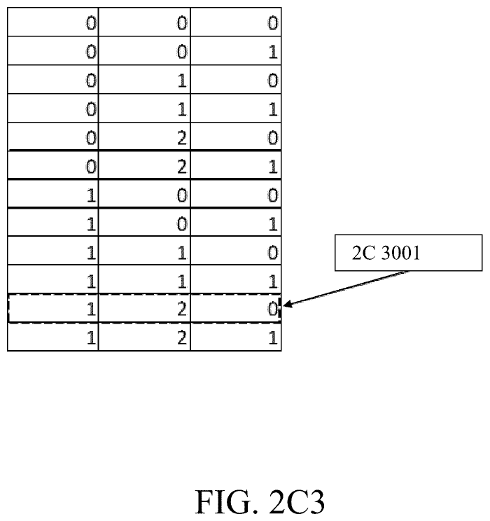

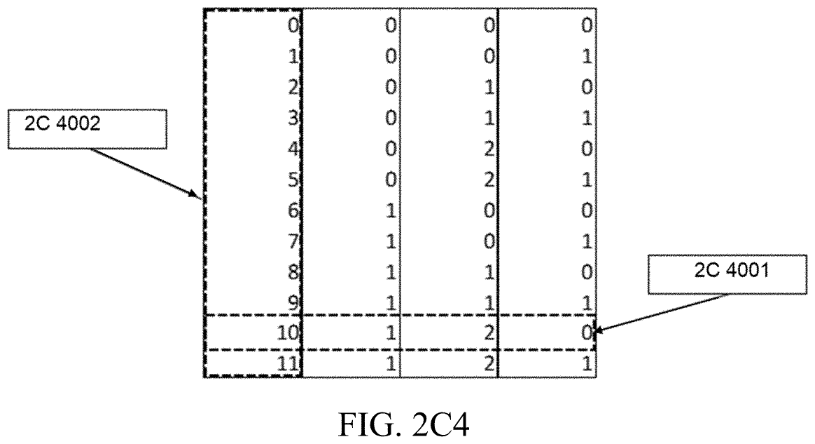

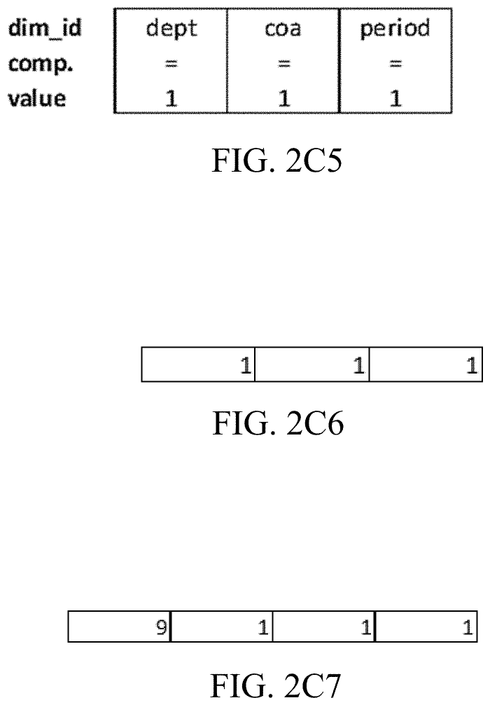

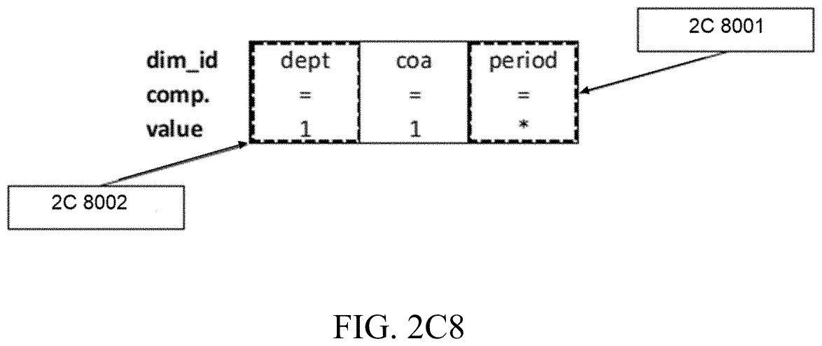

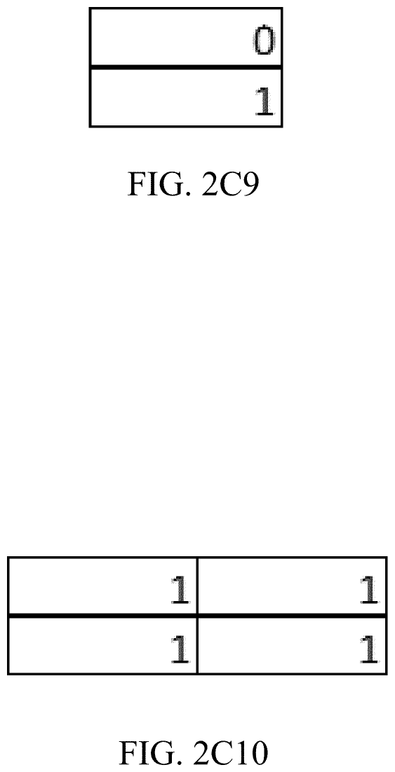

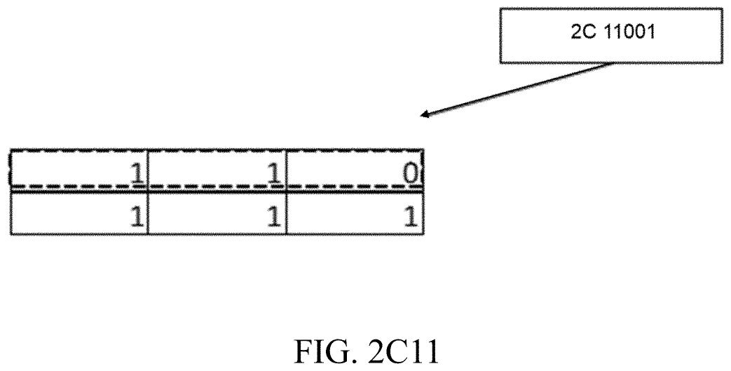

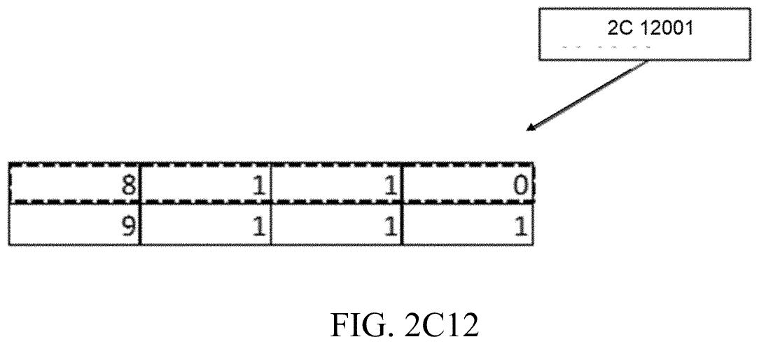

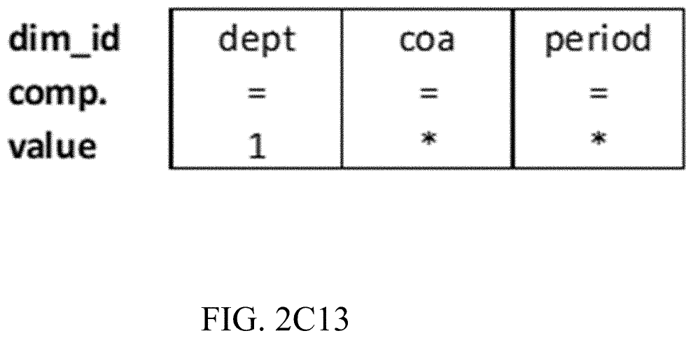

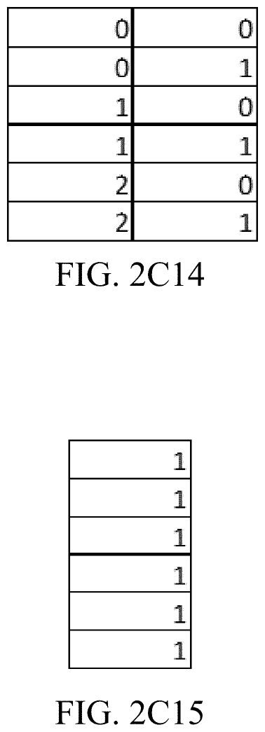

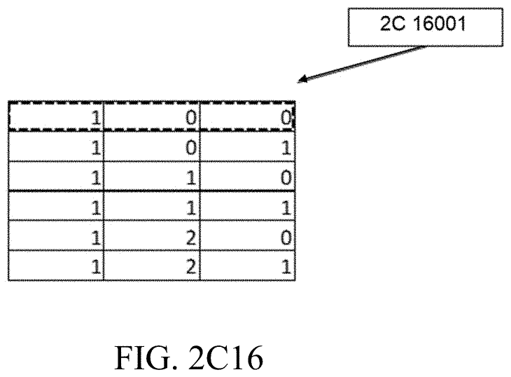

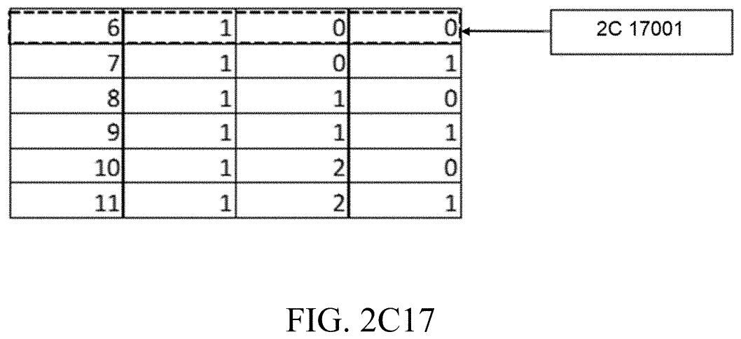

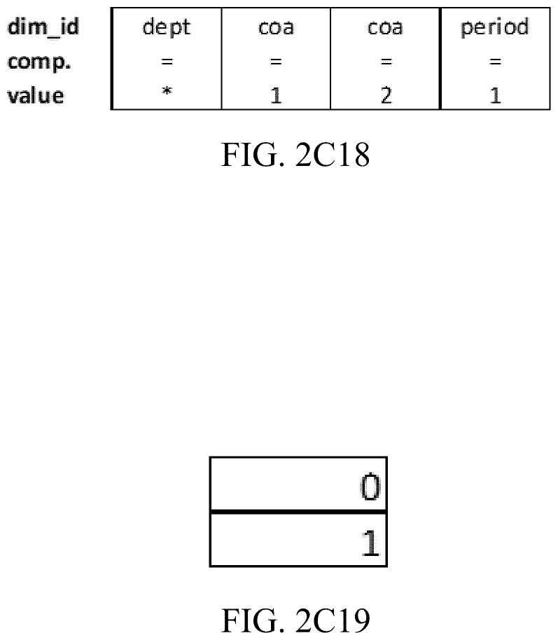

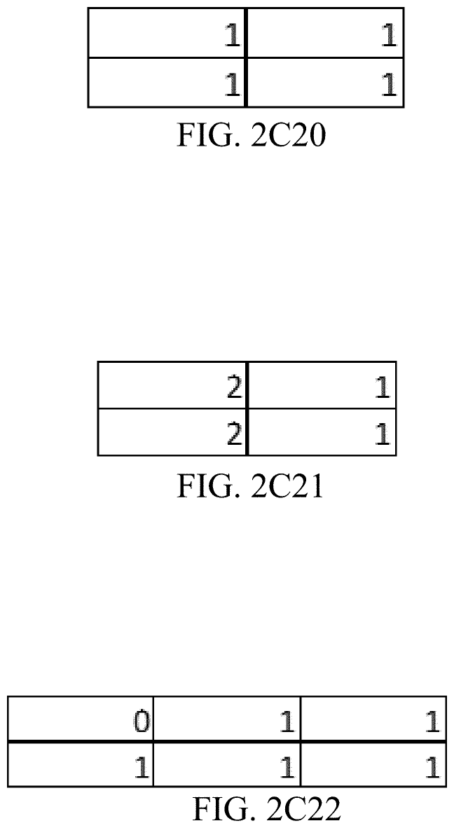

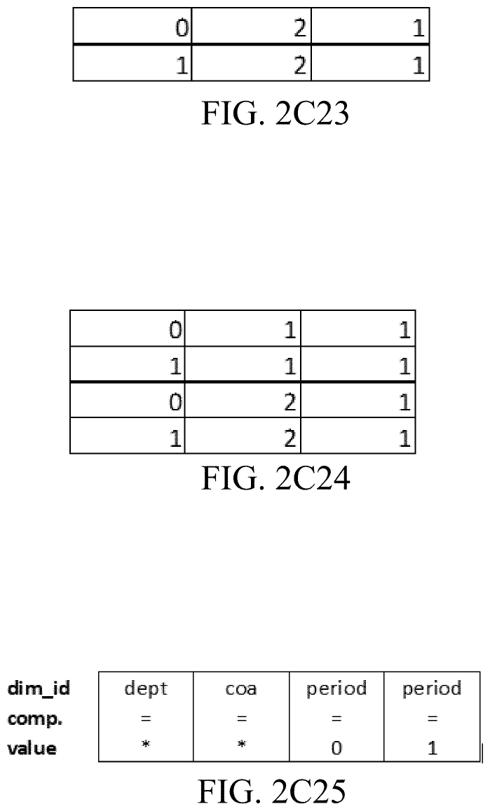

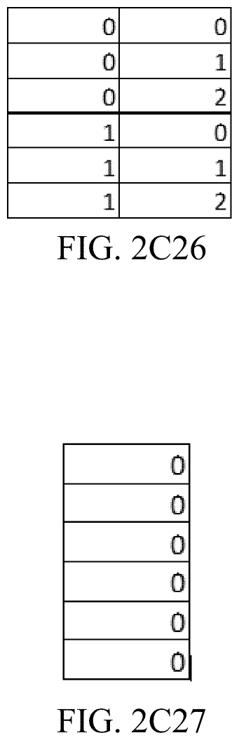

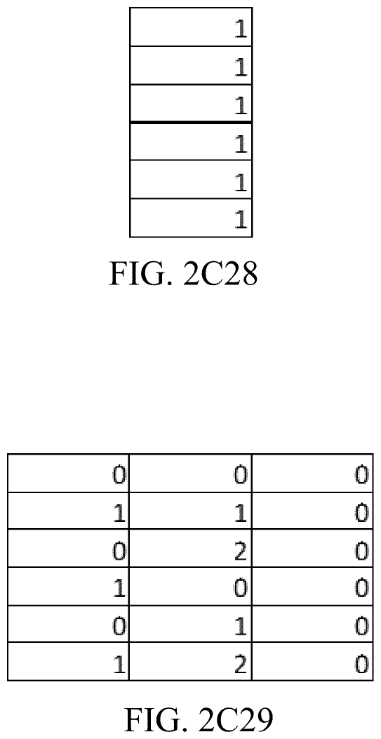

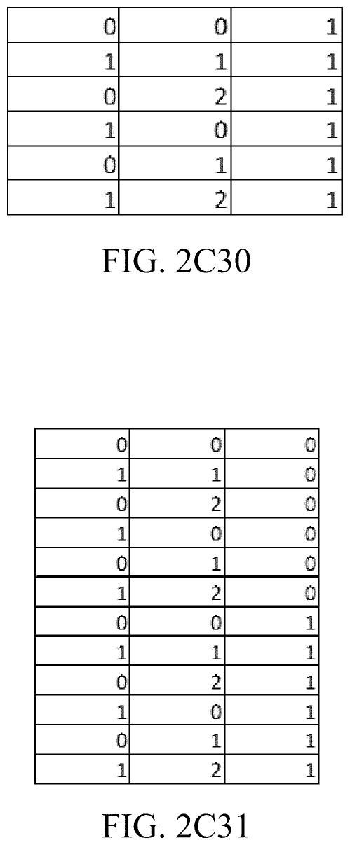

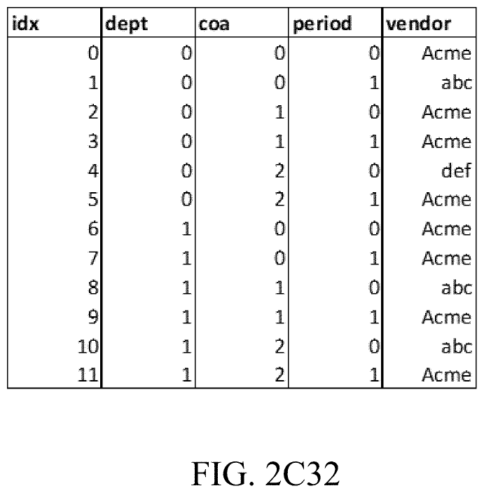

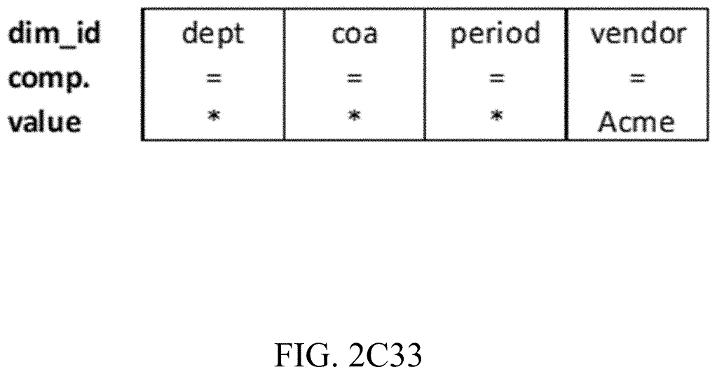

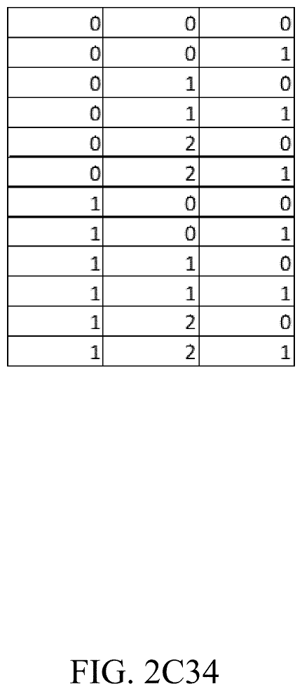

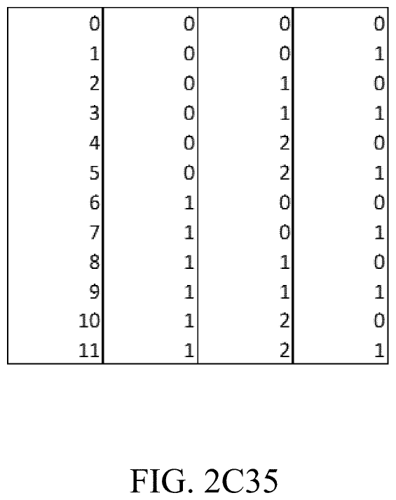

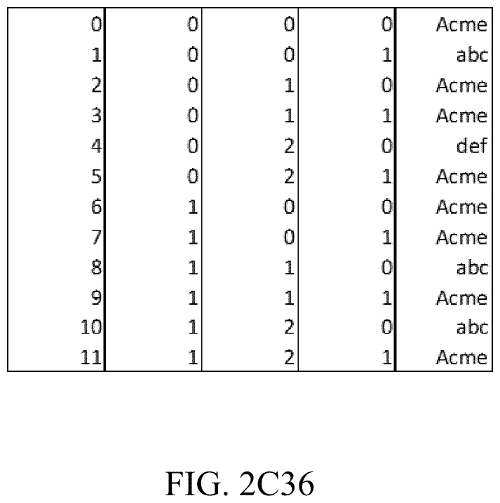

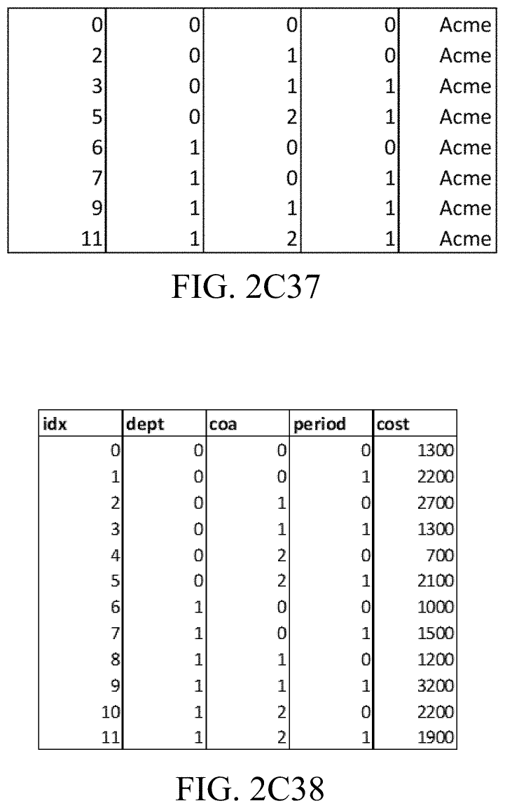

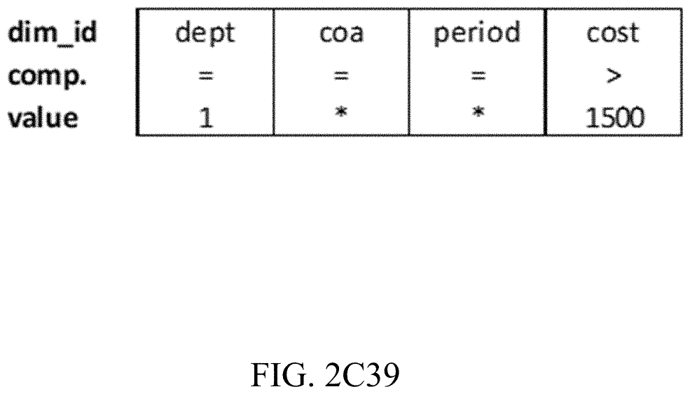

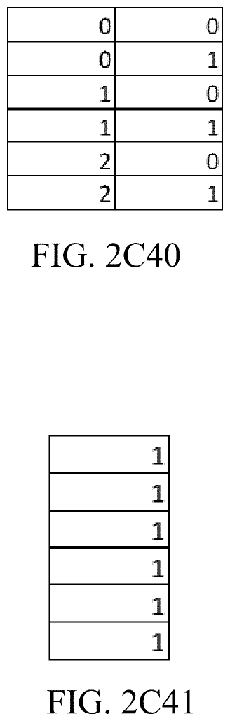

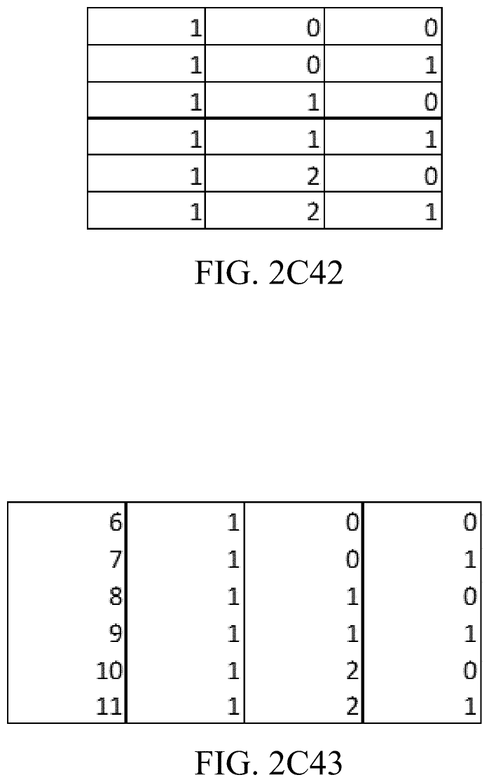

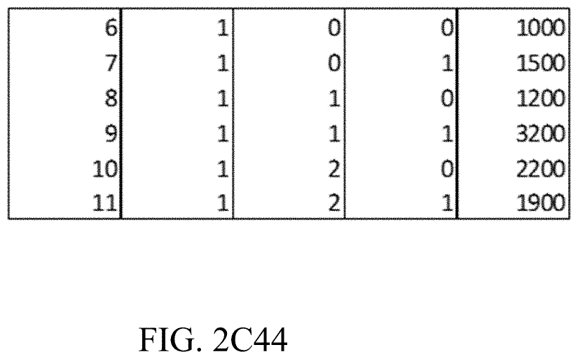

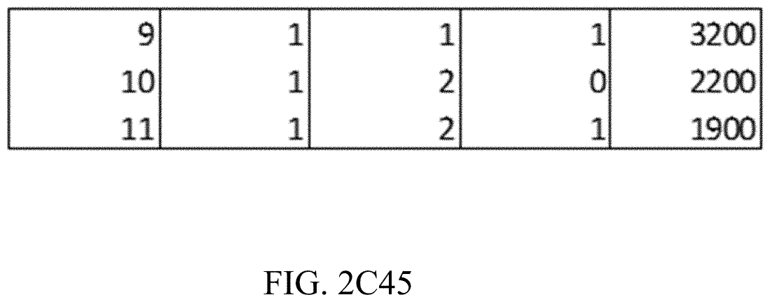

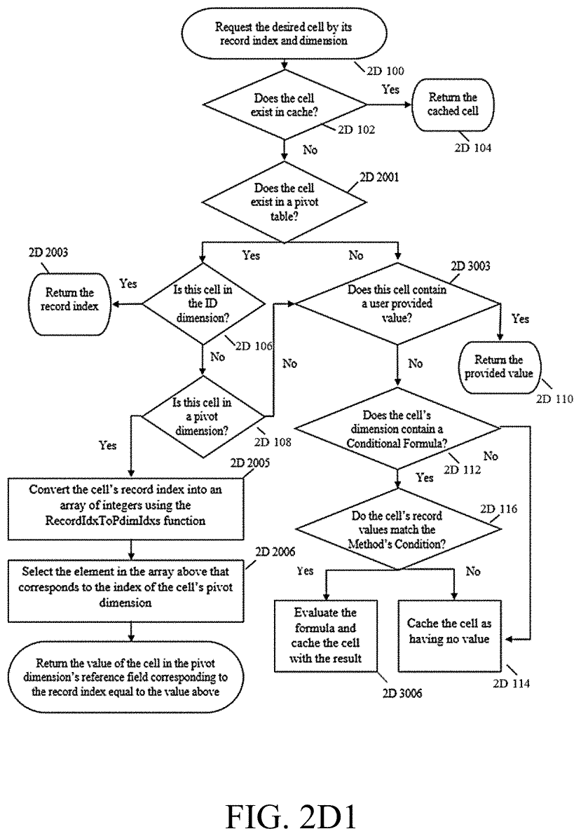

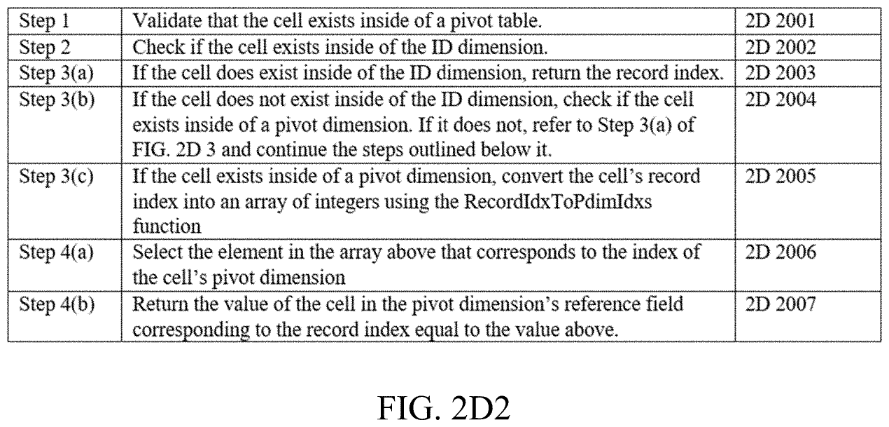

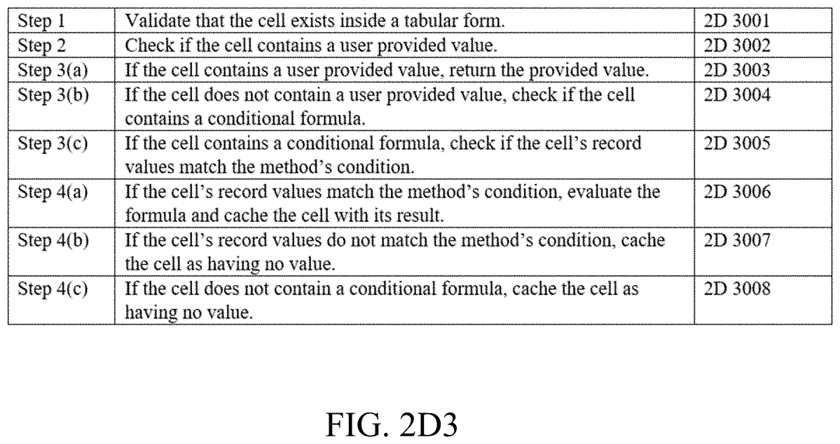

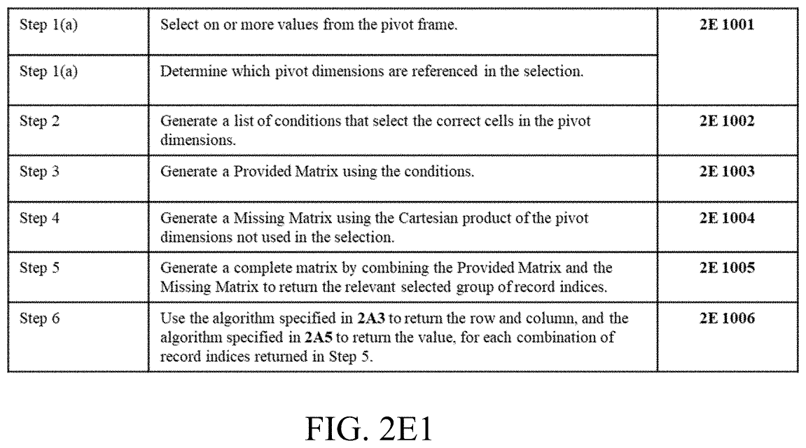

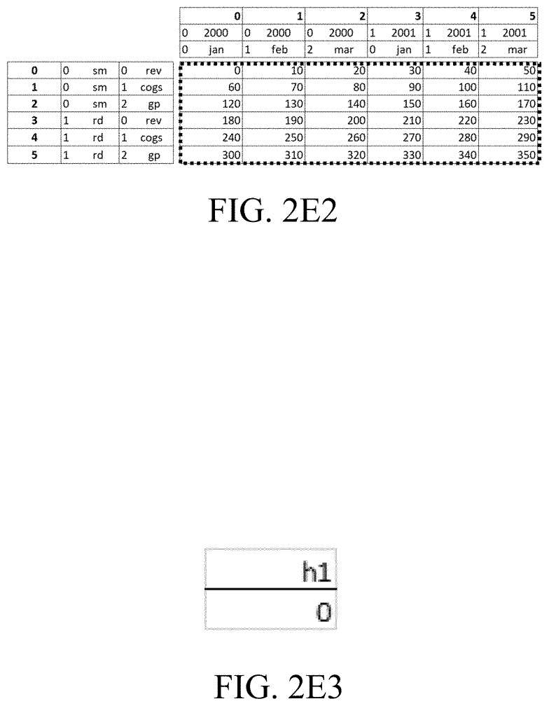

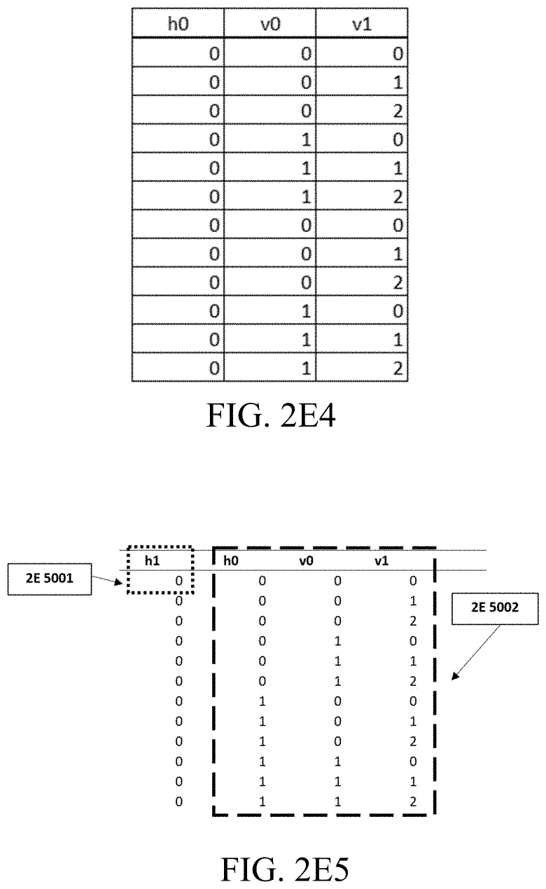

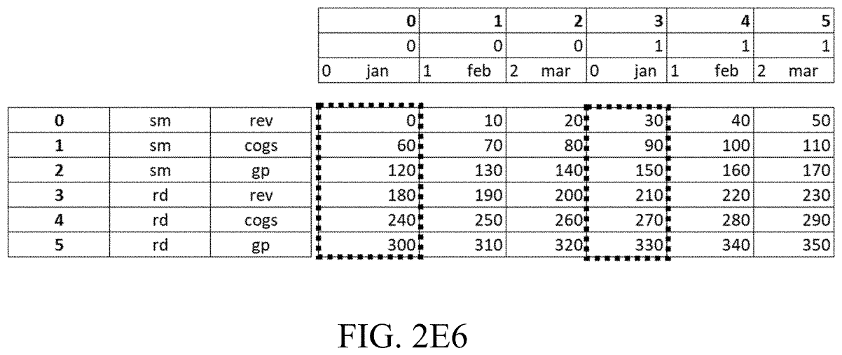

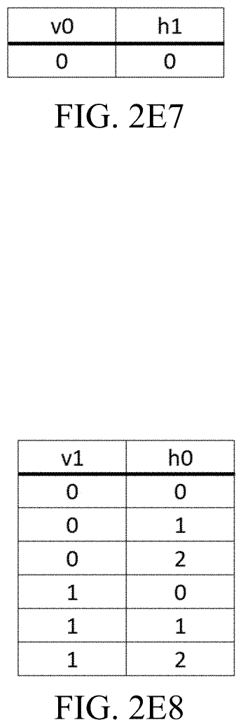

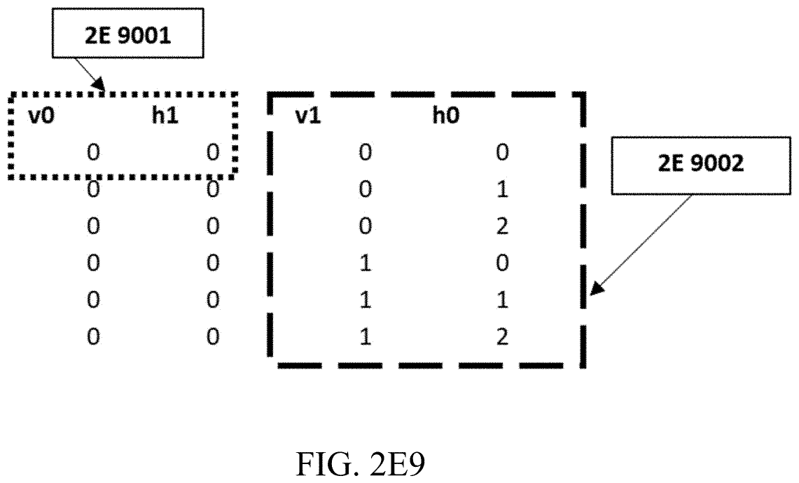

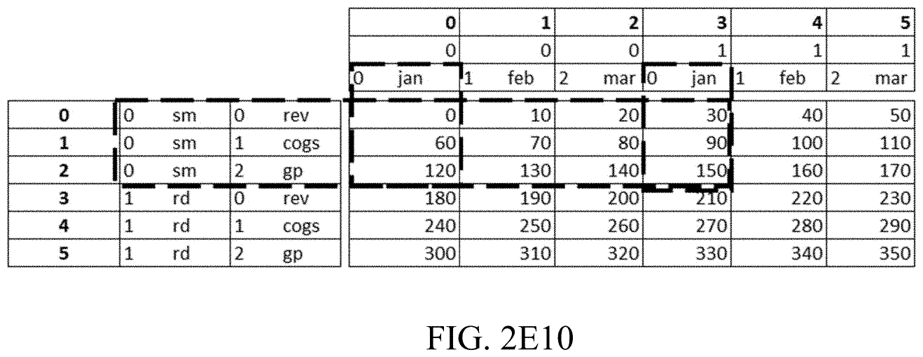

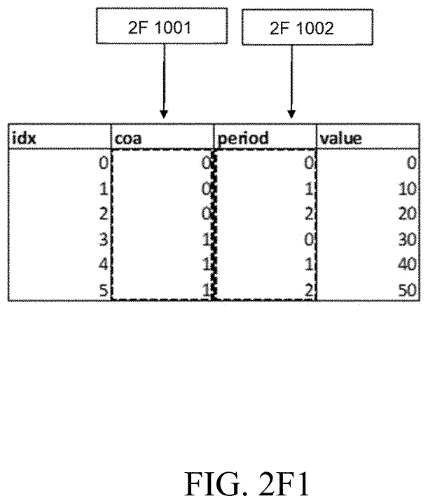

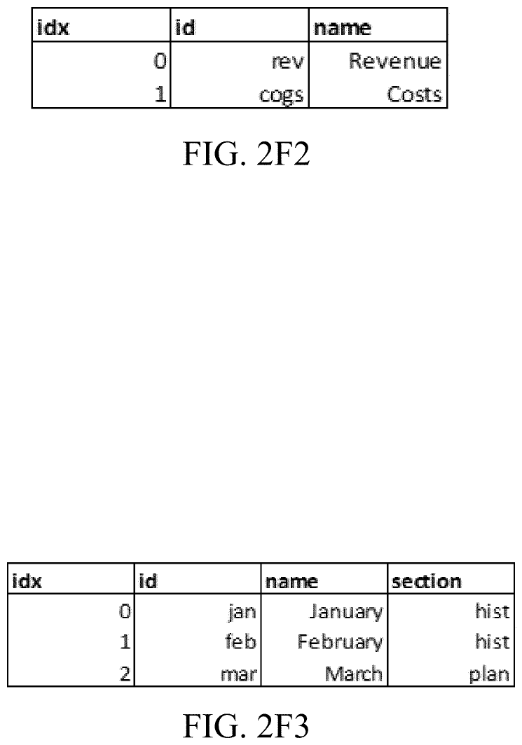

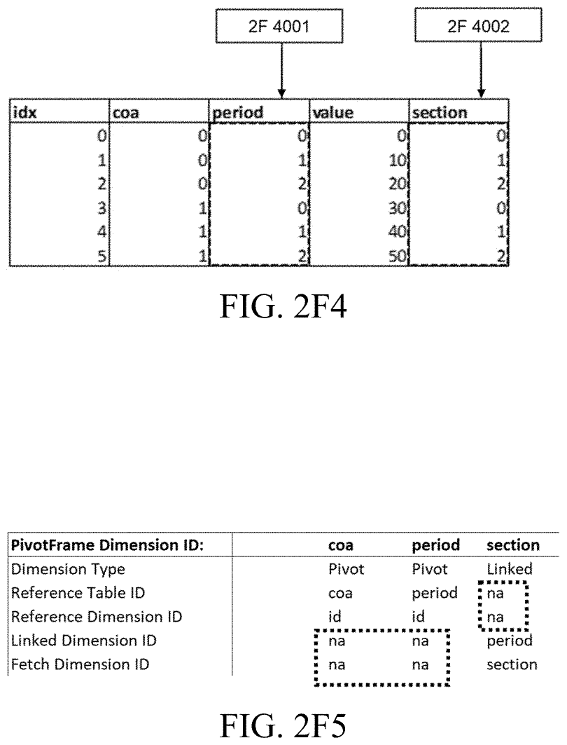

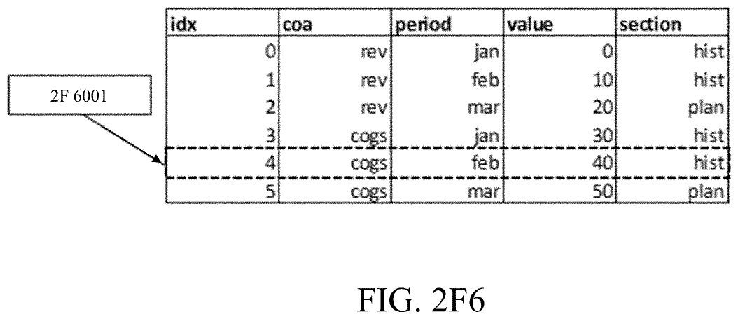

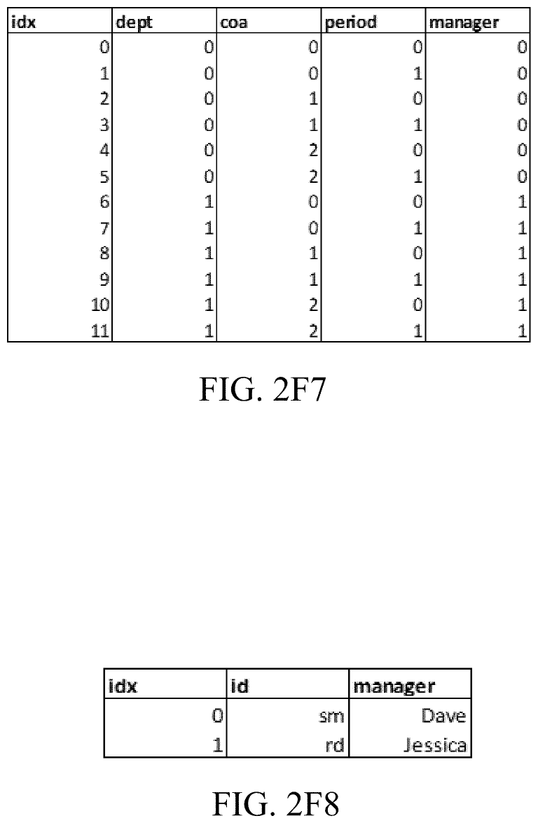

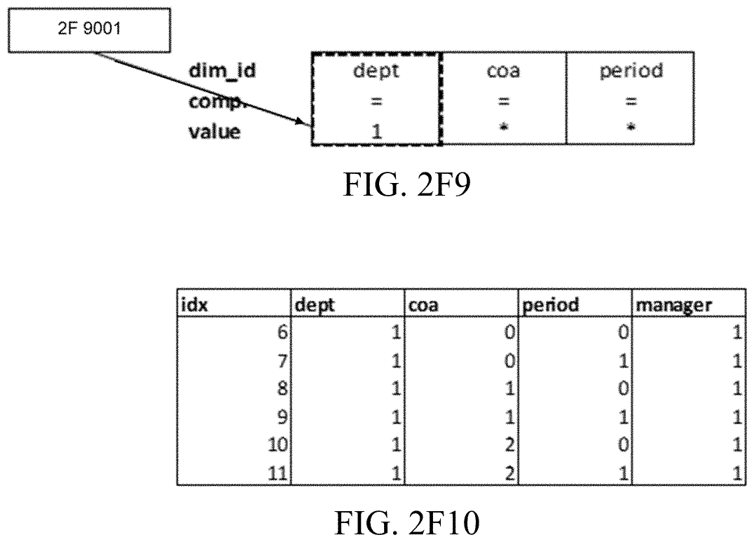

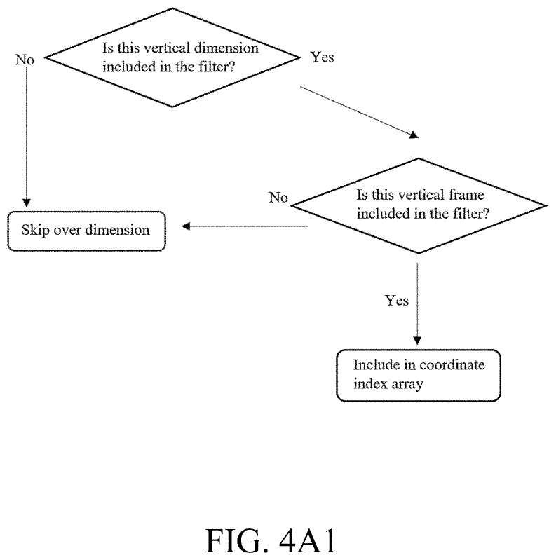

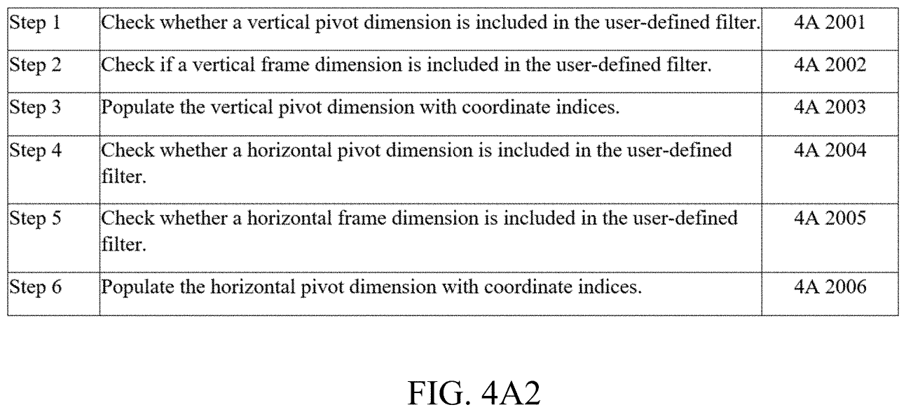

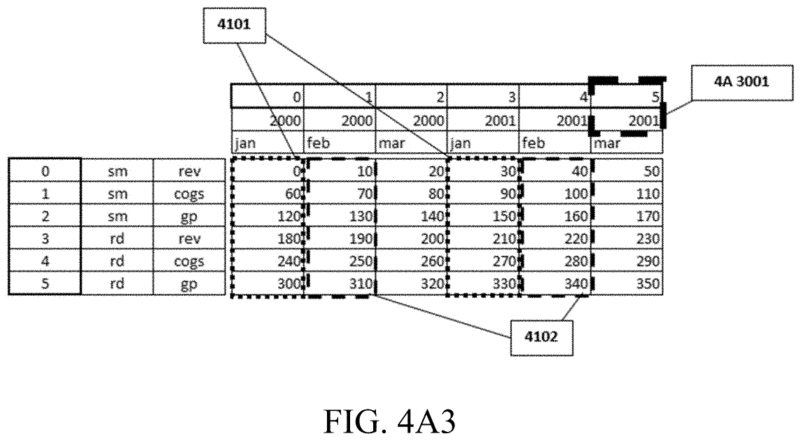

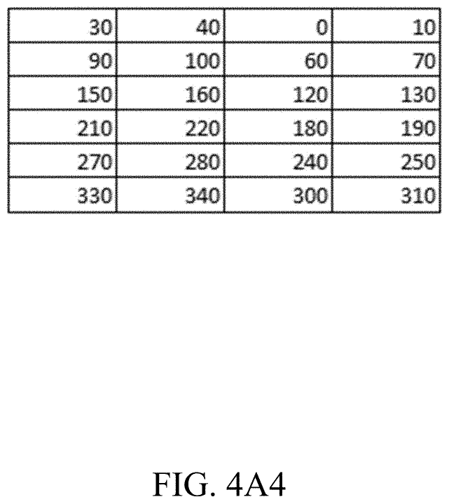

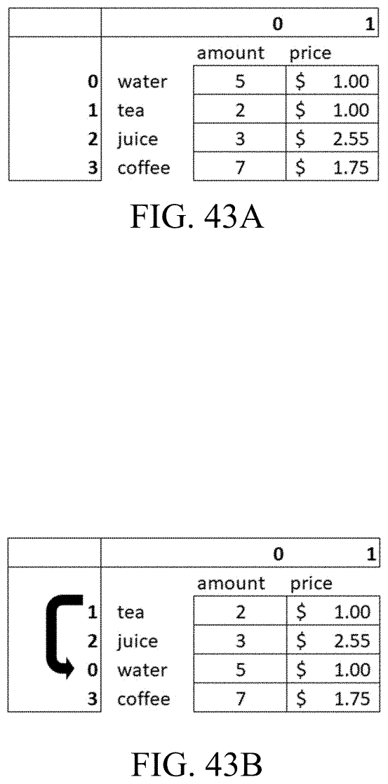

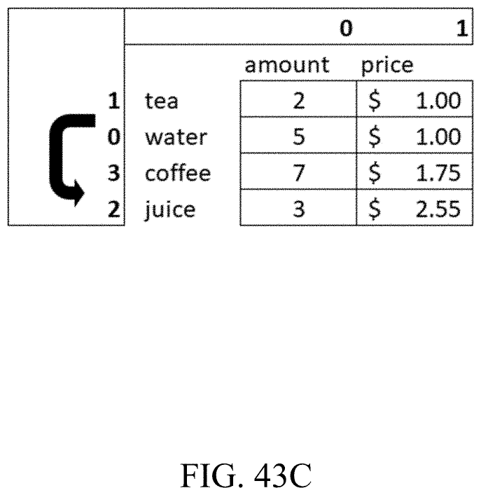

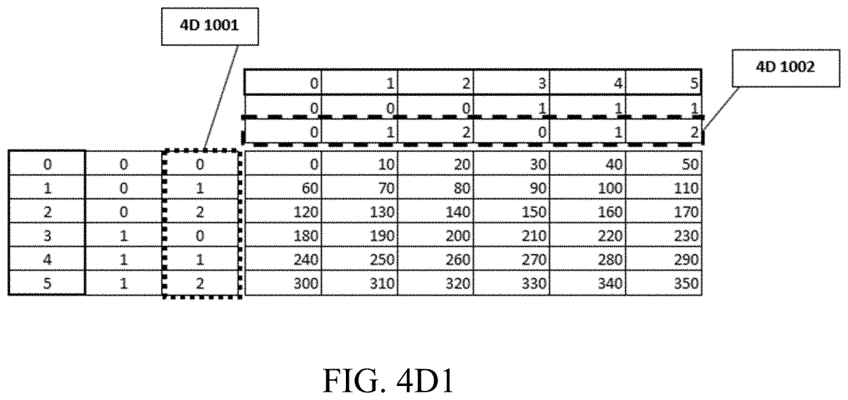

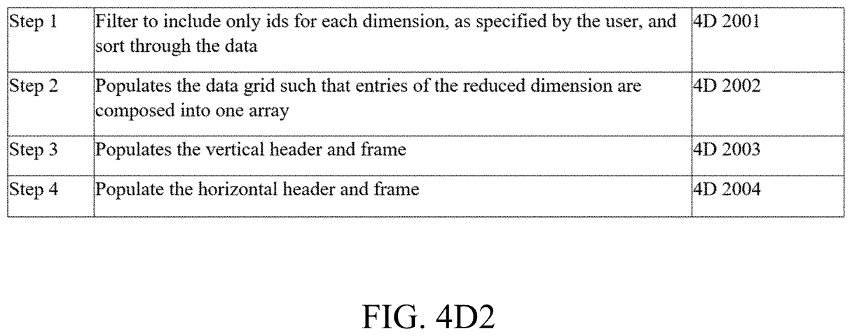

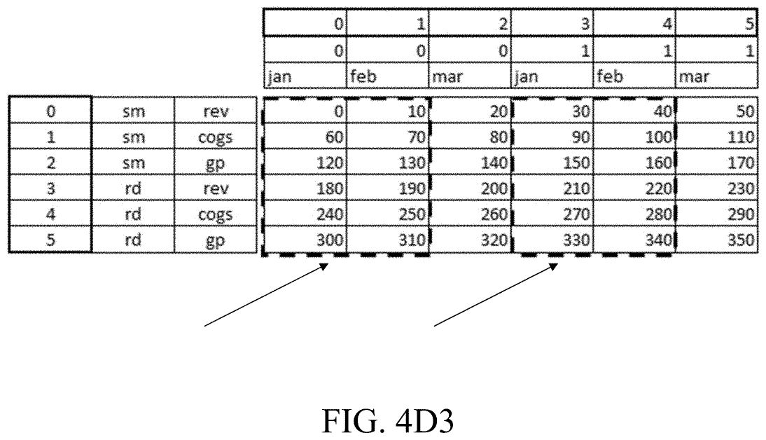

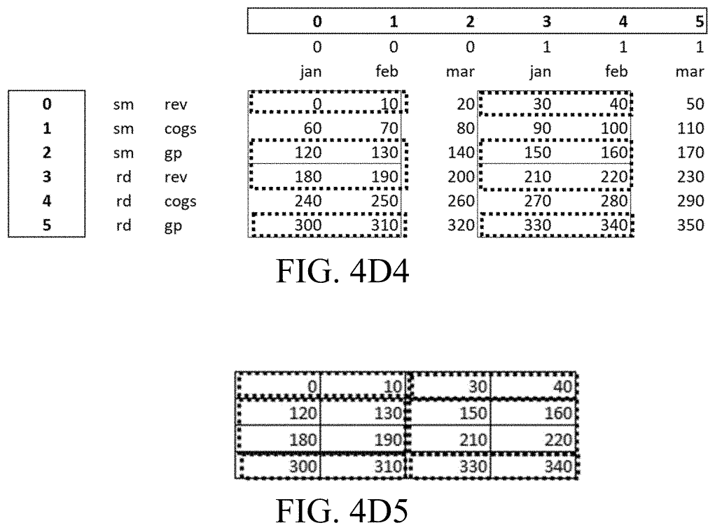

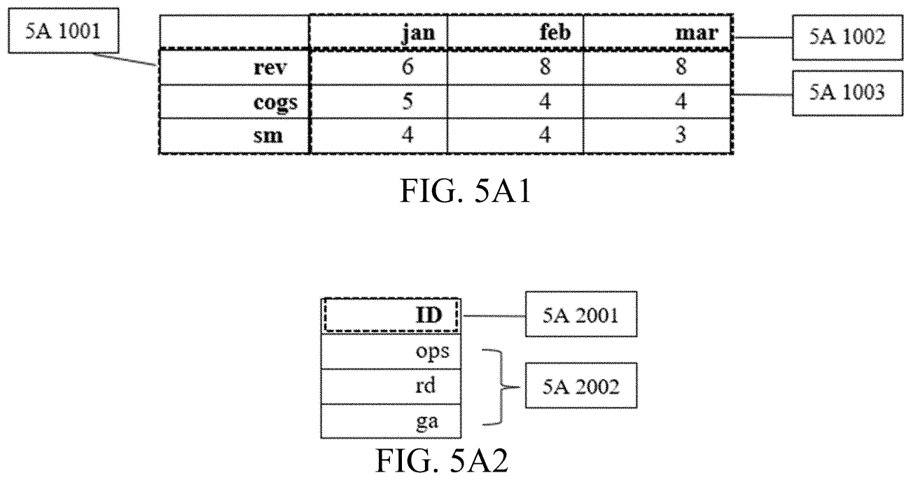

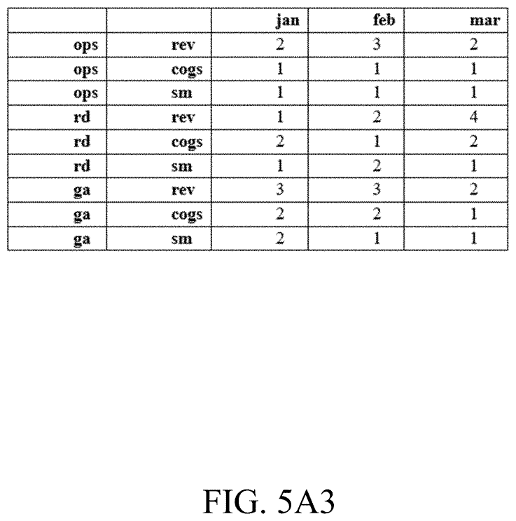

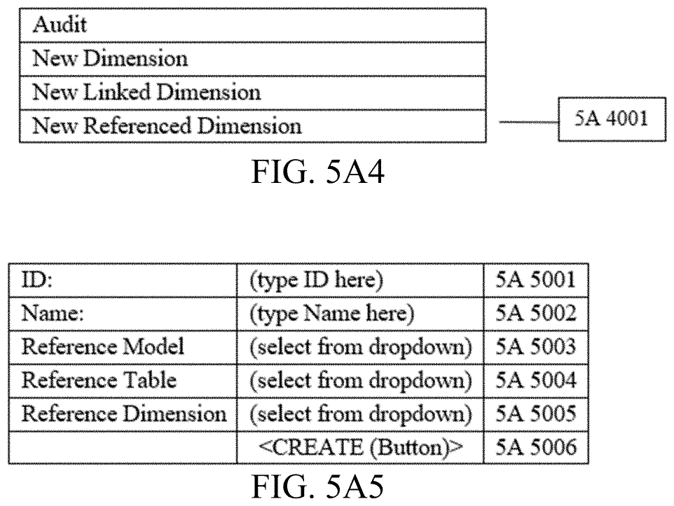

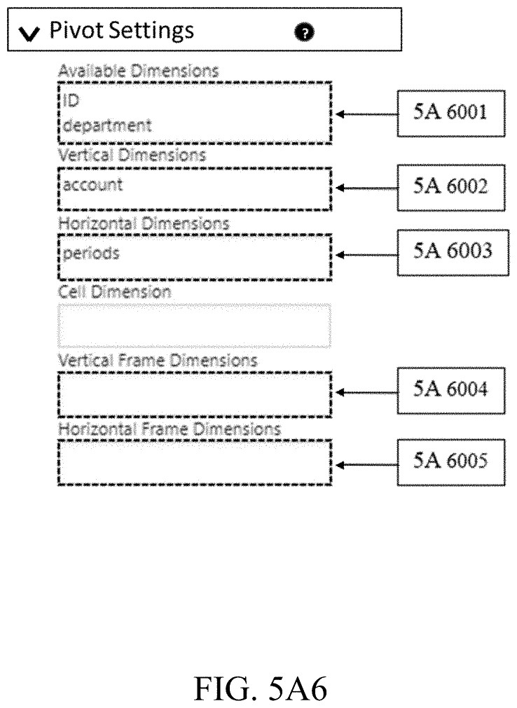

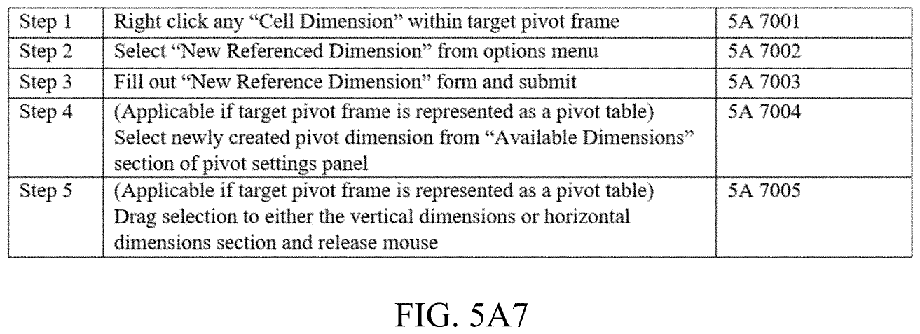

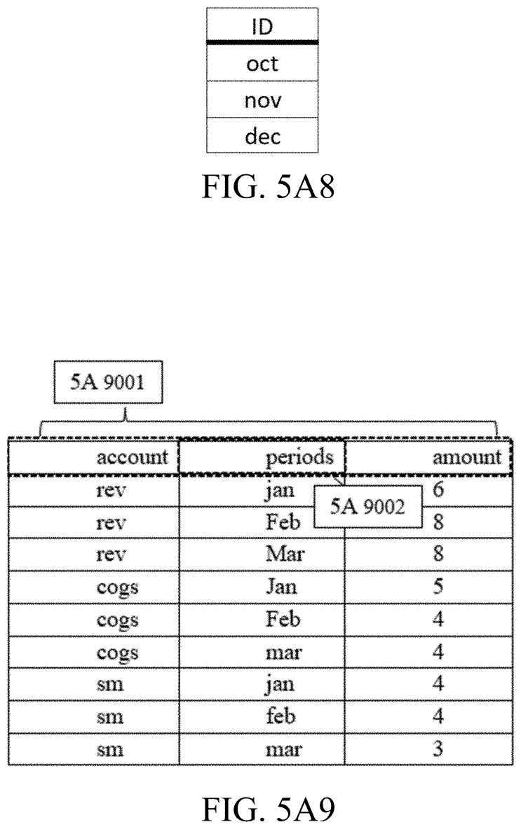

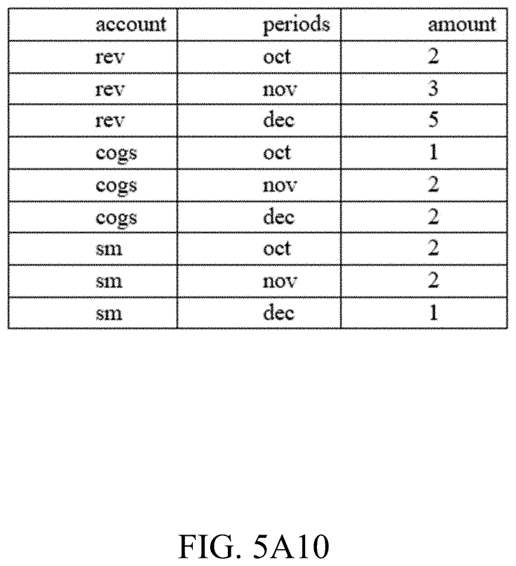

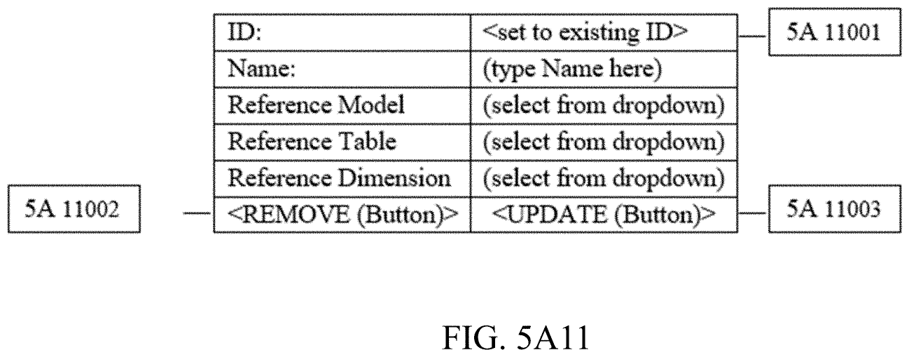

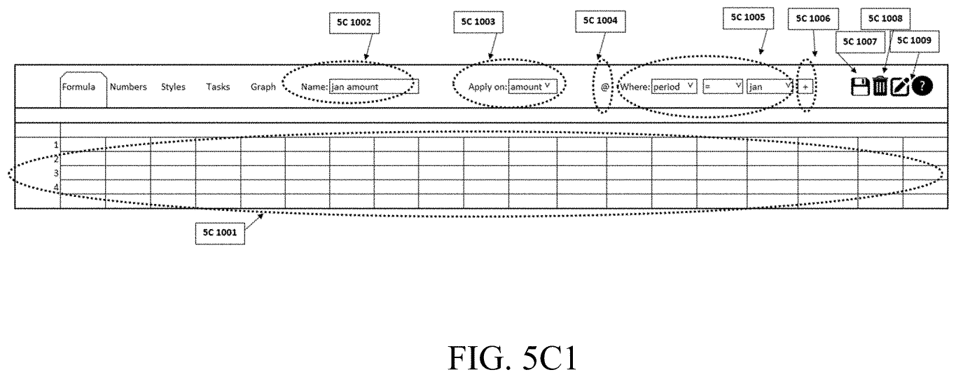

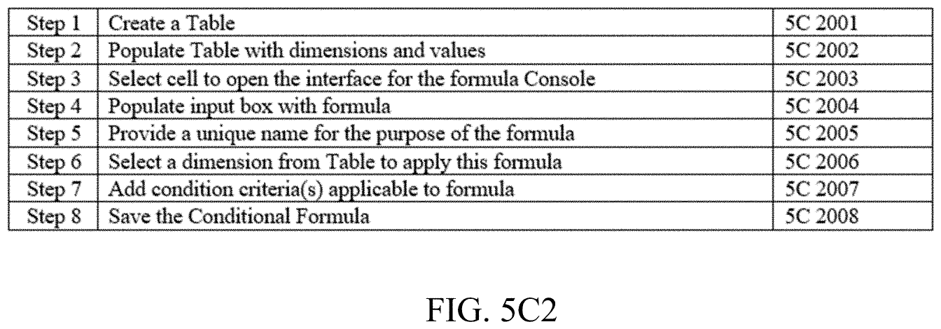

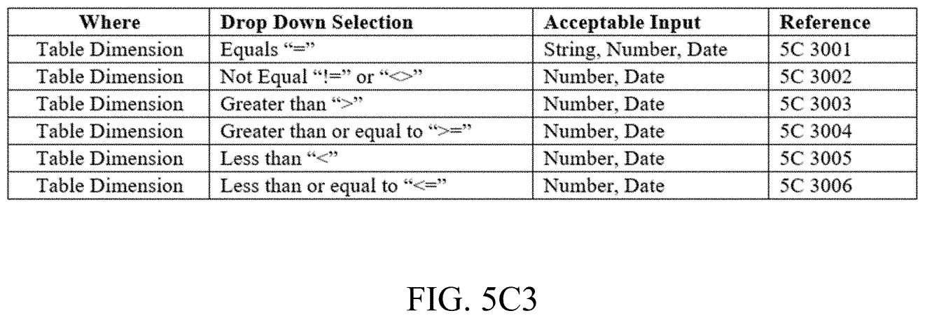

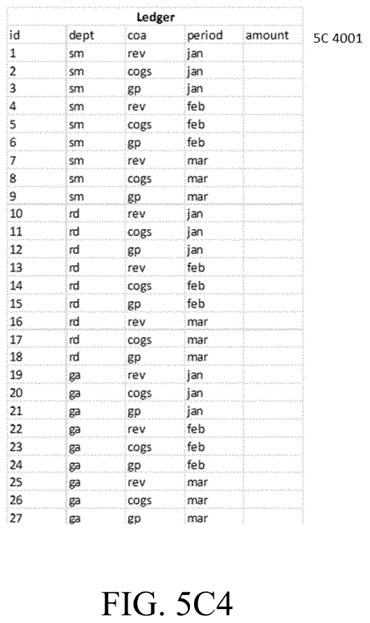

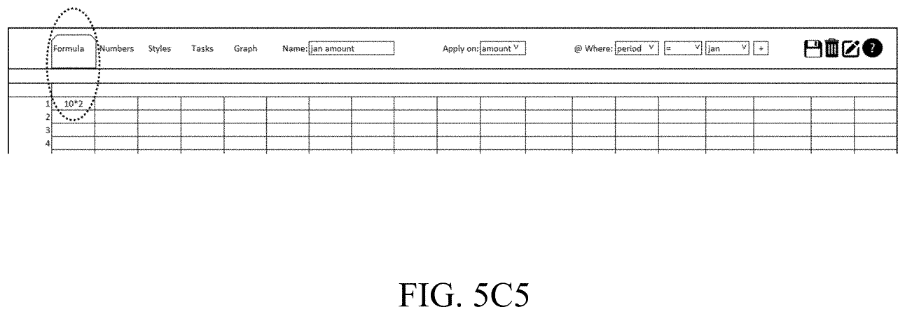

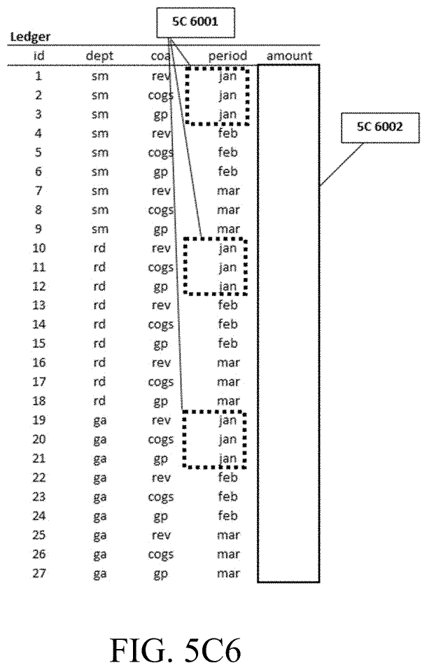

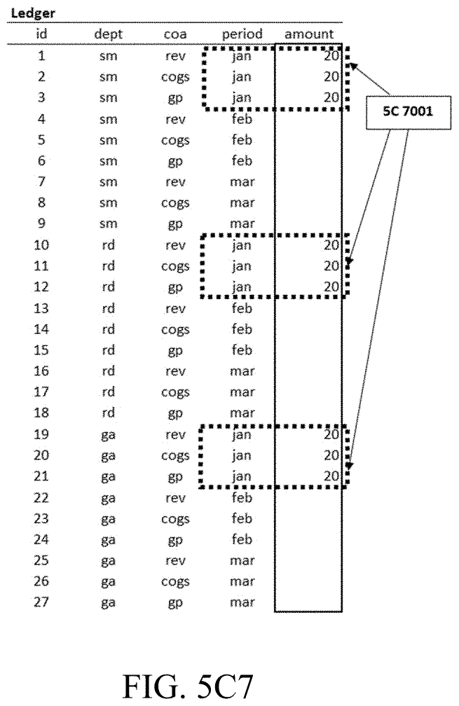

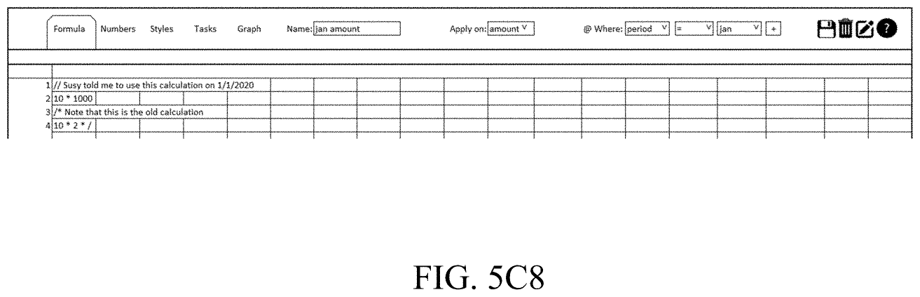

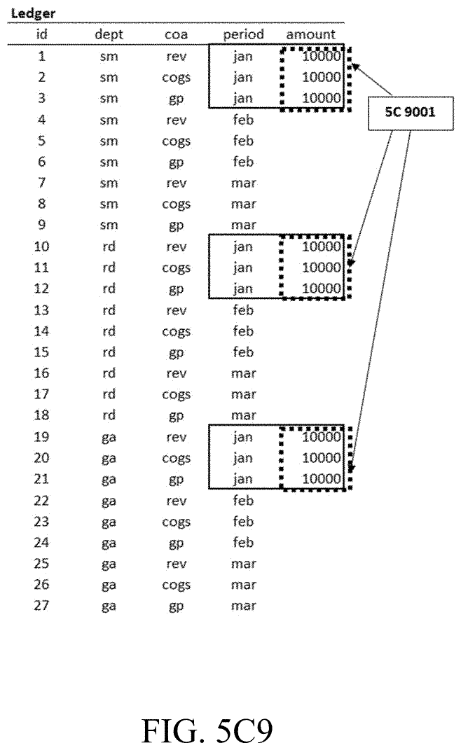

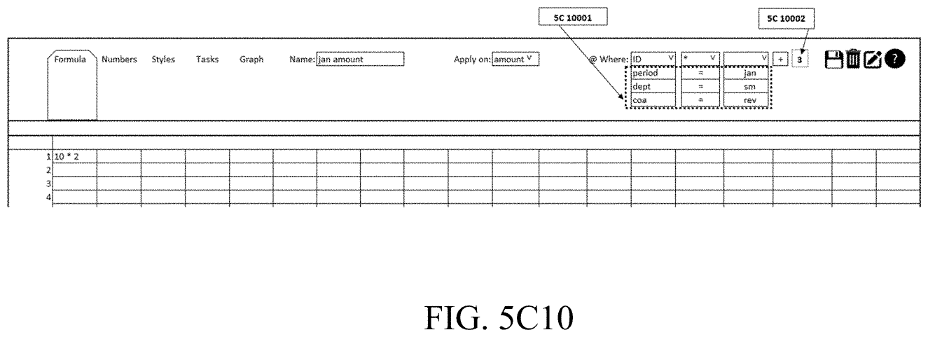

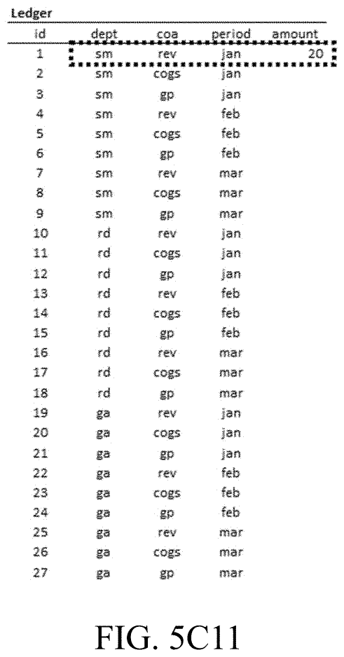

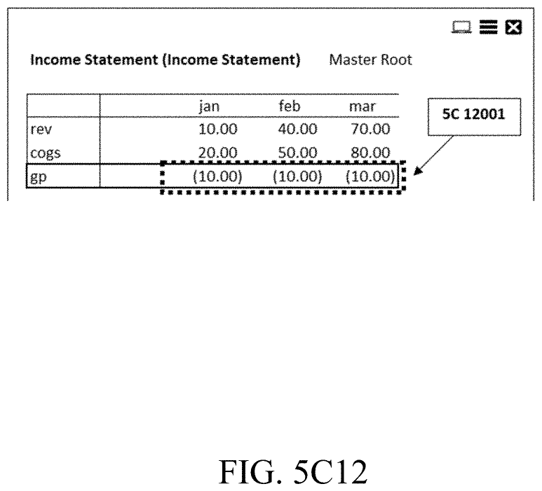

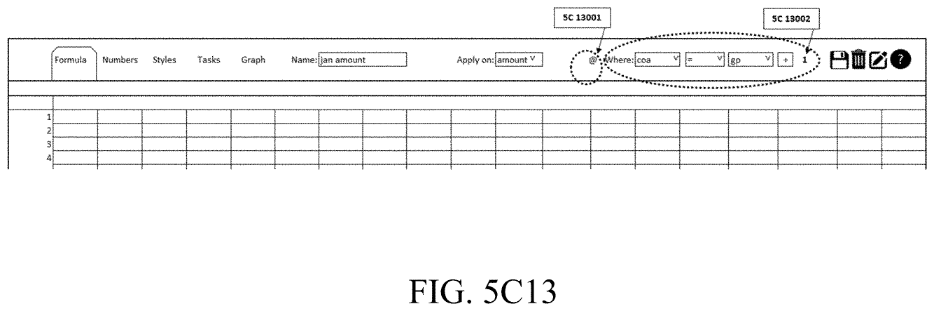

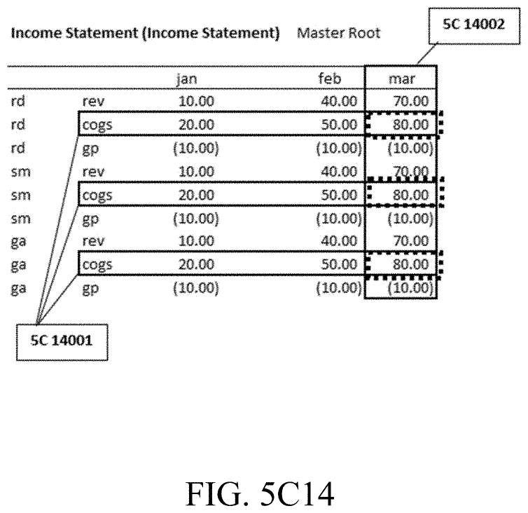

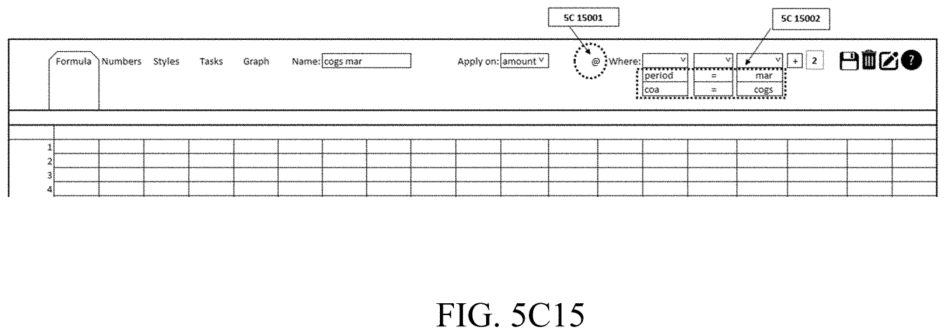

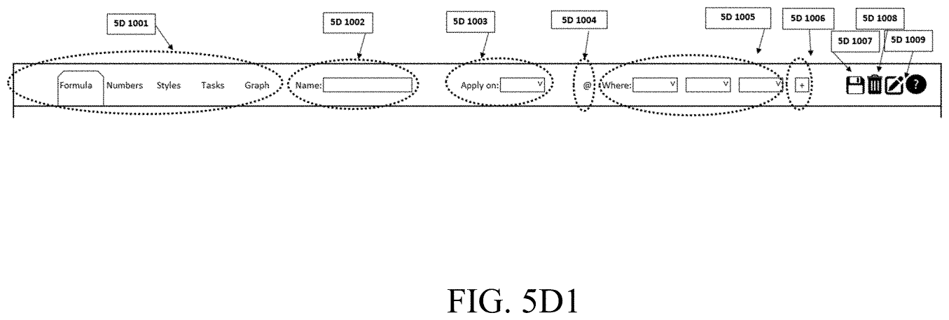

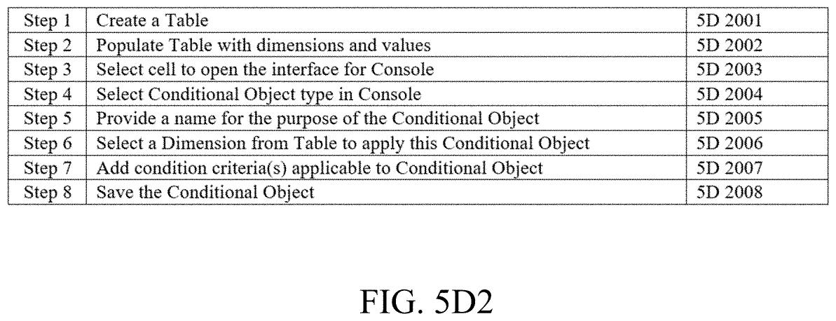

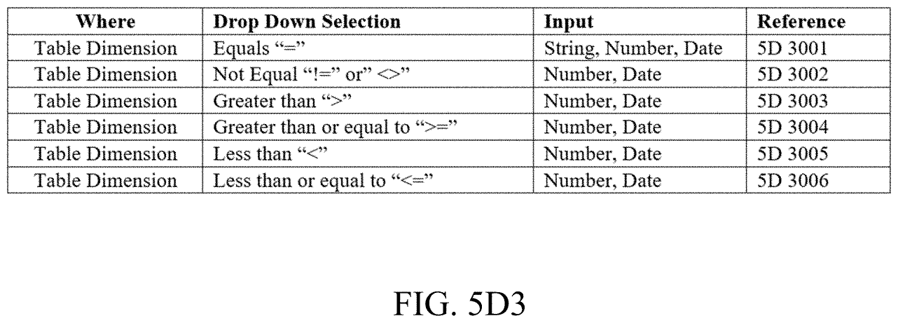

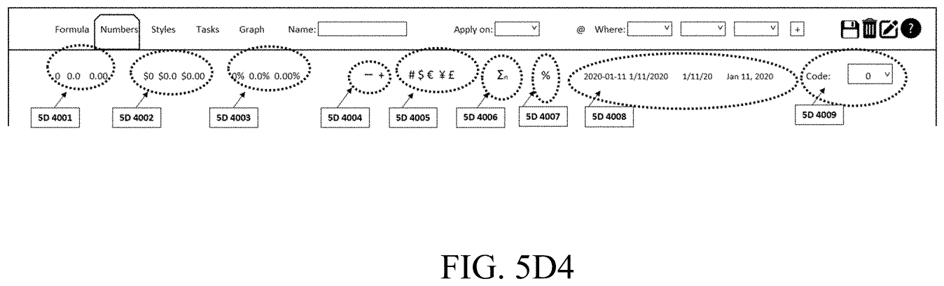

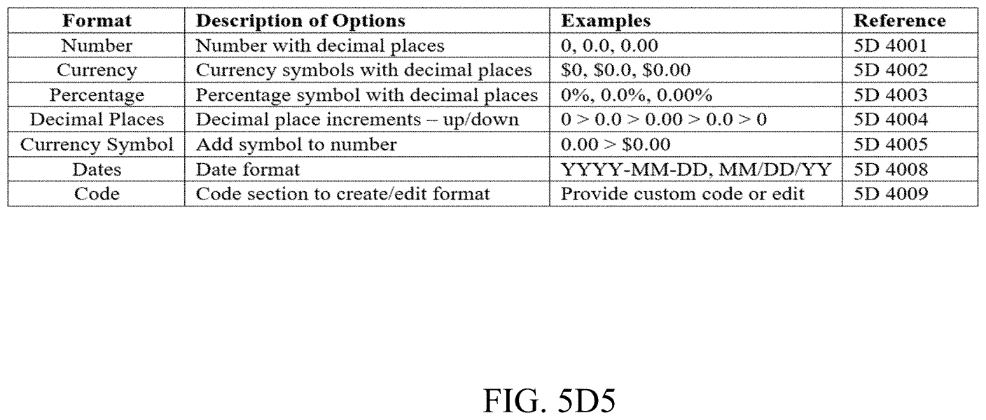

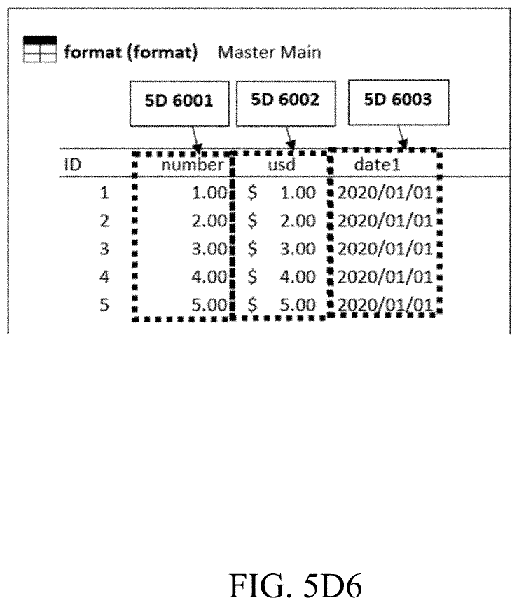

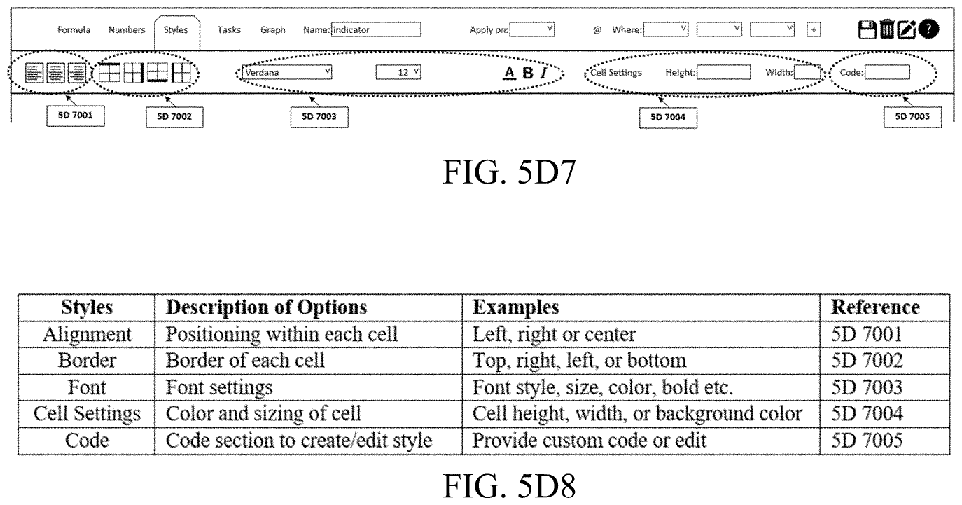

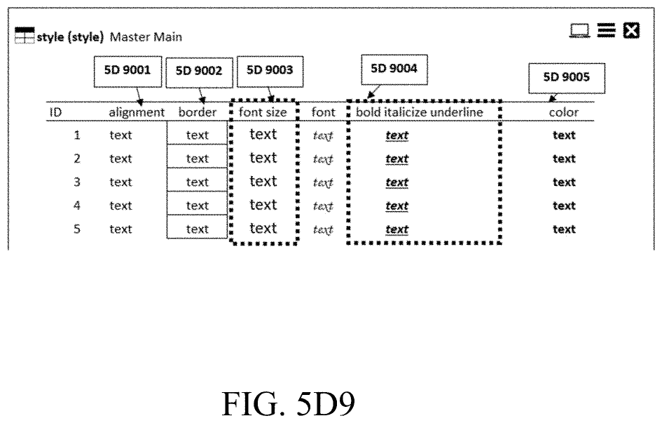

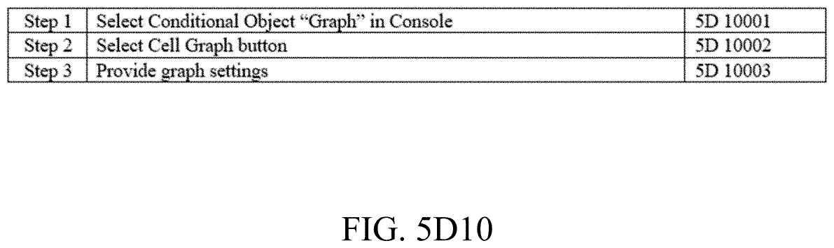

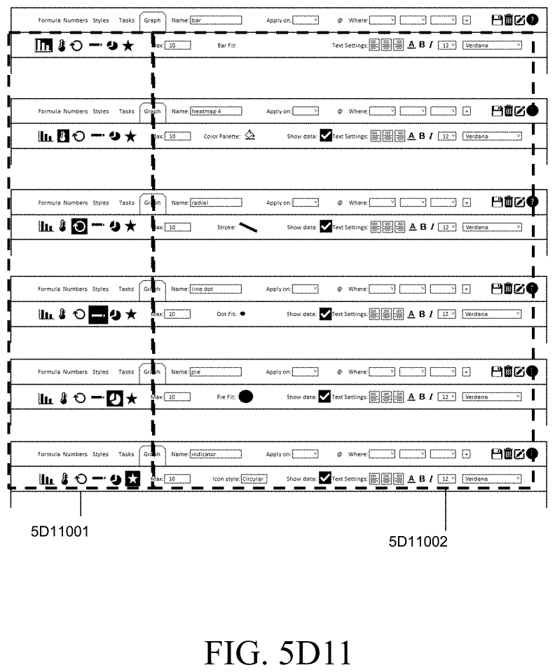

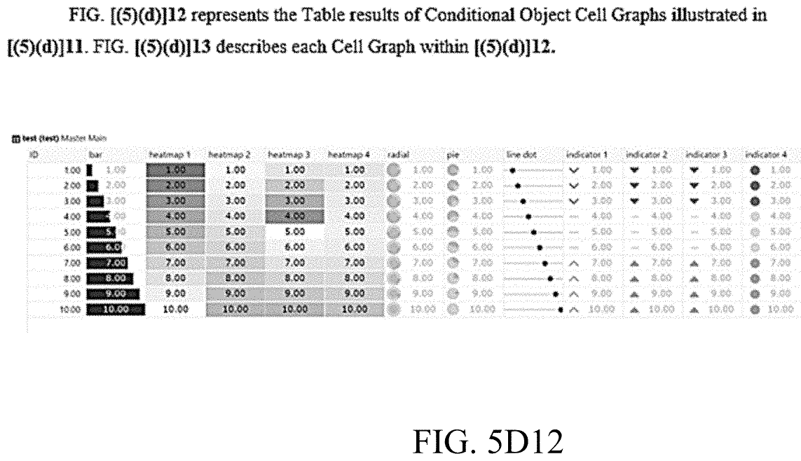

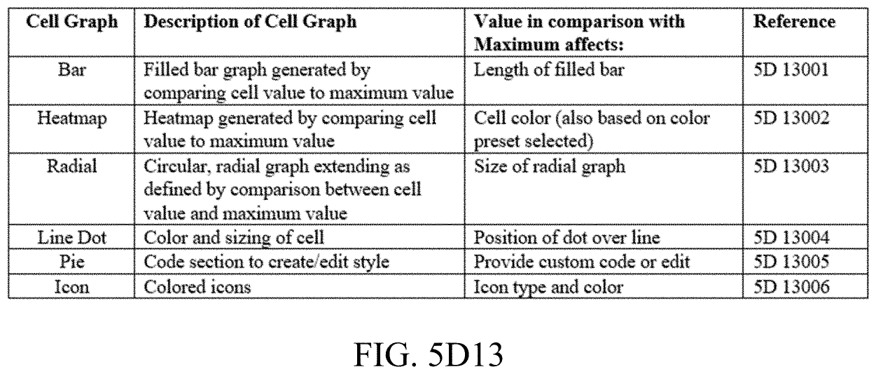

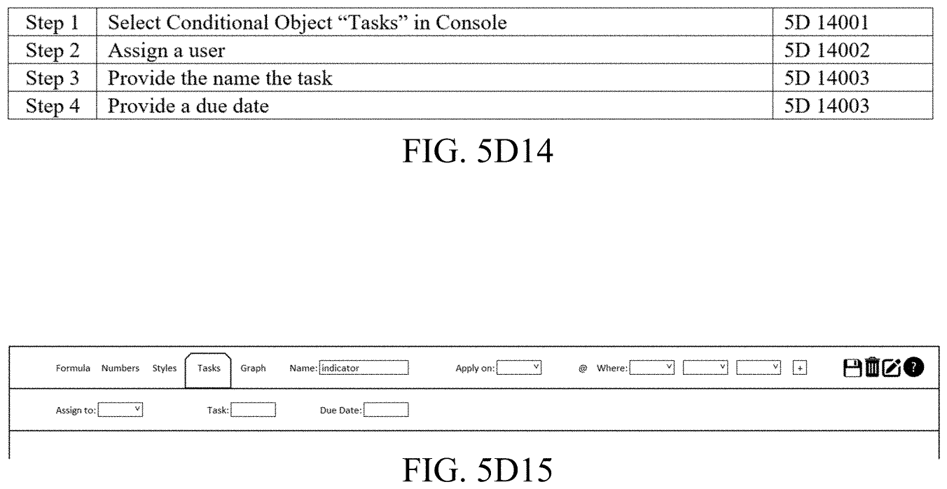

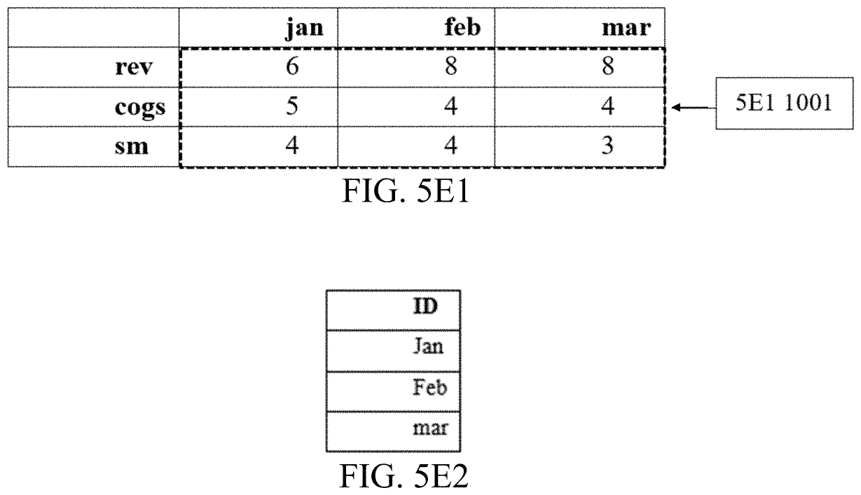

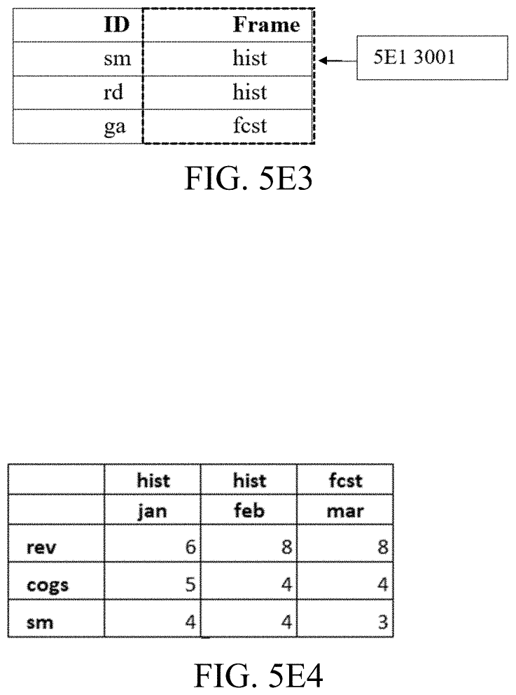

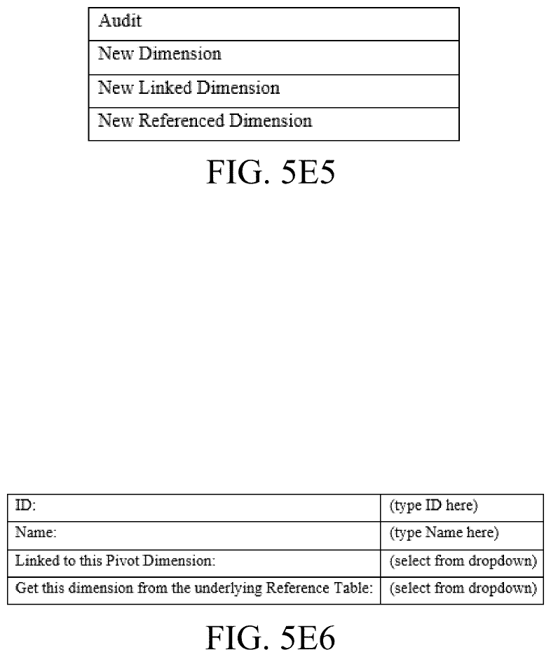

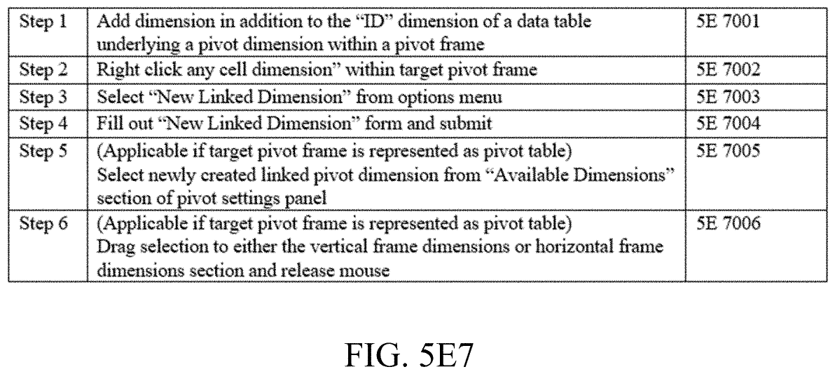

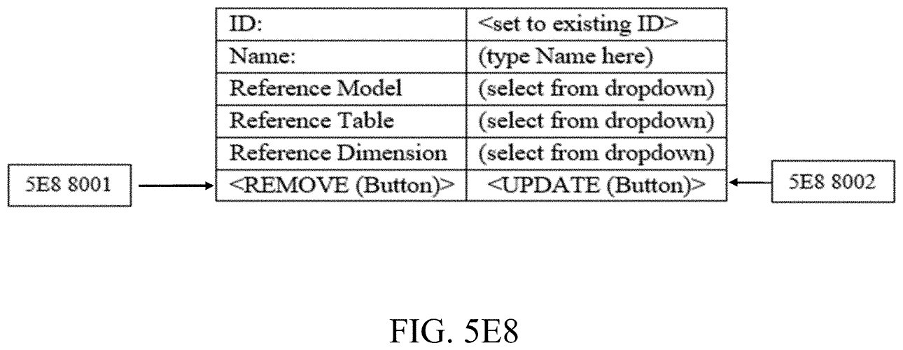

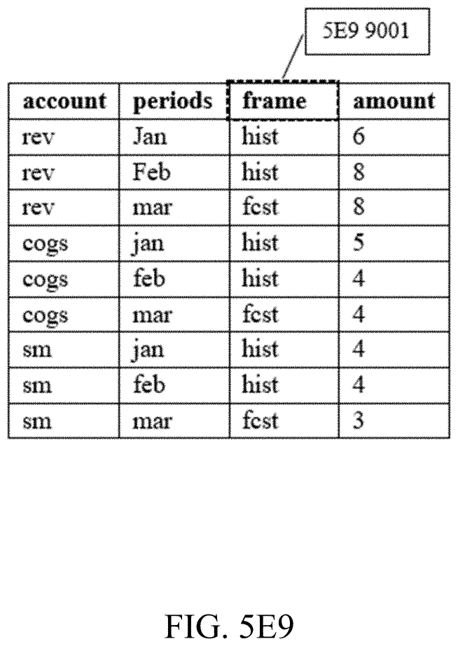

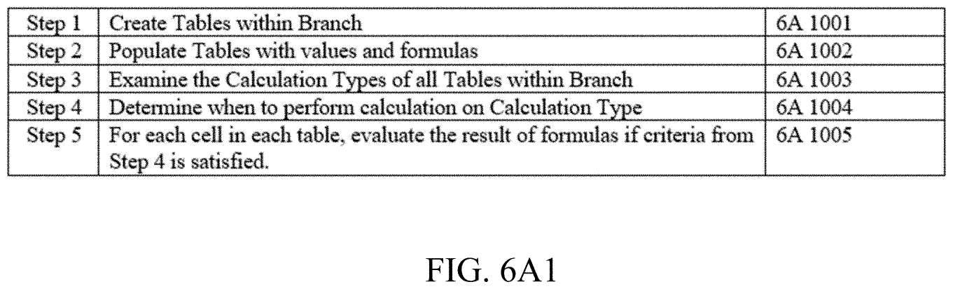

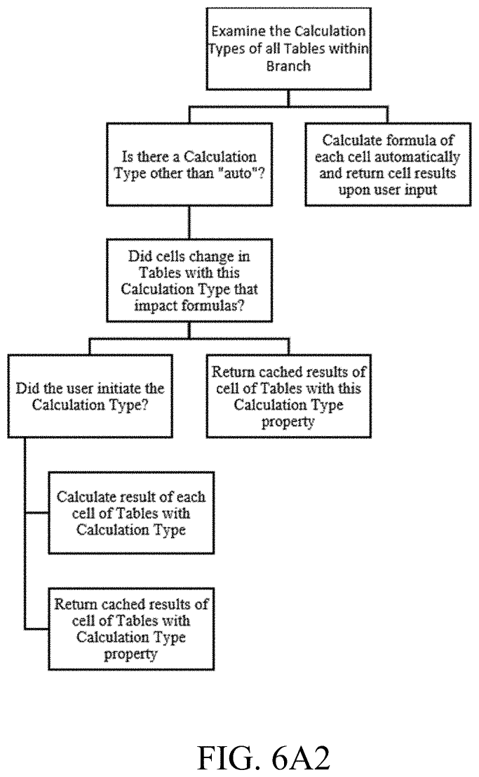

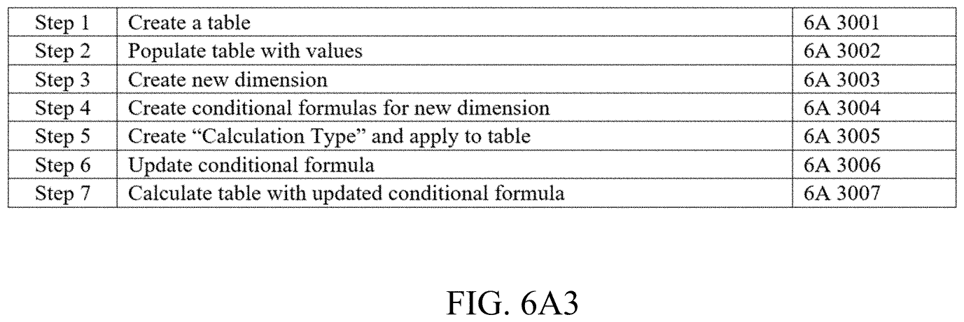

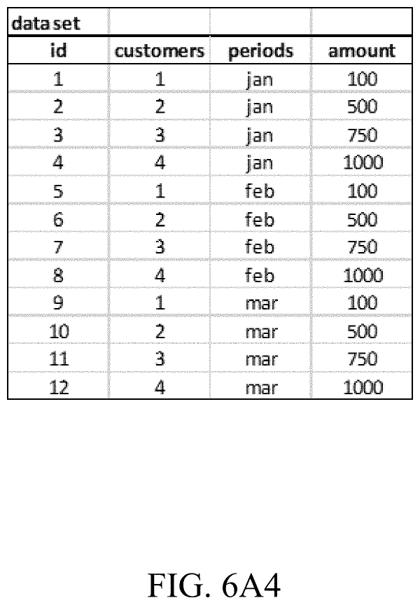

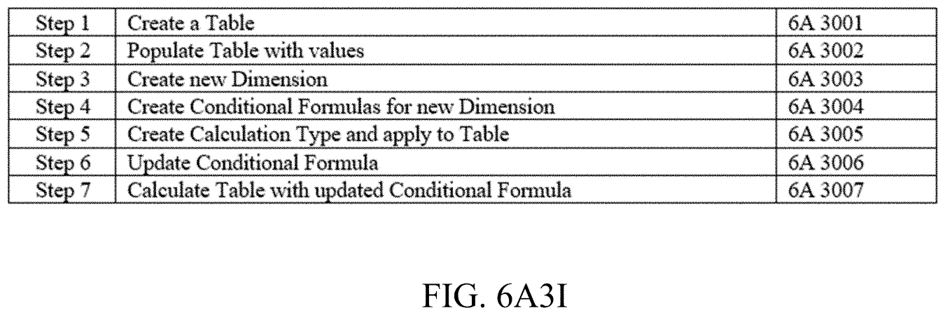

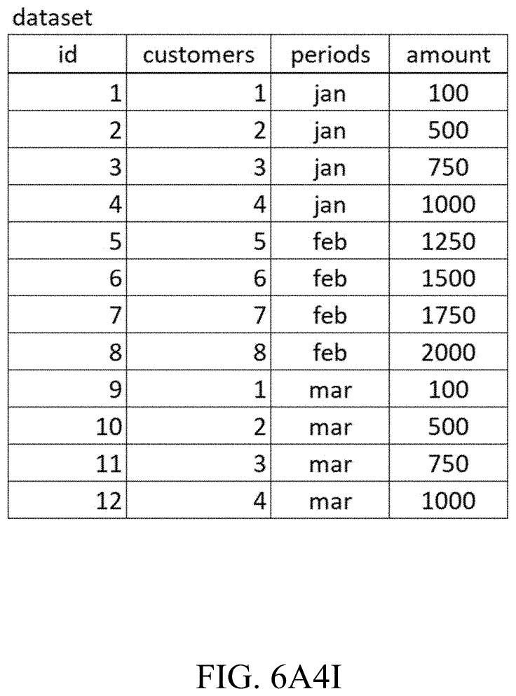

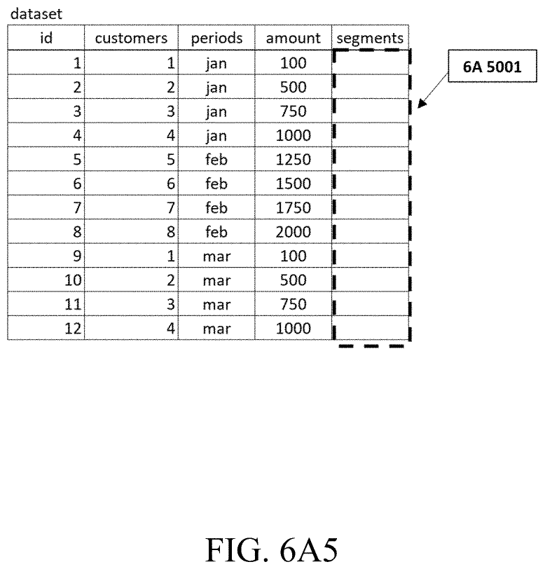

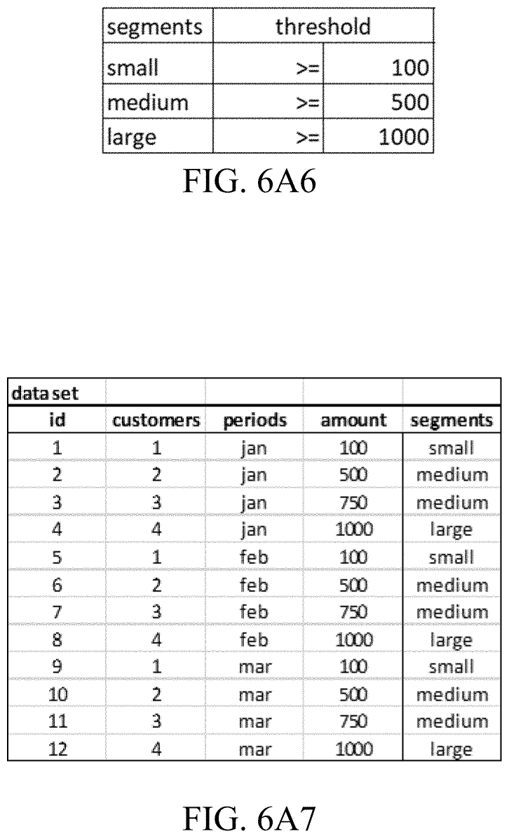

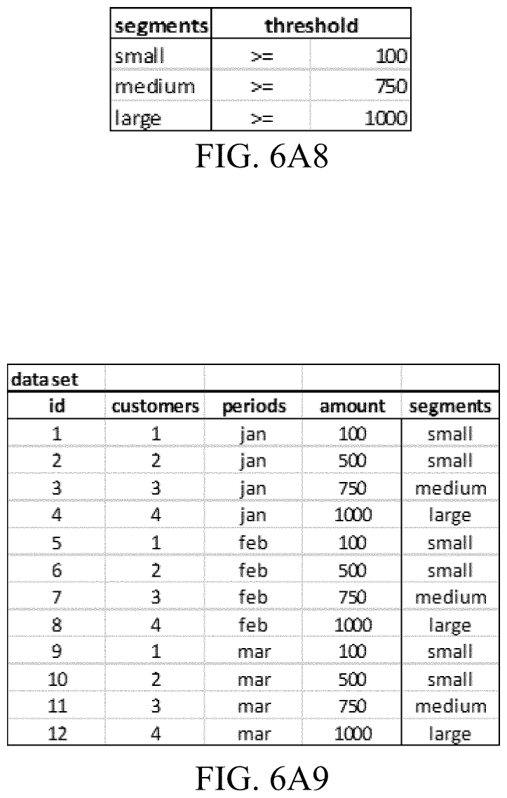

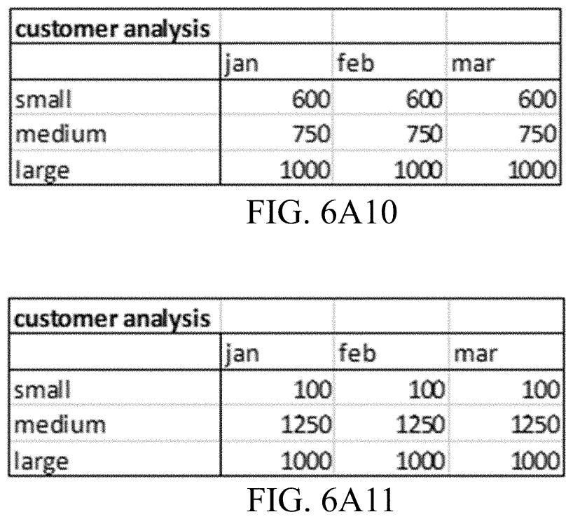

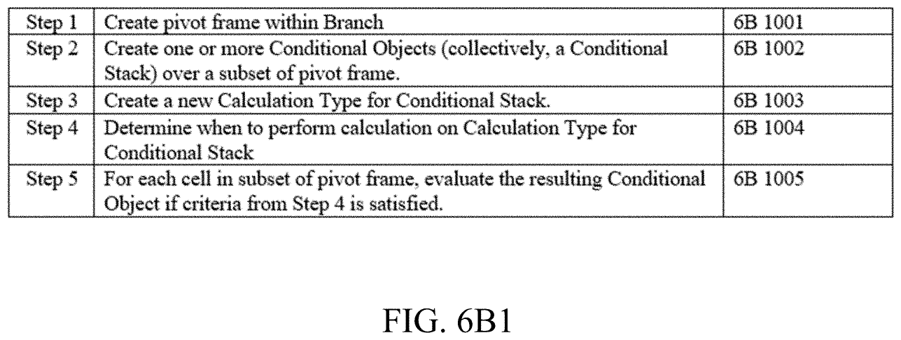

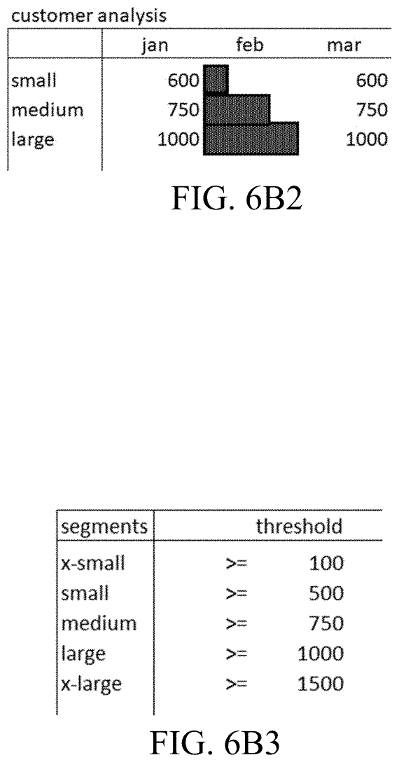

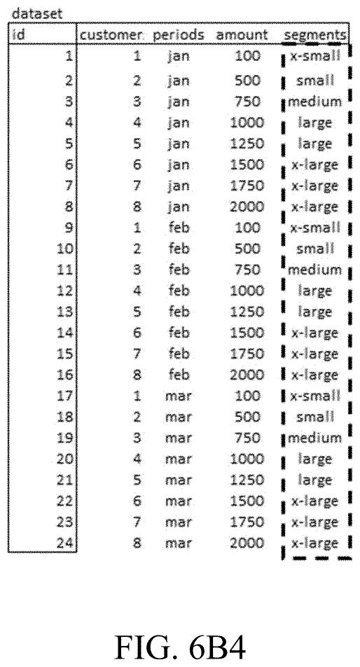

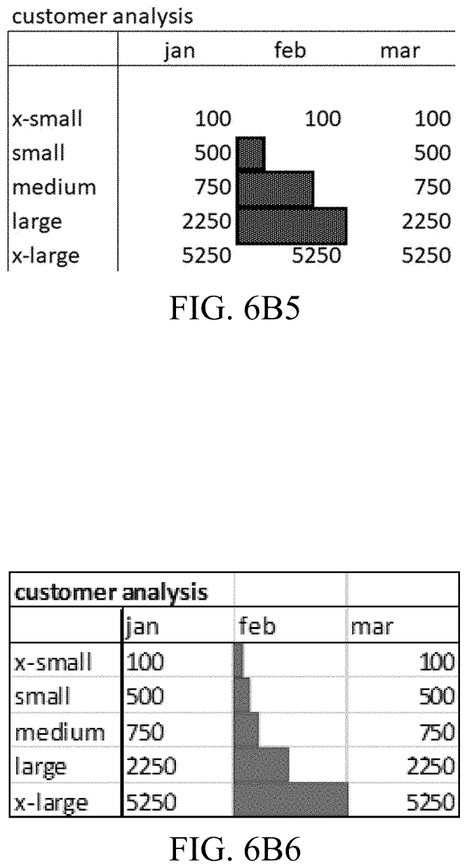

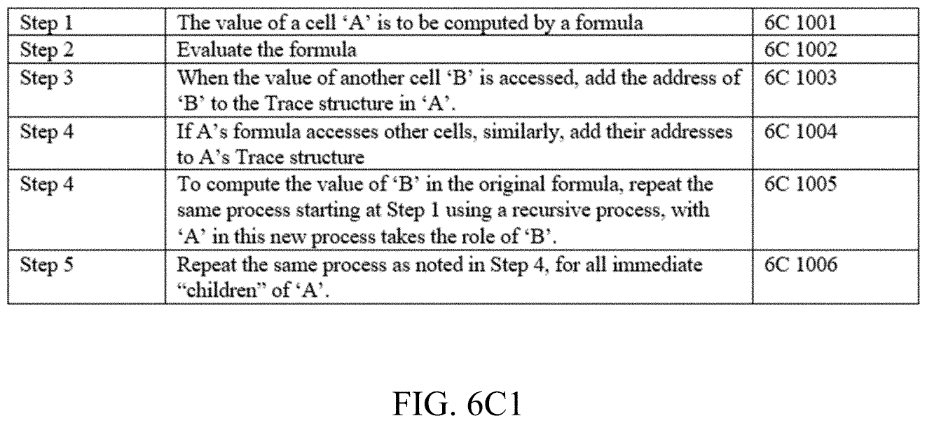

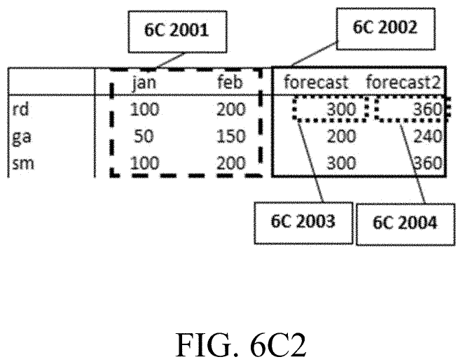

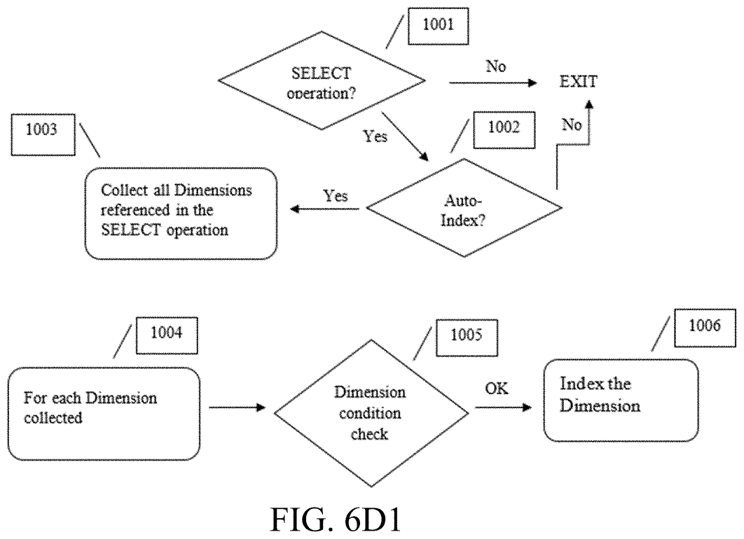

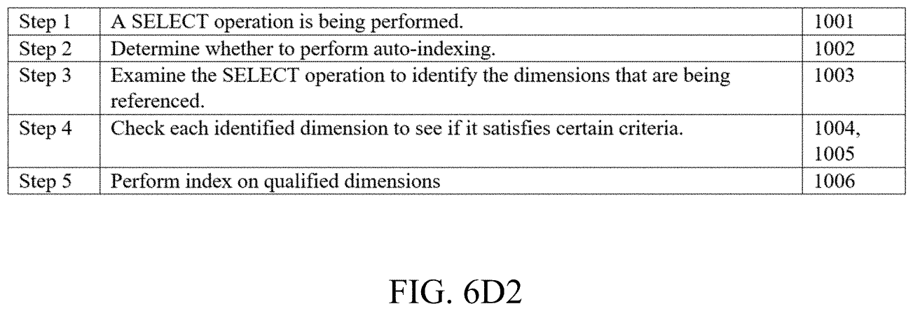

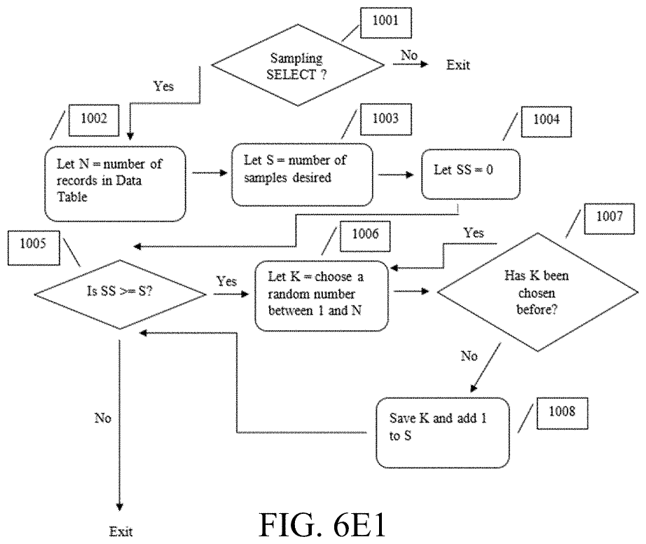

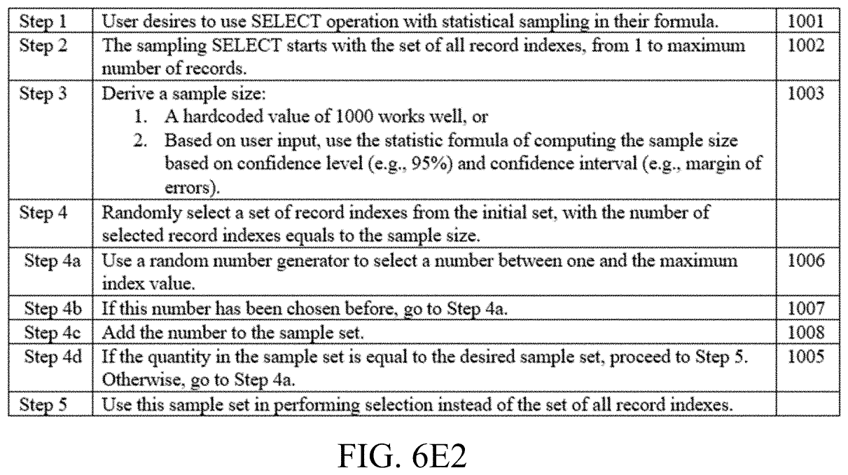

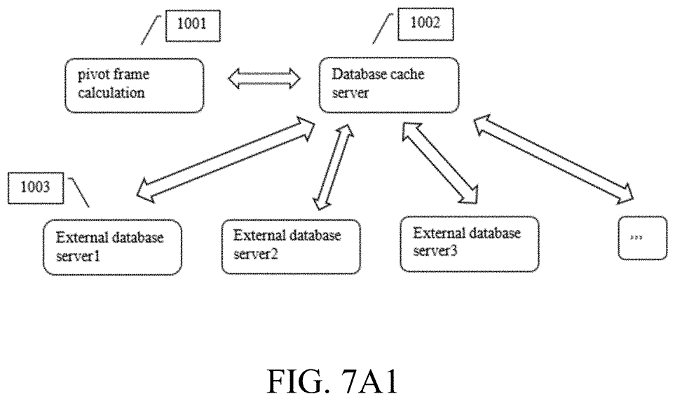

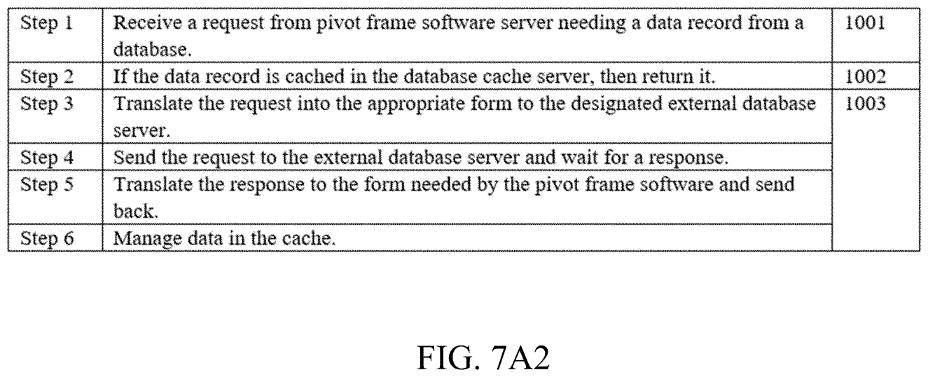

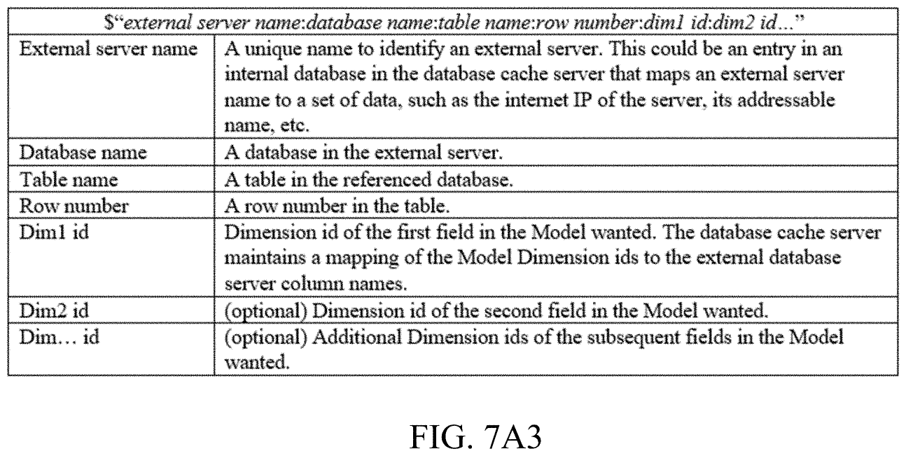

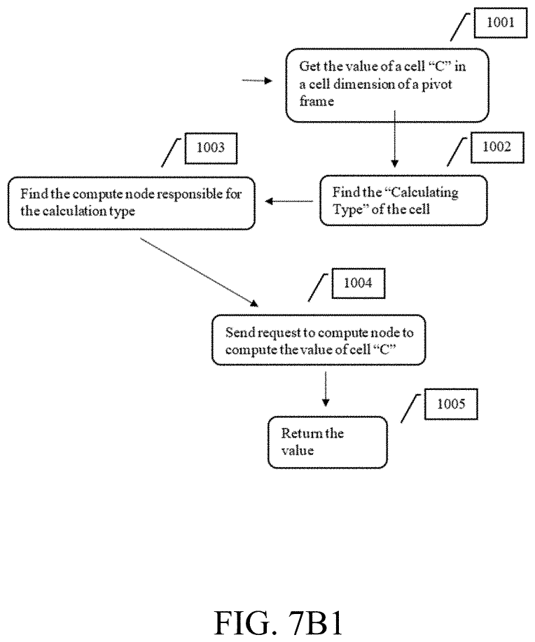

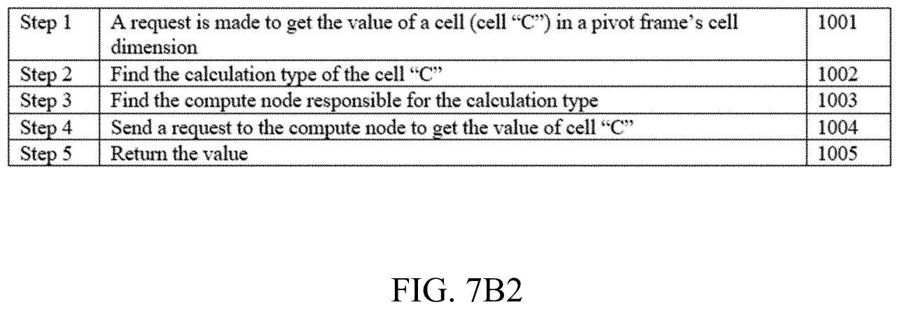

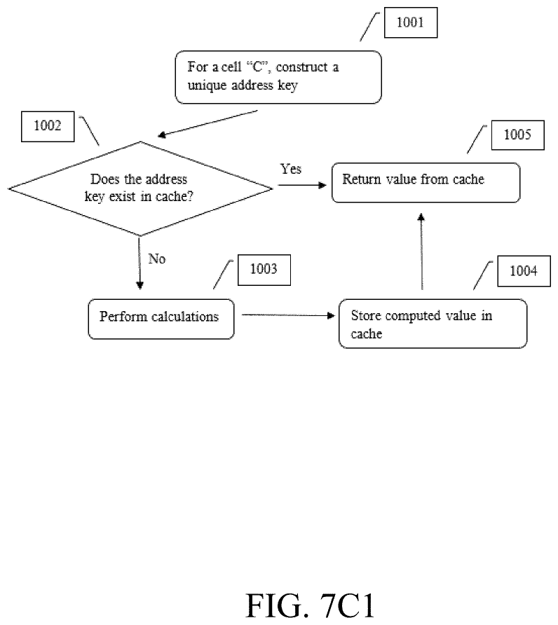

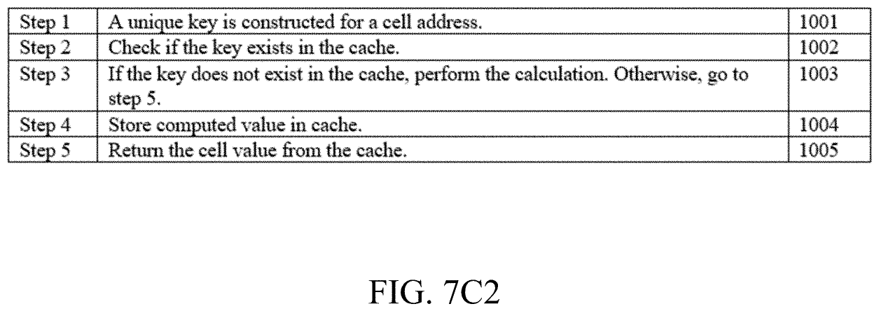

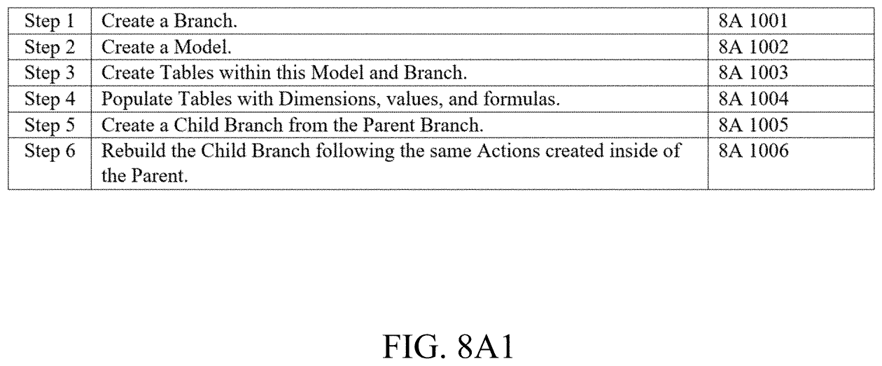

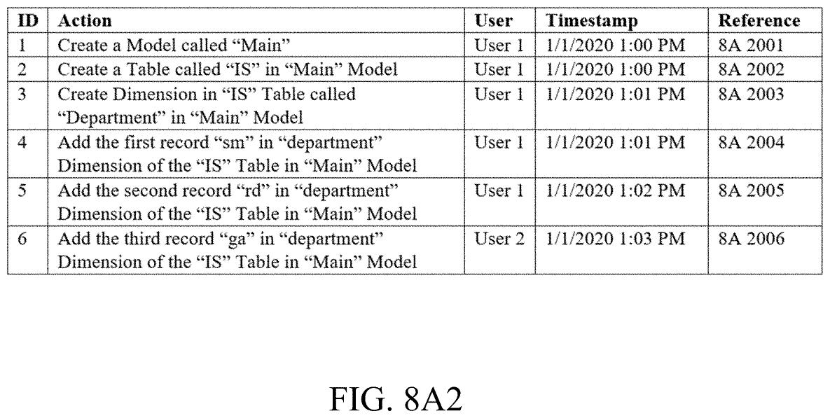

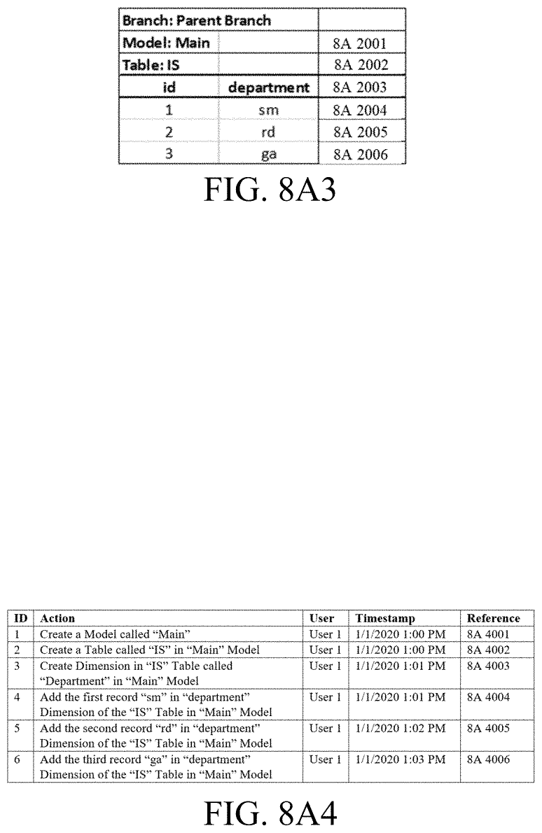

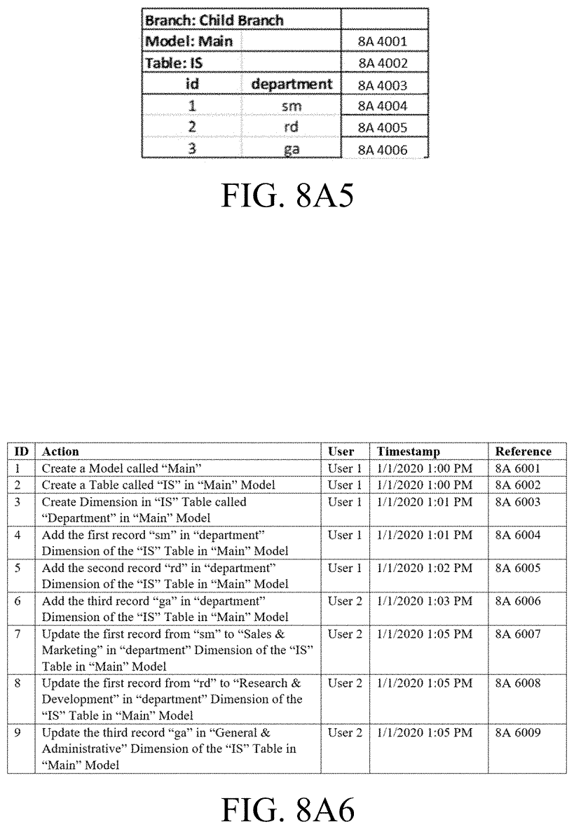

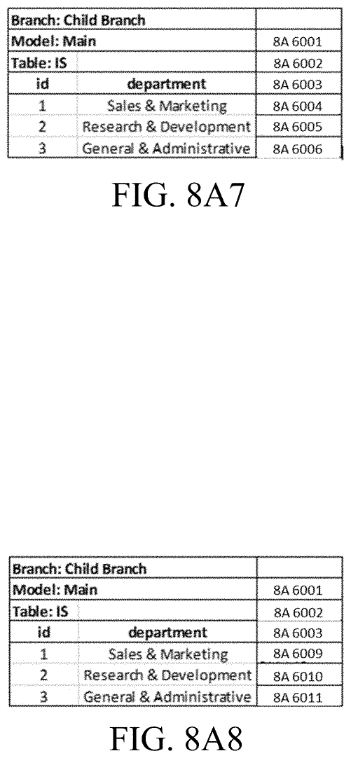

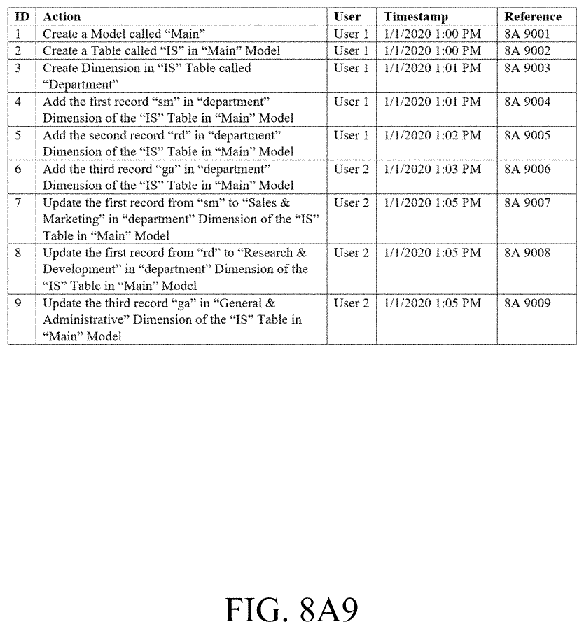

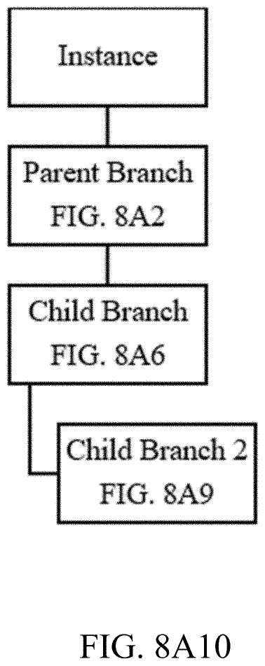

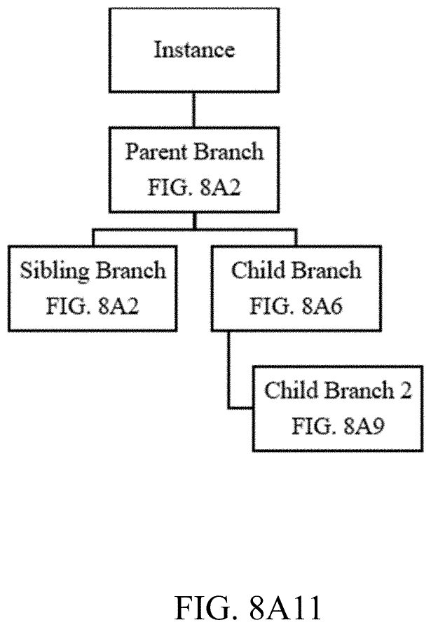

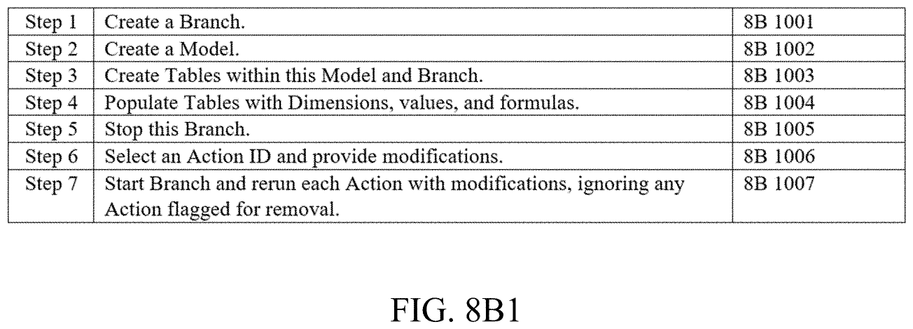

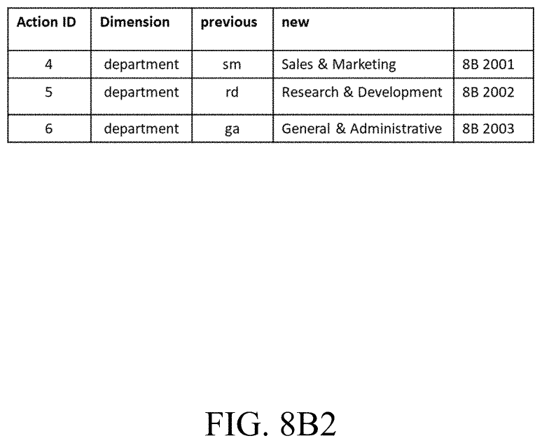

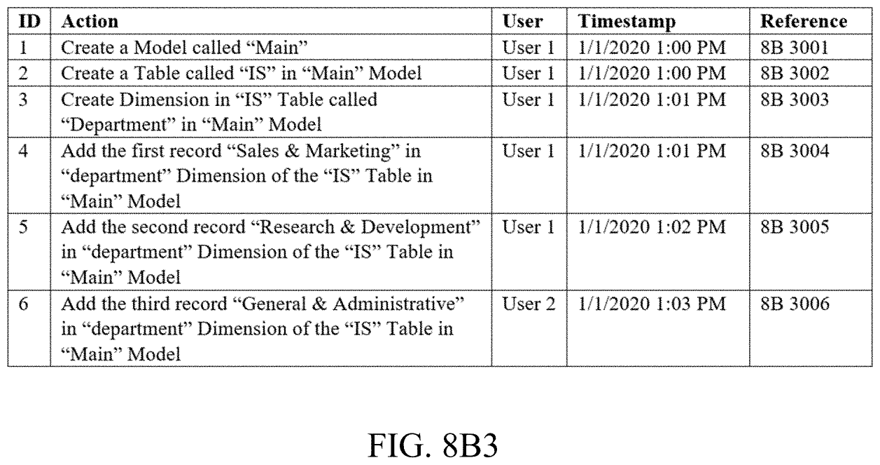

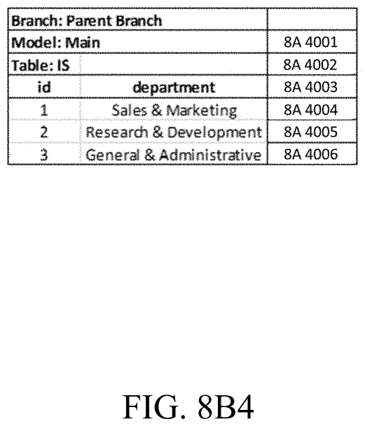

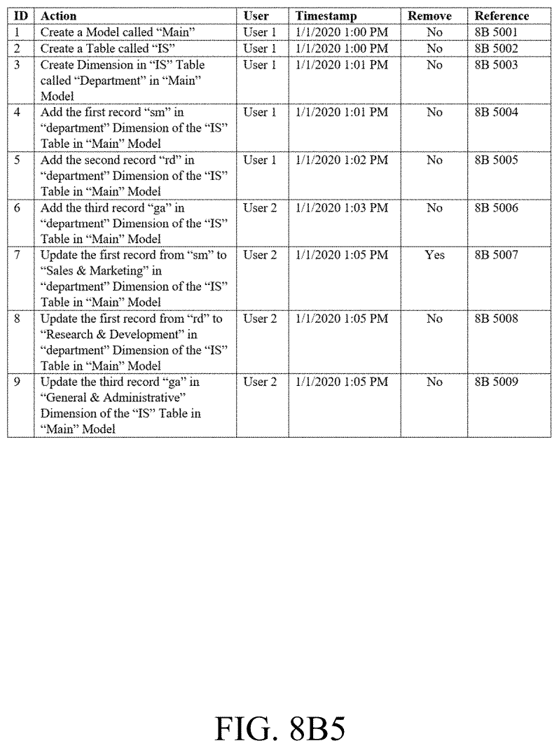

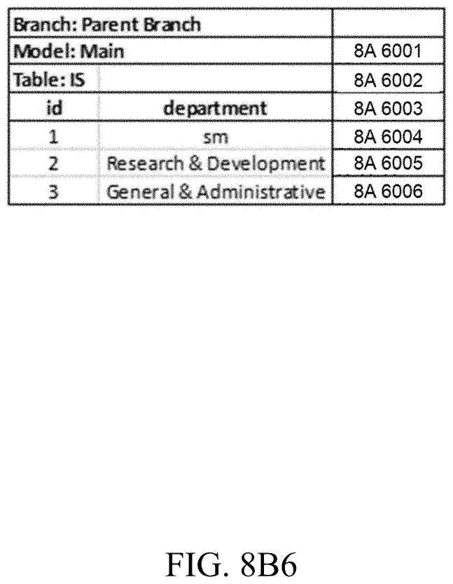

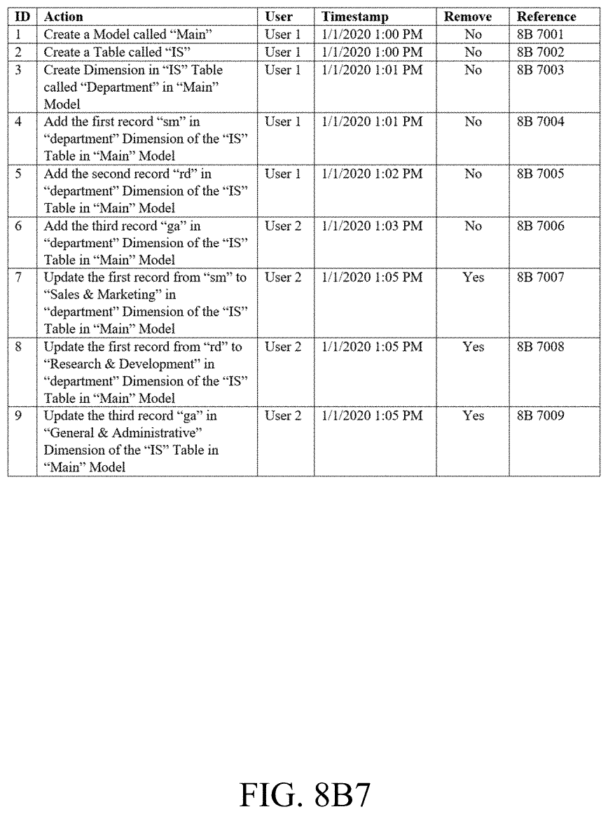

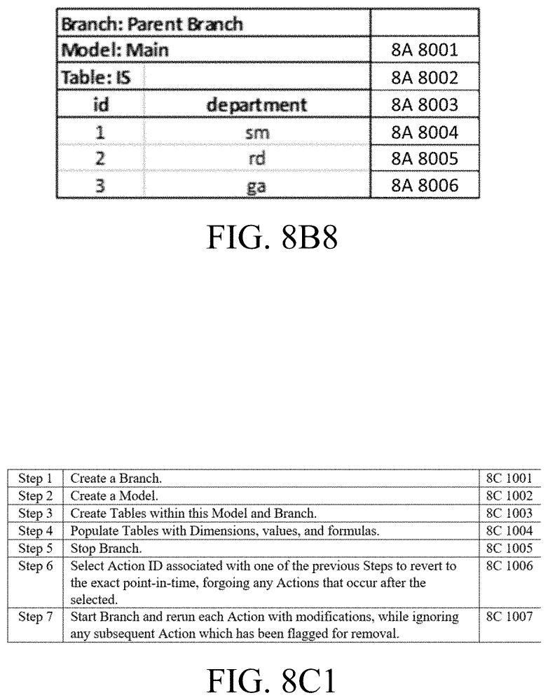

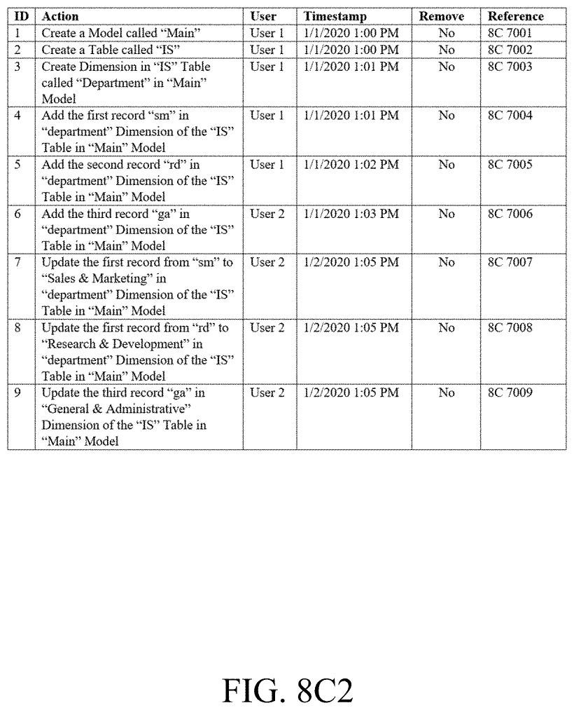

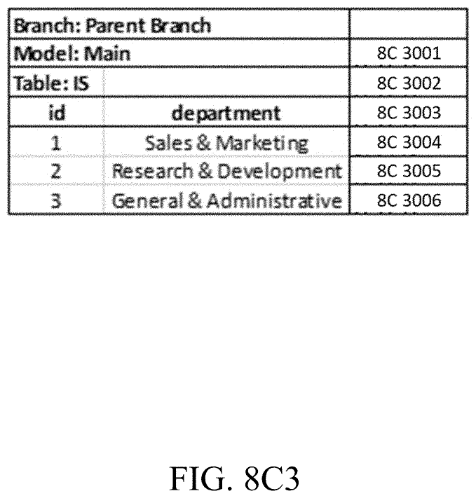

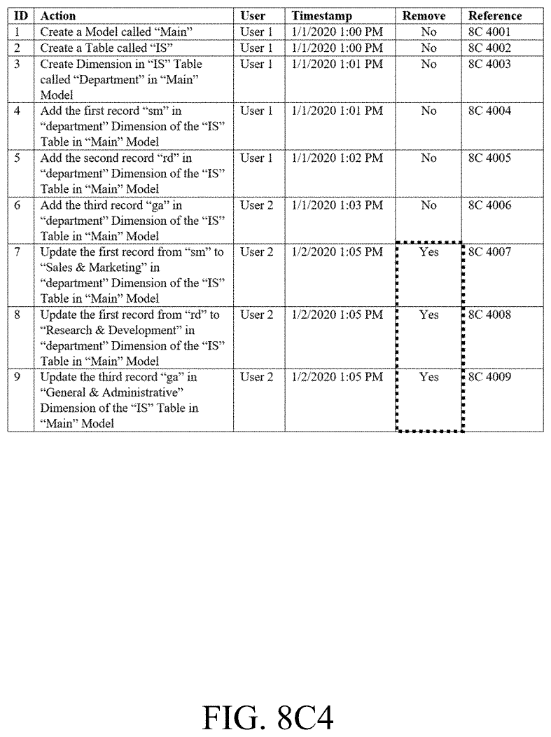

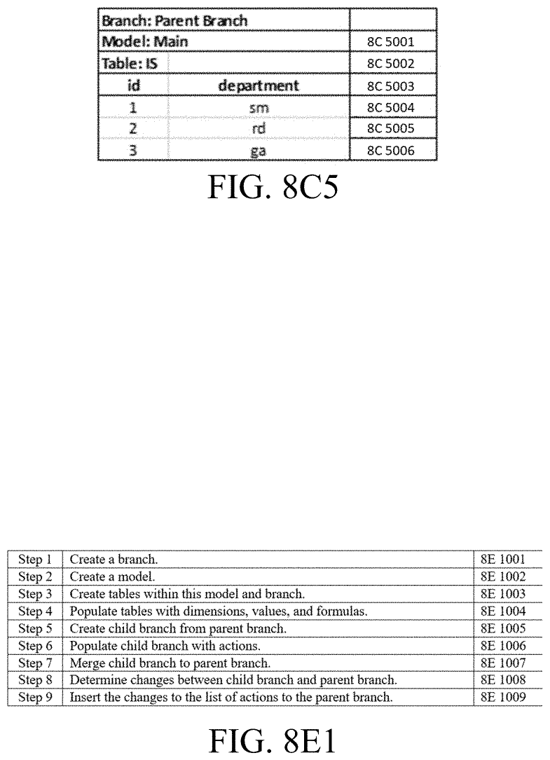

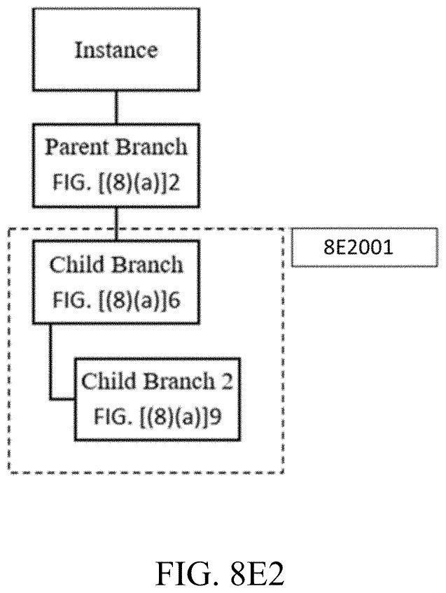

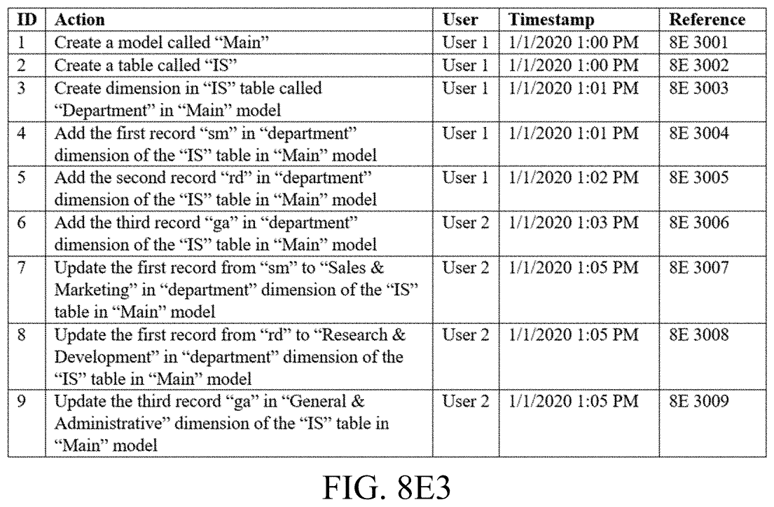

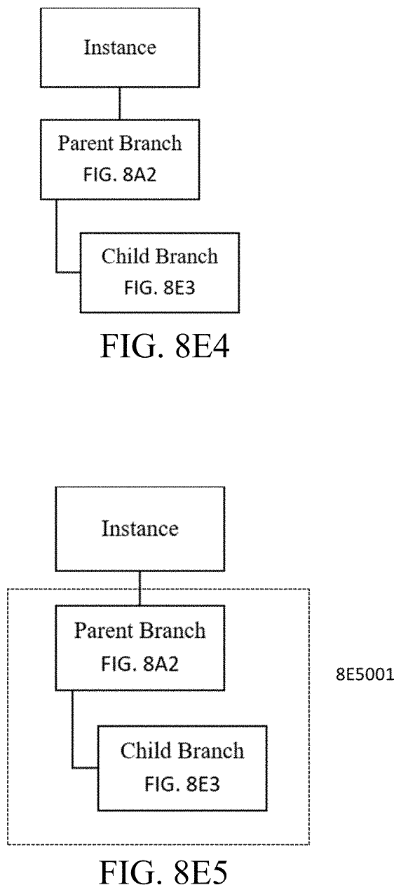

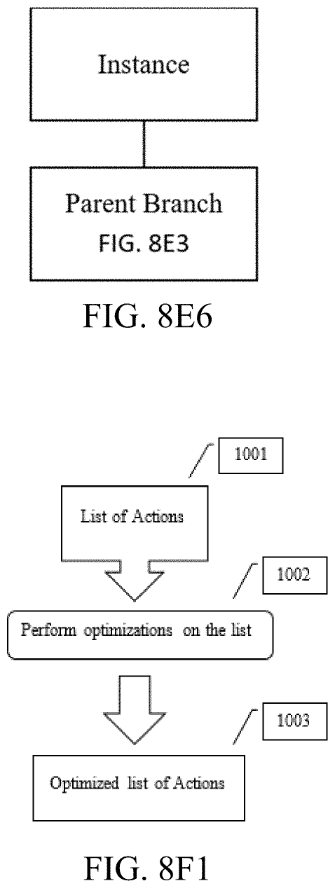

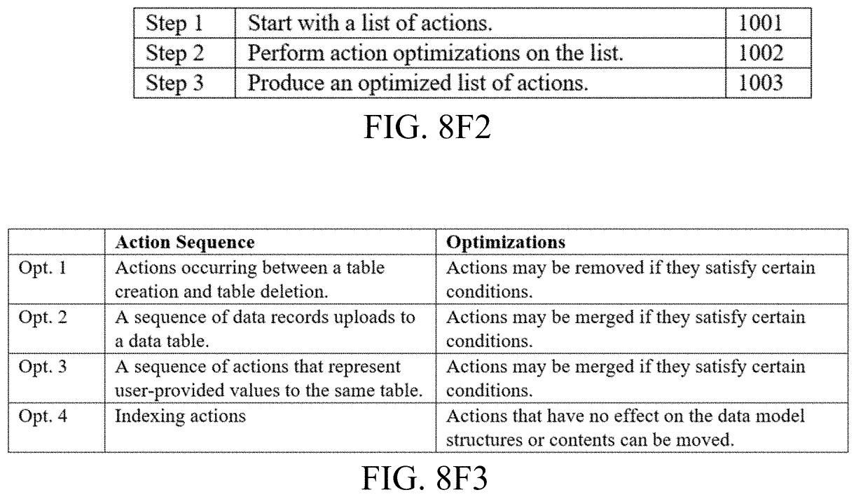

FIG. 2A illustrates pivot dimension in the data of FIG. 4.

FIG. 5 illustrates a pivot frame corresponding to the data in FIG. 4.

FIG. 6 illustrates processing operations to form the pivot frame of FIG. 5.

FIG. 2A1I illustrates processing operations performed in accordance with an embodiment of the invention.

FIG. 2A2I illustrates processing operations performed in accordance with an embodiment of the invention.

FIG. 2A2II illustrates sort operations performed in accordance with an embodiment of the invention.

FIG. 2A2III illustrates processing operations performed in accordance with an embodiment of the invention.

FIG. 2A3I illustrates processing operations performed in accordance with an embodiment of the invention.

FIG. 2A4I illustrates processing operations performed in accordance with an embodiment of the invention.

FIG. 2A5I illustrates processing operations performed in accordance with an embodiment of the invention.

FIG. 2A5II illustrates processing operations performed in accordance with an embodiment of the invention.

FIG. 49A illustrates a pivot table processed in accordance with an embodiment of the invention.

FIG. 50 illustrates a pivot table processed in accordance with an embodiment of the invention.

FIG. 51 illustrates a processed subset of the pivot table of FIG. 50.

FIG. 52 illustrates a processed subset of the pivot table of FIG. 50.

FIG. 2C1 illustrates a pivot frame processed in accordance with an embodiment of the invention.

FIG. 2C2 illustrates a condition with three expressions derived from FIG. 2C1.

FIG. 2C3 illustrates a combined matrix formed in accordance with an embodiment of the invention.

FIG. 2C4 illustrates a column value supplied in accordance with an embodiment of the invention.

FIG. 2C5 illustrates a condition with three expressions formed in accordance with an embodiment of the invention.

FIG. 2C6 illustrates a matrix provided in accordance with an embodiment of the invention.

FIG. 2C7 illustrates a record index supplementing the matrix of FIG. 2C6.

FIG. 2C8 illustrates a condition with three expressions formed in accordance with an embodiment of the invention.

FIG. 2C9 illustrates a missing matrix formed in accordance with an embodiment of the invention.

FIG. 2C10 illustrates a provided matrix formed in accordance with an embodiment of the invention.

FIG. 2C11 illustrates a combined matrix formed in accordance with an embodiment of the invention.

FIG. 2C12 illustrates a record index supplementing the matrix of FIG. 2C11.

FIG. 2C13 illustrates a condition formed in accordance with an embodiment of the invention.

FIG. 2C14 illustrates a missing matrix formed in accordance with an embodiment of the invention

FIG. 2C15 illustrates a provided matrix formed in accordance with an embodiment of the invention.

FIG. 2C16 illustrates a combined matrix formed in accordance with an embodiment of the invention.

FIG. 2C17 illustrates a record index supplementing the matrix of FIG. 2C16.

FIG. 2C18 illustrates a condition formed in accordance with an embodiment of the invention.

FIG. 2C19 illustrates a missing matrix formed in accordance with an embodiment of the invention.

FIG. 2C20 illustrates a provided matrix formed in accordance with an embodiment of the invention.

FIG. 2C21 illustrates a provided matrix formed in accordance with an embodiment of the invention.

FIG. 2C22 illustrates an intermediary combined matrix formed in accordance with an embodiment of the invention.

FIG. 2C23 illustrate another intermediary combined matrix formed in accordance with an embodiment of the invention.

FIG. 2C24 illustrates a final combined matrix formed in accordance with an embodiment of the invention.

FIG. 2C25 illustrates a condition formed in accordance with an embodiment of the invention.

FIG. 2C26 illustrates a missing matrix formed in accordance with an embodiment of the invention.

FIG. 2C27 illustrates a first provided matrix formed in accordance with an embodiment of the invention.

FIG. 2C28 illustrates a second provided matrix formed in accordance with an embodiment of the invention.

FIG. 2C29 illustrates a first intermediary combined matrix formed in accordance with an embodiment of the invention.

FIG. 2C30 illustrates a second intermediate combined matrix formed in accordance with embodiment of the invention.

FIG. 2C31 illustrates a final combined matrix formed in accordance with an embodiment of the invention.

FIG. 2C32 illustrates a pivot frame processed in accordance with an embodiment of the invention.

FIG. 2C33 illustrates a condition formed in accordance with an embodiment of the invention.

FIG. 2C34 illustrates a missing matrix formed in accordance with an embodiment of the invention.

FIG. 2C35 illustrates an intermediary matrix formed in accordance with an embodiment of the invention.

FIG. 2C36 illustrates another intermediary matrix formed in accordance with an embodiment of the invention.

FIG. 2C37 illustrates a final matrix formed in accordance with an embodiment of the invention.

FIG. 2C38 illustrates a pivot frame processed in accordance with an embodiment of the invention.

FIG. 2C39 illustrates a condition formed in accordance with an embodiment of the invention.

FIG. 2C40 illustrates a missing matrix formed in accordance with an embodiment of the invention.

FIG. 2C41 illustrates a provided matrix formed in accordance with an embodiment of the invention.

FIG. 2C42 illustrates a combined matrix formed in accordance with an embodiment of the invention.

FIG. 2C43 illustrates an intermediary matrix formed in accordance with an embodiment of the invention.

FIG. 2C44 illustrates another intermediary matrix formed in accordance with an embodiment of the invention.

FIG. 2C45 illustrates final matrix formed in accordance with an embodiment of the invention.

FIG. 2D1 illustrates processing operations performed in accordance with an embodiment of the invention.

FIG. 2D2 illustrates processing operations performed in accordance with an embodiment of the invention.

FIG. 2D3 illustrates processing operations performed in accordance with an embodiment of the invention.

FIG. 2E1 illustrates processing operations performed in accordance with an embodiment of the invention.

FIG. 2E2 illustrates a pivot table processing in accordance with an embodiment of the invention.

FIG. 2E3 illustrates cell values derived in accordance with an embodiment of the invention.

FIG. 2E4 illustrates table values derived in accordance with an embodiment of the invention.

FIG. 2E5 illustrates table values derived in accordance with an embodiment of the invention.

FIG. 2E6 illustrates a pivot frame derived in accordance with an embodiment of the invention.

FIG. 2E7 illustrates cell values derived in accordance with an embodiment of the invention.

FIG. 2E8 illustrates table values derived in accordance with an embodiment of the invention.

FIG. 2E9 illustrates table values derived in accordance with an embodiment of the invention.

FIG. 2E10 illustrates a pivot frame derived in accordance with an embodiment of the invention.

FIG. 2F1 illustrates a pivot frame processed in accordance with an embodiment of the invention.

FIG. 2F2 illustrates a reference data table to populate a pivot frame.

FIG. 2F3 illustrates a reference data table to populate a pivot frame.

FIG. 2F4 illustrates a pivot frame formed in accordance with an embodiment of the invention.

FIG. 2F5 illustrated linked pivot dimensions formed in accordance with an embodiment of the invention

FIG. 2F6 illustrates a pivot frame formed in accordance with an embodiment of the invention.

FIG. 2F7 illustrates a pivot frame formed in accordance with an embodiment of the invention.

FIG. 2F8 illustrates a reference data table to populate a pivot frame.

FIG. 2F9 illustrates a condition processed in accordance with an embodiment of the invention.

FIG. 2F10 illustrates a pivot frame filtered in accordance with an embodiment of the invention.

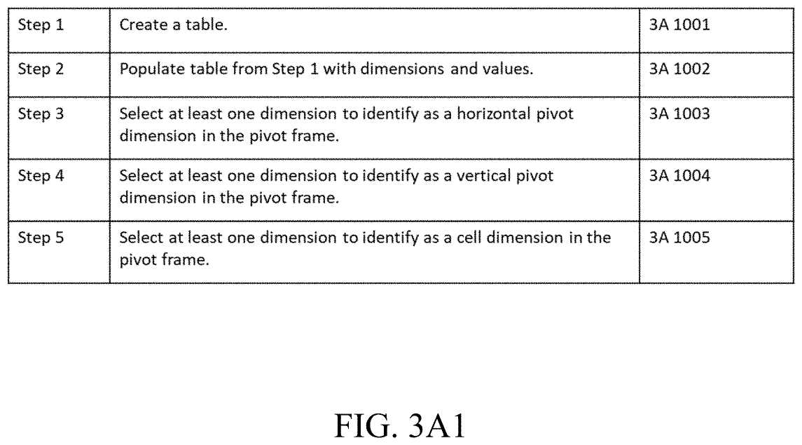

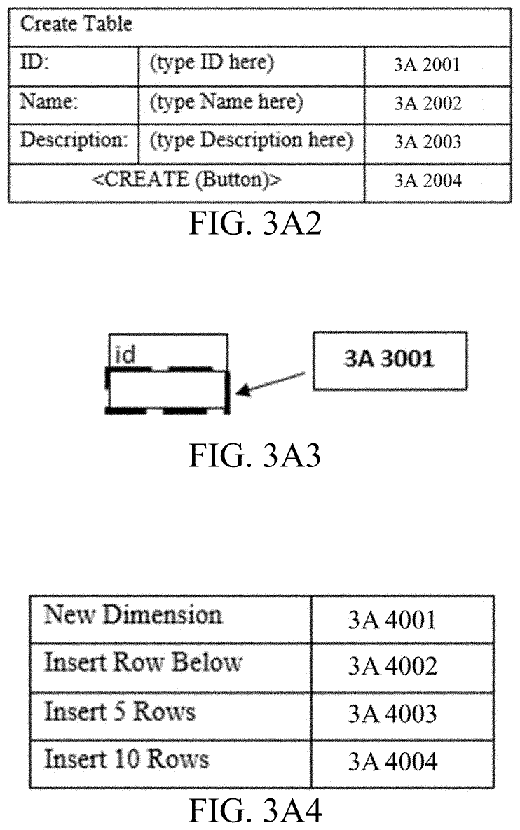

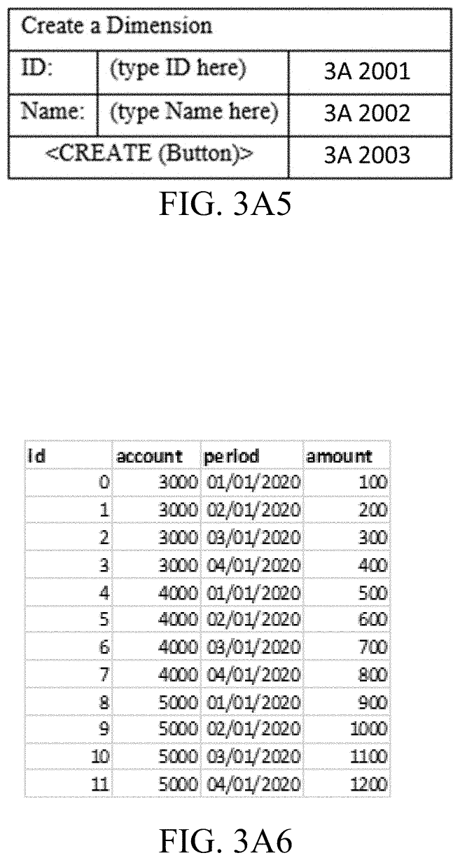

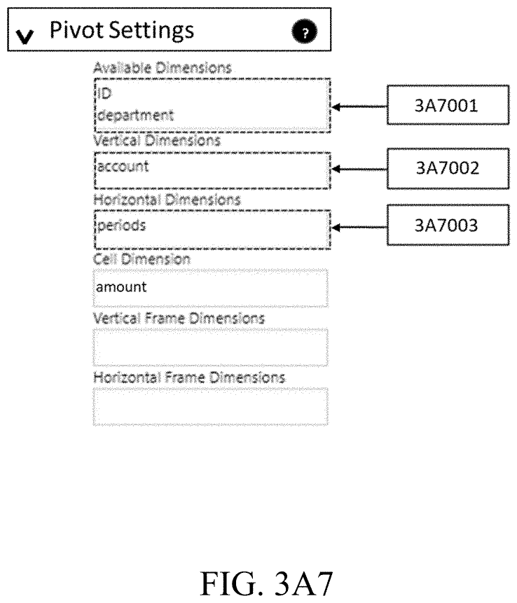

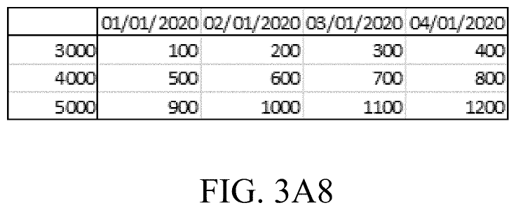

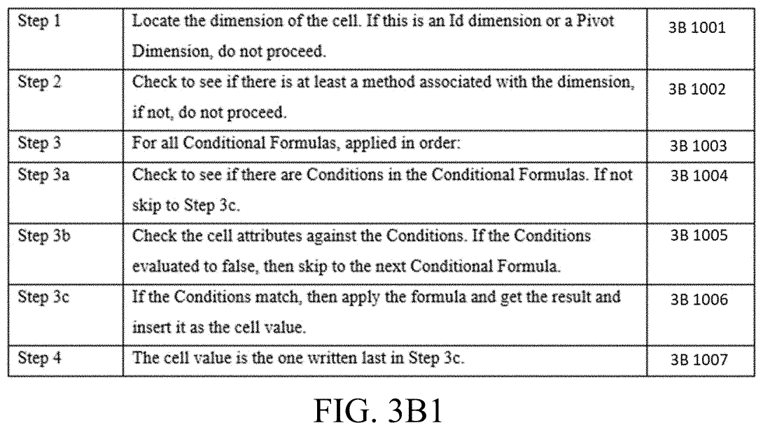

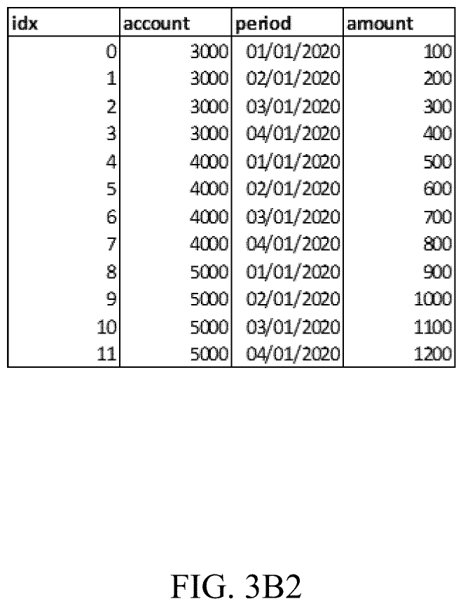

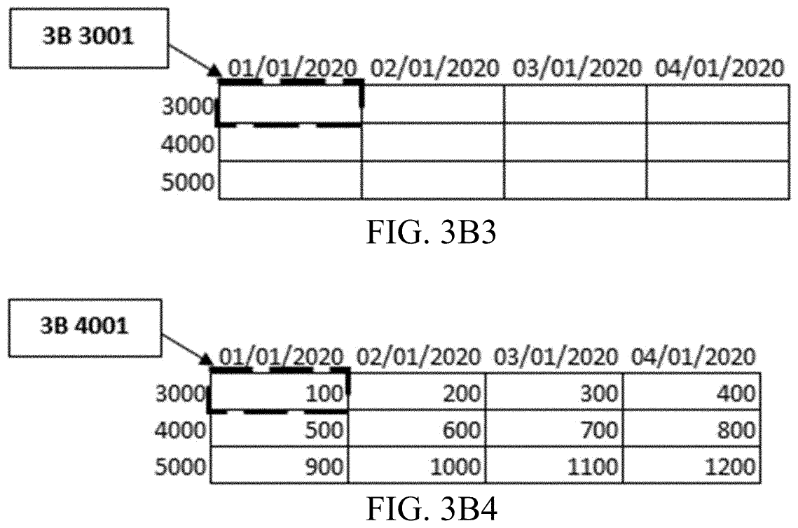

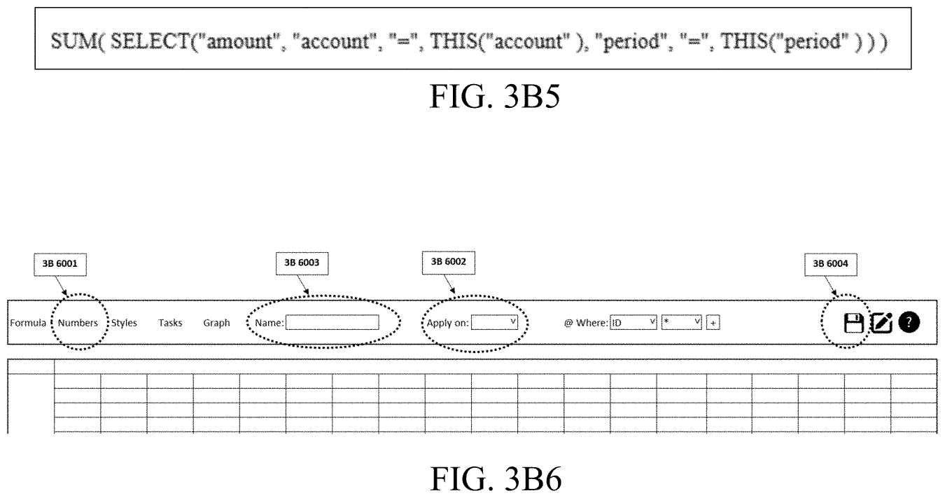

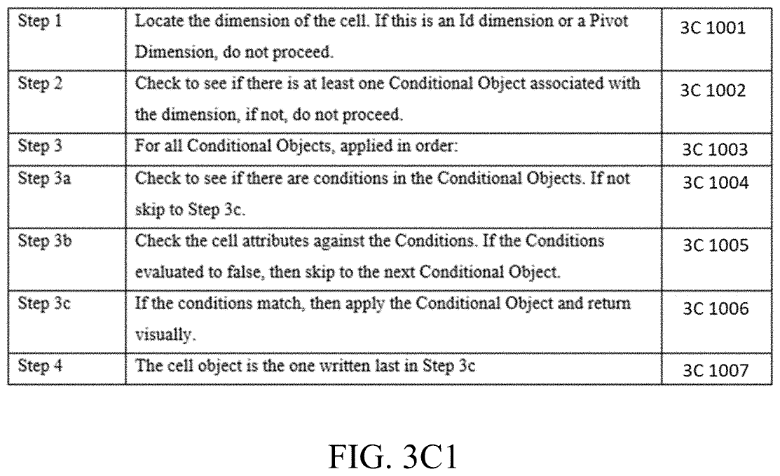

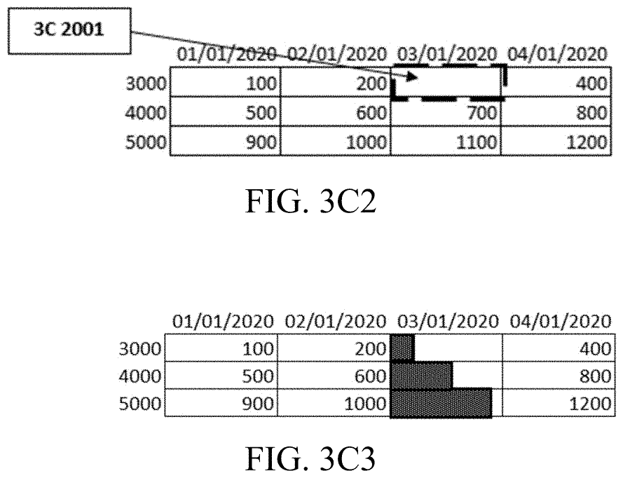

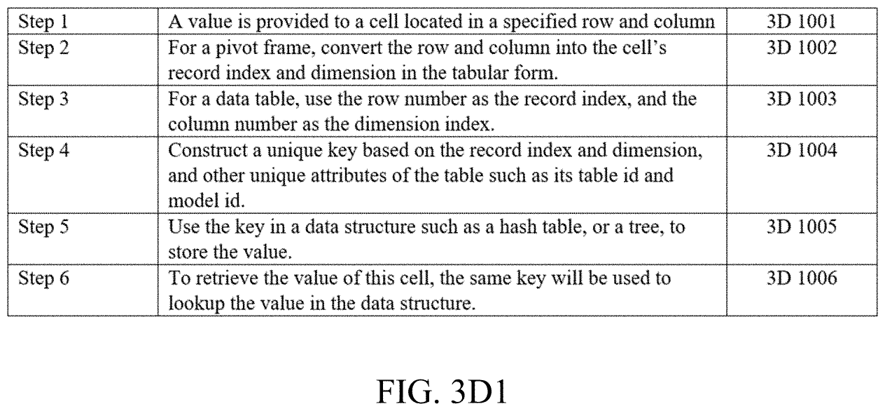

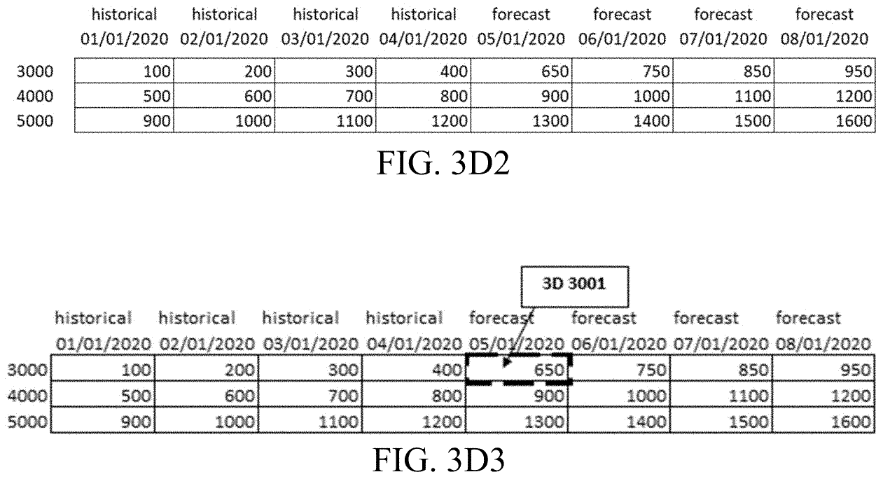

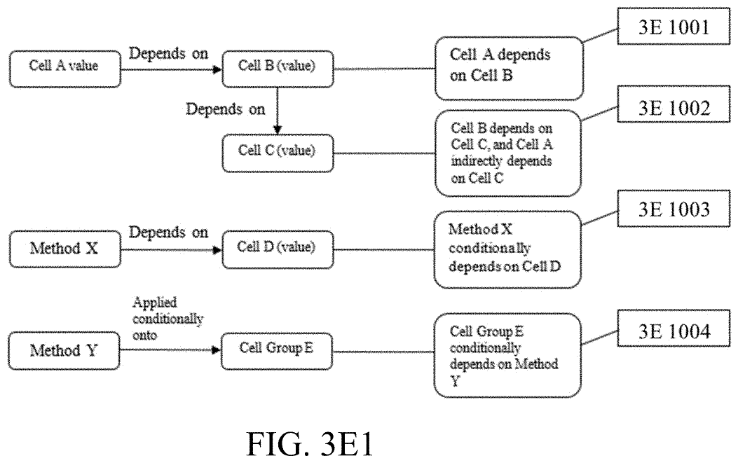

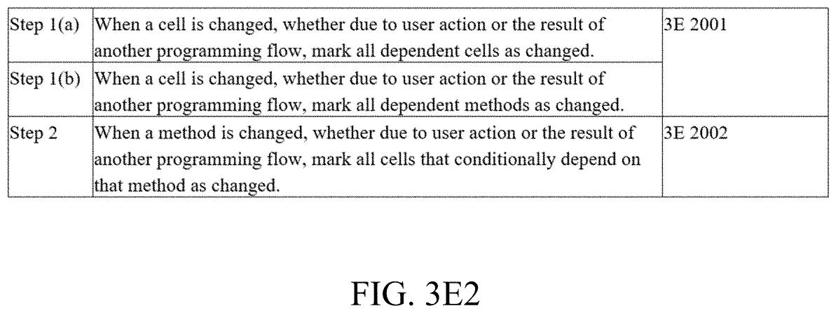

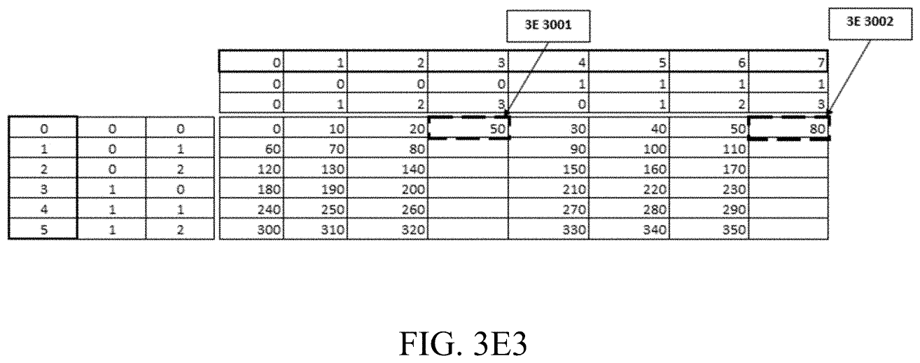

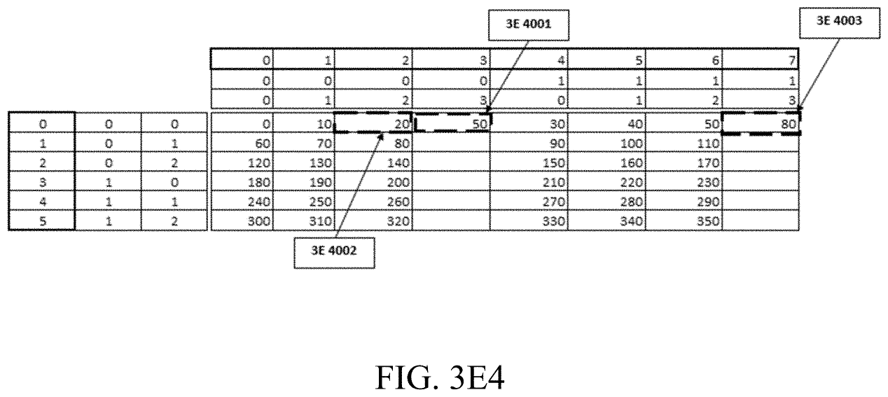

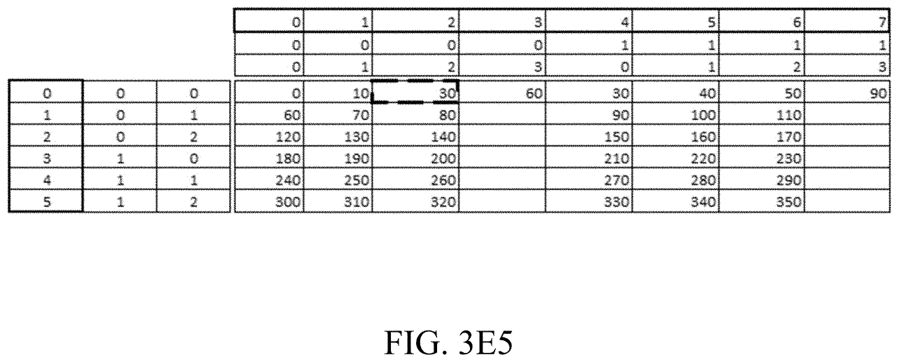

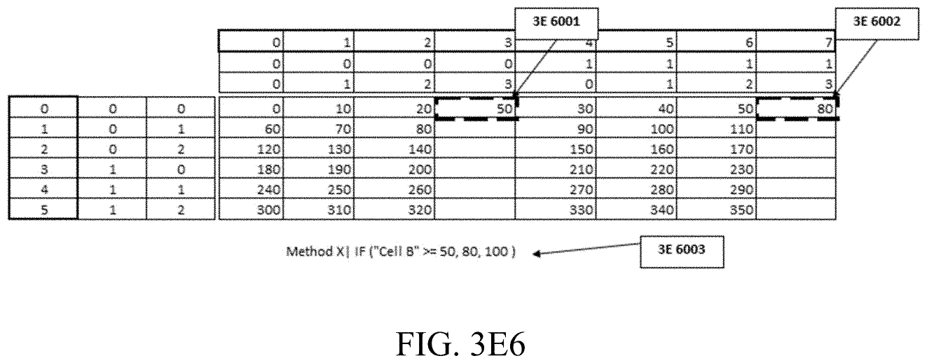

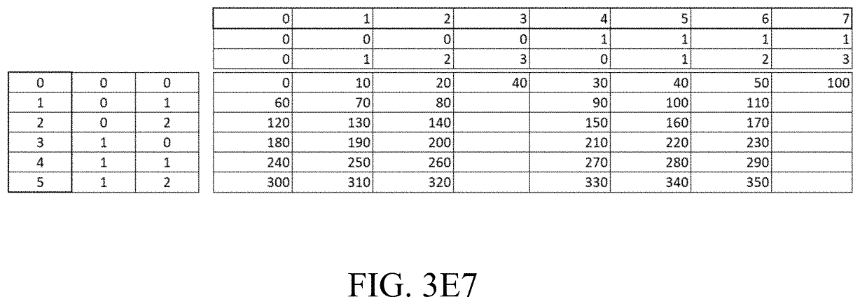

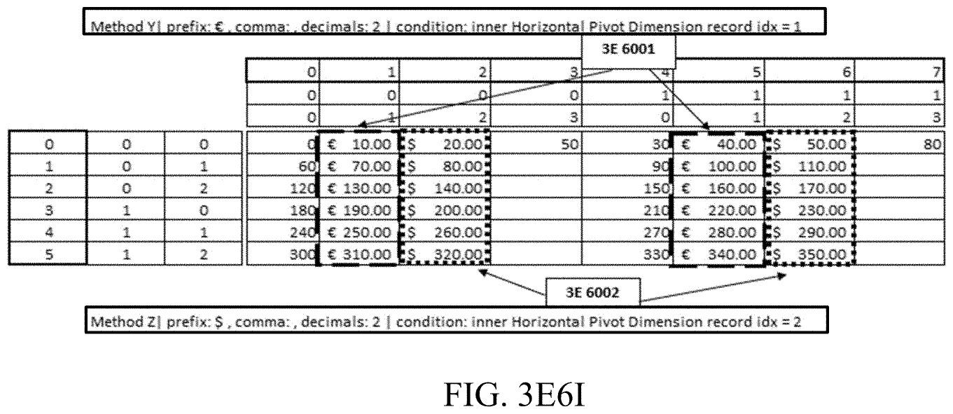

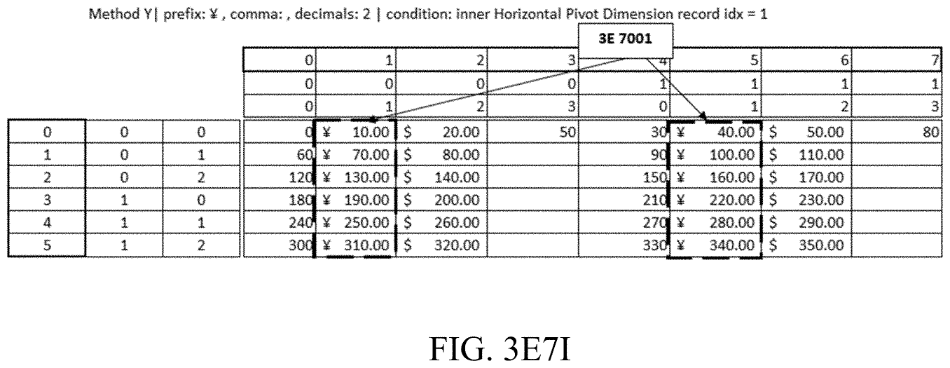

FIG. 3A1 illustrates processing operations performed in accordance with an embodiment of the invention.

FIG. 3A2 illustrates a user interface to prompt input from a user.

FIG. 3A3 illustrates a cell before populated with data.

FIG. 3A4 illustrates a user interface to prompt input from a user.

FIG. 3A5 illustrates a user interface to prompt input from a user.

FIG. 3A6 illustrates a pivot frame formed in accordance with an embodiment of the invention.

FIG. 3A7 illustrates a user interface to prompt input from a user.

FIG. 3A8 illustrates a pivot table formed in accordance with an embodiment of the invention.

FIG. 3B1 illustrates processing operations performed in accordance with an embodiment of the invention.

FIG. 3B2 illustrates a pivot frame formed in accordance with an embodiment of the invention.

FIG. 3B3 illustrates a pivot frame processed in accordance with an embodiment of the invention.

FIG. 3B4 illustrates a pivot frame processed in accordance with an embodiment of the invention.

FIG. 3B5 illustrates a formula resident in a cell of a pivot frame.

FIG. 3B6 illustrates a user interface to prompt input from a user.

FIG. 3C1 illustrates processing operations performed in accordance with an embodiment of the invention.

FIG. 3C2 illustrates a pivot frame processed in accordance with an embodiment of the invention.

FIG. 3C3 illustrates a pivot frame processed in accordance with an embodiment of the invention.

FIG. 3D1 illustrates processing operations performed in accordance with an embodiment of the invention.

FIG. 3D2 illustrates a pivot frame processed in accordance with an embodiment of the invention.

FIG. 3D3 illustrates a pivot frame processed in accordance with an embodiment of the invention.

FIG. 3E1 illustrates cell dependencies processed in accordance with an embodiment of the invention.

FIG. 3E2 illustrates processing operations performed in accordance with an embodiment of the invention.

FIG. 3E3 illustrates a pivot frame processed in accordance with an embodiment of the invention.

FIG. 3E4 illustrates a pivot frame processed in accordance with an embodiment of the invention.

FIG. 3E5 illustrates a pivot frame processed in accordance with an embodiment of the invention.

FIG. 3E6 illustrates a pivot frame processed in accordance with an embodiment of the invention.

FIG. 3E7 illustrates a pivot frame processed in accordance with an embodiment of the invention.

FIG. 3E61 illustrates a pivot frame processed in accordance with an embodiment of the invention.

FIG. 3E71 illustrates a pivot frame processed in accordance with an embodiment of the invention.

FIG. 4A1 illustrates processing operations performed in accordance with an embodiment of the invention.

FIG. 4A2 illustrates processing operations performed in accordance with an embodiment of the invention.

FIG. 4A3 illustrates a pivot frame processed in accordance with an embodiment of the invention.

FIG. 4A4 illustrates cells processed in accordance with an embodiment of the invention.

FIG. 42 illustrates processing operations performed in accordance with an embodiment of the invention.

FIG. 43A illustrates a pivot frame processed in accordance with an embodiment of the invention.

FIG. 43B illustrates a pivot frame processed in accordance with an embodiment of the invention.

FIG. 43C illustrates processing operations performed in accordance with an embodiment of the invention.

FIG. 4D1 illustrates a pivot frame processed in accordance with an embodiment of the invention.

FIG. 4D2 illustrates processing operations performed in accordance with an embodiment of the invention.

FIG. 4D3 illustrates a pivot frame processed in accordance with an embodiment of the invention.

FIG. 4D4 illustrates a pivot frame processed in accordance with an embodiment of the invention.

FIG. 4D5 illustrates cell values derived in accordance with an embodiment of the invention.

FIG. 5A1 illustrates a pivot frame processed in accordance with an embodiment of the invention.

FIG. 5A2 illustrates cells processed in accordance with an embodiment of the invention.

FIG. 5A3 illustrates a table processed in accordance with an embodiment of the invention.

FIG. 5A4 illustrates a user interface associated with an embodiment of the invention.

FIG. 5A5 illustrates a user interface to prompt a user for information.

FIG. 5A6 illustrates a user interface to prompt a user for information.

FIG. 5A7 illustrates processing operations performed in accordance with an embodiment of the invention.

FIG. 5A8 illustrates cells processed in accordance with an embodiment of the invention.

FIG. 5A9 illustrates a table processed in accordance with an embodiment of the invention.

FIG. 5A10 illustrates a table processed in accordance with an embodiment of the invention

FIG. 5A11 illustrates a user interface to solicit information from a user.

FIG. 5C1 illustrates a user interface utilized in accordance with an embodiment of the invention.

FIG. 5C2 illustrates processing operations performed in accordance with an embodiment of the invention.

FIG. 5C3 illustrates a user interface utilized in accordance with an embodiment of the invention.

FIG. 5C4 illustrates a pivot frame processed in accordance with an embodiment of the invention.

FIG. 5C5 illustrates a user interface utilized in accordance with an embodiment of the invention.

FIG. 5C6 illustrates a pivot frame processed in accordance with an embodiment of the invention.

FIG. 5C7 illustrates a pivot frame processed in accordance with an embodiment of the invention.

FIG. 5C8 illustrates a user interface utilized in accordance with an embodiment of the invention.

FIG. 5C9 illustrates a pivot frame processed in accordance with an embodiment of the invention.

FIG. 5C10 illustrates a user interface utilized in accordance with an embodiment of the invention.

FIG. 5C11 illustrates a pivot frame processed in accordance with an embodiment of the invention.

FIG. 5C12 illustrates an income statement processed in accordance with an embodiment of the invention.

FIG. 5C13 illustrates a user interface utilized in accordance with an embodiment of the invention.

FIG. 5C14 illustrates an income statement processed in accordance with an embodiment of the invention.

FIG. 5C15 illustrates a user interface utilized in accordance with an embodiment of the invention.

FIG. 5D1 illustrates a user interface utilized in accordance with an embodiment of the invention.

FIG. 5D2 illustrates processing operations associated with an embodiment of the invention.

FIG. 5D3 illustrates a user interface utilized in accordance with an embodiment of the invention.

FIG. 5D4 illustrates a user interface utilized in accordance with an embodiment of the invention.

FIG. 5D5 illustrates a user interface utilized in accordance with an embodiment of the invention.

FIG. 5D6 illustrates cells processed in accordance with an embodiment of the invention.

FIG. 5D7 illustrates a user interface utilized in accordance with an embodiment of the invention.

FIG. 5D8 illustrates a user interface utilized in accordance with an embodiment of the invention.

FIG. 5D9 illustrates cells processed in accordance with an embodiment of the invention.

FIG. 5D10 illustrates processing operations performed in accordance with an embodiment of the invention.

FIG. 5D11 illustrates a user interface utilized in accordance with an embodiment of the invention.

FIG. 5D12 illustrates a user interface utilized in accordance with an embodiment of the invention.

FIG. 5D13 is a key describing the cell graph of FIG. 5D12

FIG. 5D14 illustrates processing operations associated with an embodiment of the invention.

FIG. 5D15 illustrates a user interface utilized in accordance with an embodiment of the invention.

FIG. 5E1 illustrates a pivot frame processed in accordance with an embodiment of the invention.

FIG. 5E2 illustrates a column of cells processed in accordance with an embodiment of the invention.

FIG. 5E3 illustrates a table processed in accordance with an embodiment of the invention.

FIG. 5E4 illustrates a pivot frame processed in accordance with an embodiment of the invention.

FIG. 5E5 illustrates a user interface utilized in accordance with an embodiment of the invention.

FIG. 5E6 illustrates a user interface utilized in accordance with an embodiment of the invention.

FIG. 5E7 illustrates processing operations performed in accordance with an embodiment of the invention.

FIG. 5E8 illustrates a user interface utilized in accordance with an embodiment of the invention.

FIG. 5E9 illustrates a user interface utilized in accordance with an embodiment of the invention.

FIG. 6A1 illustrates processing operations performed in accordance with an embodiment of the invention

FIG. 6A2 illustrates processing operations performed in accordance with an embodiment of the invention.

FIG. 6A3 illustrates processing operations performed in accordance with an embodiment of the invention.

FIG. 6A4 illustrates a table processed in accordance with an embodiment of the invention.

FIG. 6A31 illustrates processing operations performed in accordance with an embodiment of the invention.

FIG. 6A41 illustrates a table processed in accordance with an embodiment of the invention.

FIG. 6A5 illustrates a table processed in accordance with an embodiment of the invention.

FIG. 6A6 illustrates cells processed in accordance with an embodiment of the invention.

FIG. 6A7 illustrates a table processed in accordance with an embodiment of the invention.

FIG. 6A8 illustrates cells processed in accordance with an embodiment of the invention.

FIG. 6A9 illustrates a table processed in accordance with an embodiment of the invention.

FIG. 6A10 illustrates a table processed in accordance with an embodiment of the invention.

FIG. 6A11 illustrates a table processed in accordance with an embodiment of the invention.

FIG. 6B1 illustrates processing operations performed in accordance with an embodiment of the invention.

FIG. 6B2 illustrates a table processed in accordance with an embodiment of the invention.

FIG. 6B3 illustrates conditions set in accordance with an embodiment of the invention.

FIG. 6B4 illustrates a pivot frame processed in accordance with an embodiment of the invention.

FIG. 6B5 illustrates a table processed in accordance with an embodiment of the invention.

FIG. 6B6 illustrates a table processed in accordance with an embodiment of the invention.

FIG. 6C1 illustrates processing operations performed in accordance with an embodiment of the invention.

FIG. 6C2 illustrates a table processed in accordance with an embodiment of the invention.

FIG. 6D1 illustrates a process flow utilized in accordance with an embodiment of the invention.

FIG. 6D2 illustrates processing operations performed in accordance with an embodiment of the invention.

FIG. 6E1 illustrates a process flow utilized in accordance with an embodiment of the invention.

FIG. 6E2 illustrates processing operations performed in accordance with an embodiment of the invention.

FIG. 7A1 illustrates an architecture utilized in accordance with an embodiment of the invention.

FIG. 7A2 illustrates processing operations performed in accordance with an embodiment of the invention.

FIG. 7A3 illustrates terms utilized in characterizing the invention.

FIG. 7B1 illustrates a process flow associated with an embodiment of the invention.

FIG. 7B2 illustrates processing operations performed in accordance with an embodiment of the invention.

FIG. 7C1 illustrates a process flow associated with an embodiment of the invention.

FIG. 7C2 illustrates processing operations performed in accordance with an embodiment of the invention.

FIG. 8A1 illustrates processing operations associated with an embodiment of the invention.

FIG. 8A2 illustrates processing operations associated with an embodiment of the invention.

FIG. 8A3 illustrates cells processed in accordance with an embodiment of the invention.

FIG. 8A4 illustrates processing operations associated with an embodiment of the invention.

FIG. 8A5 illustrates cells processed in accordance with an embodiment of the invention.

FIG. 8A6 illustrates processing operations associated with an embodiment of the invention.

FIG. 8A7 illustrates cells processed in accordance with an embodiment of the invention.

FIG. 8A8 illustrates cells processed in accordance with an embodiment of the invention.

FIG. 8A9 illustrates processing operations associated with an embodiment of the invention.

FIG. 8A10 illustrates branch processing associated with an embodiment of the invention.

FIG. 8A11 illustrates branch processing associated with an embodiment of the invention.

FIG. 8B1 illustrates processing operations associated with an embodiment of the invention.

FIG. 8B2 illustrates a table processed in accordance with an embodiment of the invention.

FIG. 8B3 illustrates processing operations performed in accordance with an embodiment of the invention.

FIG. 8B4 illustrates a table processed in accordance with an embodiment of the invention.

FIG. 8B5 illustrates processing operations associated with an embodiment of the invention.

FIG. 8B6 illustrates a table processed in accordance with an embodiment of the invention.

FIG. 8B7 illustrates processing operations associated with an embodiment of the invention.

FIG. 8B8 illustrates a table processed in accordance with an embodiment of the invention.

FIG. 8C1 illustrates processing operations associated with an embodiment of the invention

FIG. 8C2 illustrates processing operations associated with an embodiment of the invention.

FIG. 8C3 illustrates a table processed in accordance with an embodiment of the invention.

FIG. 8C4 illustrates processing operations associated with an embodiment of the invention.

FIG. 8C5 illustrates a table processed in accordance with an embodiment of the invention.

FIG. 8E1 illustrates processing operations performed in accordance with an embodiment of the invention.

FIG. 8E2 illustrates branch processing performed in accordance with an embodiment of the invention.

FIG. 8E3 illustrates processing operations performed in accordance with an embodiment of the invention.

FIG. 8E4 illustrates branch processing performed in accordance with an embodiment of the invention.

FIG. 8E5 illustrates branch processing performed in accordance with an embodiment of the invention.

FIG. 8E6 illustrates branch formation in accordance with an embodiment of the invention.

FIG. 8F1 illustrates processing operations performed in accordance with an embodiment of the invention.

FIG. 8F2 illustrates processing operations performed in accordance with an embodiment of the invention.

FIG. 8F3 illustrates processing operations performed in accordance with an embodiment of the invention.

Like reference numerals refer to corresponding parts throughout the several views of the drawings.

### DETAILED DESCRIPTION OF THE INVENTION

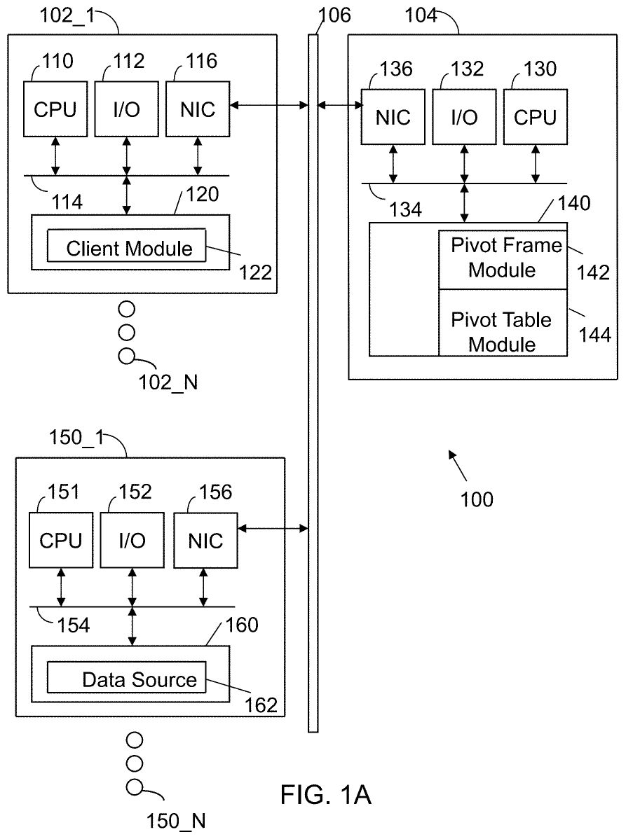

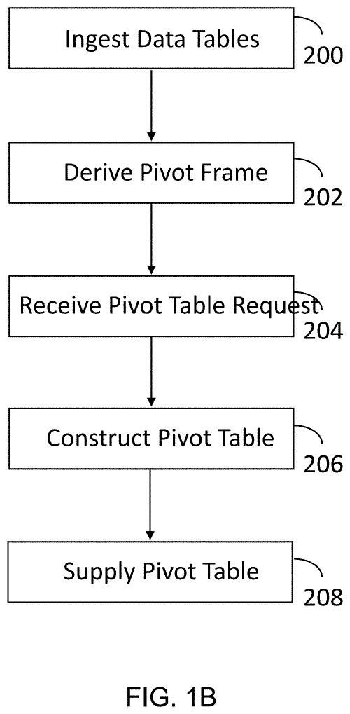

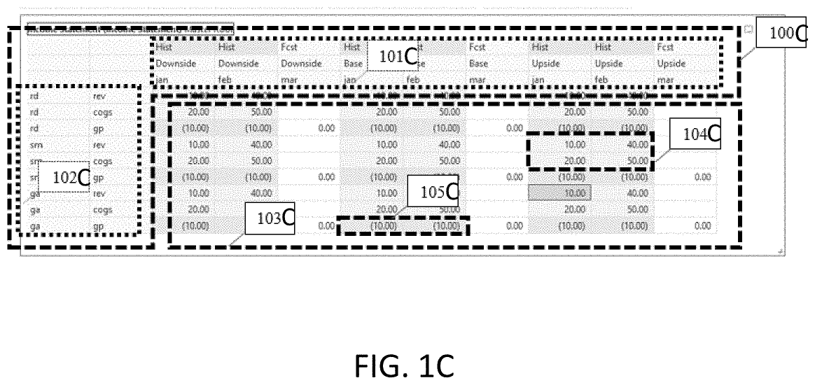

FIG. 1A illustrates a system 100 configured in accordance with an embodiment of the invention. The system 100 includes a set of client devices 102_1 through 102_N that communicate with a server 104 via a network 106, which may be any combination of wired and wireless networks. Each client device includes a processor (e.g., central processing unit) 110 and input/output devices 112 connected via a bus 114. The input/output devices 112 may include a keyboard, mouse, touch display and the like. A network interface circuit 116 is also connected to the bus 114. The network interface circuit 116 provides connectivity to network 106. A memory 120 is also connected to the bus 114. The memory 120 stores instructions executed by processor 110. The memory 120 may store a client module 122, which is an application that allows a user to communicate with server 104 and data sources 150_1 through 150_N. At the direction of the client module 122, the server 104 collects from the data sources 150_1 through 150_N source data tables. A pivot frame is derived from the source data tables. The pivot frame is subsequently used to supply a pivot table to one or more of client machines 102_1 through 102_N.

Server 104 includes a processor 130, input/output devices 132, a bus 134 and a network interface circuit 136. A memory 140 is connected to the bus 134. The memory 140 stores a pivot frame module 142 with instructions executed by processor 136 to form a pivot frame. The pivot frame has an index column with index column values representing each unique combination of records in the source data tables, pivot dimension columns forming a deterministic matrix where each row of the deterministic matrix represents a unique combination of records in the source data tables, and a value column with individual values assigned to corresponding index column values. The pivot table module 144 includes instructions executed by processor 136 to form a pivot table from a pivot frame, as detailed below.

System 100 also includes data source machines 150_1 through 150_N. Each data source machine includes a processor 151, input/output devices 152, a bus 154 and a network interface circuit 156. A memory 160 is connected to bus 154. The memory stores a data source 162 with source data tables.

FIG. 1B illustrates processing operations associated with an embodiment of the invention. Initially, source data tables are ingested 200. For example, server 104 may ingest the source data tables from one or more of data source machines 150_1 through 150_N. A pivot frame is then derived 202. The pivot frame module 142 may be used to implement this operation. The pivot frame has an index column with index column values representing each unique combination of records in the source data tables, pivot dimension columns forming a deterministic matrix where each row of the deterministic matrix represents a unique combination of records in the source data tables, and a value column with individual values assigned to corresponding index column values.

A pivot table request is received 204. The request may be received at server 104 from one or more client machines 102_1 through 102_N. The request may be received prior to ingesting the source data tables. A pivot table is constructed from the pivot frame 206. The pivot table module 144 may be used to implement this operation. The pivot table is then supplied 208. For example, server 104 supplies the pivot table to one or more of client machines 102_1 through 102_N.

Disclosed is a method to perform analyses and present information using a pivot table-like grid, called a pivot frame. The disclosed techniques allow a user the unique ability to define a pivot header and place conditional formulas and conditional objects in the pivot body. This facilitates various types of analyses, including forecasting a company's income statement by department and for different scenarios. This method provides the user with the benefit of placing formulas and objects conditionally on the pivot body.

FIG. 1C illustrates a pivot frame populated in accordance with an embodiment of the invention. The pivot frame includes a pivot header 100C, which itself contains a horizontal pivot header 101C and a vertical pivot header 102C. The pivot frame also includes a pivot body 103C which has a conditional formula 104C.

FIG. 2 illustrates the Horizontal Pivot Header 101C from FIG. 1C, which is composed of one horizontal frame dimension 201C and two horizontal pivot dimensions 202C.

FIG. 3 illustrates the vertical pivot header 102C from FIG. 1, which is composed of two vertical pivot dimensions. In one embodiment, the pivot header 100C is constructed for analyzing each time period of different scenarios for an income statement by department. The time periods and scenarios are represented as the horizontal pivot dimensions 202C. The time periods are January (“jan”), February (“feb”) and March (“mar”). The scenarios are Downside, Base and Upside. The Horizontal Frame Dimension 201C indicates whether the time period for a given column is Historical (“Hist”) or Forecast (“Fcst”). The departments and income statement line items are represented as the vertical pivot dimensions in FIG. 3. The departments are Research & Development (“rd”), Sales & Marketing (“sm”) and General & Administrative (“ga”). The income statement line items are Revenue (“rev”), Cost of Goods Sold (“cogs”) and Gross Profit (“gp”). Conditional Formulas 104C define how each cell of the pivot frame is to be evaluated. Conditional objects 105C define arbitrary objects contained in each cell, such as information for formatting, styling, comments, tasks permissions and visualizations.

Analyses can be performed by creating the pivot frame in FIG. 1C, populating the pivot frame with conditional formulas and conditional objects and by viewing the pivot frame with various combinations of pivot dimensions and frame dimensions. Such analyses can provide a user with information on a company's historical performance as well as forecast performance for each department, for each time period and under different scenarios.

FIG. 4 illustrates a pivot frame that contains a pivot header with two horizontal pivot dimensions and two vertical pivot dimensions. The first horizontal pivot dimension 401 references a data table, which has the id of “h0,” contains records and contains the values 0 and 1. This is shown as element 2A2001 in FIG. 2A. The second horizontal pivot dimension 402 references a data table that has the id of “h1” and contains records with values 0, 1 and 2. This is shown as element 2A2002 in FIG. 2A. The first vertical pivot dimension 403 references a data table that has the id of “v0” and contains records with values 0 and 1. This is shown as element 2A2003 in FIG. 2A. The second vertical pivot dimension 404 references a data table that has the id “v1” and contains records with values 0, 1 and 2. This is shown as element 2A2004 in FIG. 2A. A column index 405 and row index 406 are included to facilitate descriptions.

The same data represented in FIG. 4 as a pivot frame can be represented as the data table 501 in FIG. 5. The data table contains dimensions for the record index 502, the pivot dimensions 503 and a value 504.

FIG. 6 provides the steps required to create a data table, such as the one demonstrated in FIG. 5, which can also be viewed as a pivot frame, such as the one demonstrated in FIG. 4, by using the methods described herein. A pivot frame is created by defining it with an id and name 601. The length of the pivot frame is then defined as the product of the lengths of each pivot dimension's reference data table 602. In the example provided in FIG. 5, this is equal to 2*3 * 2*3=36 since the pivot dimensions are the tables with id's “h0”, “h1”, “v0” and “v1” and those tables have lengths equal to 2, 3, 2 and 3, respectively. The columns of the Data Table are then added 603. In the example provided in FIG. 5, the columns “id” 502; the pivot dimensions 503 “h0”, “h1”, “v0” and “v1”; and dimension “value” 504 are added. Then, each value of the “id” column is populated with each value being equal to a record index 604, such that the “id” column of the first record is 0, the second record 1, the third record is 2 and so on. An algorithm for populating the pivot dimensions is then selected 605 and the result of providing that algorithm with the values of the pivot dimension's reference tables' indices produces the matrix 505 in FIG. 5.

The algorithm selected in Step 5 605 is a Cartesian Product for the examples provided herein, but any algorithm that meets the following criteria may be used:
The algorithm receives as input a list of values corresponding to the lengths of each pivot dimension's reference table.
The algorithm generates a deterministic matrix with the number of columns equal to the number of pivot dimensions and the number of rows equal to the pivot length.
Each value in the generated matrix is unique and can be associated with a unique record in the representation of the pivot frame.

Alternative algorithms include matrix multiplication with certain transformations.

The steps outlined in FIG. 6 allow the following methods to be performed on a pivot frame:
1. Method to determine a record index given a row and column.
2. Method to determine a record index given the values of each Pivot Dimension.
3. Method to determine a row and column given record index.
4. Method to determine a row and column given the values of each Pivot Dimension.
5. Method to determine the values of each Pivot Dimension given a record index.
6. Method to determine the values of each Pivot Dimension given a row and column.

The methods listed above provide the computational efficiency that allow a pivot frame to be used as an analytical and reporting tool on models involving many dimensions and formulas.

FIG. 2A1I describes the method by which a record index 507 of a pivot frame, such as shown in FIG. 5, can be determined when provided a row and column index of a pivot frame. In one embodiment of this invention, a user may want to determine a record index 507 in a PivotFrame given the row index of 3 and column index of 4, which correspond to 406 and 405 of FIG. 4. The horizontal pivot body length is computed 2A11001. In this example, the value is 6, since the horizontal pivot dimensions are “h0” and “h1”, and “h0” contains two records in its Reference Data Table 2A2001 and “h1” contains three records in its Reference Data Table 2A2002. The user then calculates the record index 2A11002 by multiplying the desired row index of 3 by the Horizontal Pivot Body Length, which is 6 in this example, and then adding the column index of 4, which results in 3×6+4=22. Therefore, the record index is 22. The fact that the data in a pivot frame is the same when represented as a data table and as a pivot table-like grid can be confirmed as the record at index 22 in the Data Table view 506 has the value 220, which is the same value at row index 3 and column index 4 visible in the Pivot Table view 407.

This invention enables the following:
The ability to quickly determine the record index within a pivot frame if provided the corresponding row and column indexes.
The ability to generate pivot from a pivot frame table-like grids that have arbitrarily large numbers of pivot dimensions, frame dimensions, rows and columns, yet still be able to retrieve the contents of any pivot body cell in O(1) time.
The ability to have a single memory location and single evaluation for each entry in a data frame regardless of how the pivot frame is represented.

Thus, the record index is the row number of a pivot frame. By using the deterministic properties of the algorithm selected in 605, such as but not limited to a Cartesian product, efficient arithmetic can be used to retrieve a cell in a pivot frame given its row and column indexes. Note that this is achieved without the need to compute the actual Cartesian product. The fact that the underlying data structure would reflect an algorithm provided by 605, such as the Cartesian product, allows 0(1) time calculations without having to create the Cartesian product.

FIG. 2A2I describes the method by which a record index 507 of a pivot frame can be determined when provided with the record indexes corresponding to each pivot dimension's reference data table, also referred to as the pivot dimension record indexes 508.

The provided pivot dimension record indexes correspond to the underlying record indexes in the reference data tables of the pivot dimensions in the horizontal pivot header and the vertical pivot header. The association is determined using a pivot dimension sorting algorithm, which is step 1 in FIG. 2A2I. FIG. 2A2II provides an example of such a sorting algorithm. For example, a user may provide the values in row 508 in FIG. 5, which is the list of numbers 1, 0, 1 and 1. The first number in that list, 1, corresponds to the record at index 1 in the table h0 2A2001 of FIG. 2A. The second number in that list, 0, corresponds to the record at index 0 in the table h1 2A2002. The third number in that list, 1, corresponds to the record as index 1 in the table v0 2A2003. The fourth number in that list, 1, corresponds to the record at index 1 in the table v1 2A2004.

In one embodiment, a user may want to determine the record index in a pivot frame given the first vertical pivot dimension 403 has a value corresponding to record index 1 410 in that pivot dimension's reference data table 2A2001, the second vertical pivot dimension 404 has a value corresponding to record index 0 411 in that pivot dimension's reference data table 2A2002, the first horizontal pivot dimension 401 has a value corresponding to record index 1 408 in that pivot dimension's reference data table 2A2003, and the second Horizontal Pivot Dimension 402 has a value corresponding to record index 1 409 in that Pivot Dimension's Reference Data Table 2A2004. These record indexes correspond to the array of numbers 1, 0, 1 and 1, which are called the pivot dimension record indexes array. The cell being sought can also be expressed as having a row index 406 of 3, a horizontal 405 index of 4 and a value of 220 as shown with element 407 in FIG. 4.

The user first creates a list of the pivot dimension record indexes provided and sorts that list according to a pivot dimension sorting algorithm, such as the one described in FIG. 2A2II. Given the vertical pivot dimensions are “v0” and “v1”, and the horizontal pivot dimensions are “h0” and “h1”, the list is sorted with the order “v0”, “v1”, “h0” and “h1”, which results in the pivot dimension record indexes being a list with numbers 1, 0, 1 and 1. This list corresponds to the values seen in 508.

The pivot lengths of the pivot frame are calculated 2A21002, which is step 2 of FIG. 2A2I. The pivot lengths are computed as an array where each element is the length of each pivot dimension's reference data table, where the pivot dimensions are ordered by the pivot dimension sorting algorithm. The total number of records in tables v0, v1 h0 and h1 are 2, 3, 2 and 3. Based on the reference data table lengths provided in FIG. 2A, the Pivot Lengths is equal to the array with elements 2, 3, 2 and 3.

The record index is then calculated 2A21003, which is step 3 of FIG. 2A2I. The record index may be calculated using the algorithm in FIG. 2A2III. The pivot dimension record indexes obtained above are 1, 01, 1 and 1. The first element of the Pivot Dimension Record Indexes array is 1. The product of all Pivot Length elements which come after the first element in the pivot lengths array with an index greater than 0 is equal to 3×2×3=18. This is because the Pivot Length elements are 3, 2, 3 and 2, where the leftmost element 3 corresponds to the index 3, the next element 2 corresponds to the index 2, the next element correspond to the index 1 and the final element corresponds to the index 0. The accumulator is thus increased by 1×(3×2×3)=18. The second element of the Pivot Dimension Record Indexes array is 0. The product of all Pivot Length elements with an index greater than 1 is equal to 2×3=6. The accumulator is unchanged since 0×6=0. The third element of the Pivot Dimension Record Indexes array is 1. The product of all Pivot Length elements with an index greater than 2 is equal to 3. The accumulator is increased by 1×3=3, and it is now 3+0+18=21. The fourth element of the Pivot Dimension Record Indexes array is 1. Since this is the last element, the accumulator is increased by 1×1=1, and it is now 21+1=22. The final result from the algorithm in FIG. 2A2III results in 22, which is the PivotFrame record index corresponding to the provided Pivot Dimension Record Indexes.

The fact that the PivotFrame record index is 22 for the Pivot Dimension Record Indexes of 1, 0, 1 and 1 can be confirmed since the value column for the record at index 22 is 220 506, as shown in FIG. 5. As shown in FIG. 4, the value corresponding to the cell with the value 220 in the Pivot Table representation has a corresponding first Vertical Pivot Dimension with a Reference Data Table record index 1 410, a second Vertical Pivot Dimension with a Reference Data Table record index 0 411, a first Horizontal Pivot Dimension with a Reference Data Table record index 1 408, and a second Horizontal Pivot Dimension with a Reference Data Table record index 1 409.

Thus, it can be appreciated that the invention allows for quickly determining a record index given values of a pivot frame's horizontal pivot dimensions and vertical pivot dimensions.

FIG. 2A3I describes a method by which the row and column index of a pivot frame can be determined if provided a pivot frame record index. In one embodiment of this invention, a user may want to determine the row and column index of a pivot frame for the record at index 22. The user first calculates the horizontal pivot body length 2A31001 as being equal to 6, since the horizontal pivot dimensions are “h0” and “h1”, and “h0” contains two records in its Reference Data Table 2A2001 and “h1” contains three records in its Reference Data Table 2A2002. The user then calculates the Vertical Pivot Body Length 2A31002 as being equal to 6 also, since the vertical pivot dimensions are “v0” and “v1”, and “v0” contains two records in its Reference Data Table 2A2003 and “v1” contains three records in its Reference Data Table 2A2004. The row index can then be calculated by dividing the provided record index 22 by the Horizontal Pivot Body Length of 6, which is equal to 3.67, and then rounding that figure down to the nearest whole number, which is 3. The column index can be calculated by taking the modulo of the record index 22 and the vertical pivot body length of 6, which results in 4. Therefore, the row index and column index that correspond to the record index 22 are 3 and 4, respectively. The fact that the data in a pivot frame is the same when represented as a data table and as a pivot table can be confirmed as the record at index 22 in the pivot frame view 506 of FIG. 5 has the value 220, which is the same value at row index 3 and column index 4 visible in the pivot table view 407 FIG. 4.

Thus, this invention allows for quickly determining the row and column index within a pivot frame if provided the corresponding record index.

FIG. 2A4I describes the method to determine the row and column index for a desired cell in a pivot frame if provided the pivot dimension record indexes 508. In one embodiment, a user may want to determine the row and column index within the pivot body given the first vertical pivot dimension 410 has a value corresponding to record index 1 in that pivot dimension's reference data table 2A2003, the second vertical pivot dimension 411 has a value corresponding to record index 0 in that pivot dimension's reference data table 2A2004, the first horizontal pivot dimension 408 has a value corresponding to record index 1 in that pivot dimension's reference data table 2A2001, and the second vertical pivot dimension 409 has a value corresponding to record index 1 in that pivot dimension's reference data table 2A2002. Together, these values are the pivot dimension record indexes and have the values of 1, 0, 1 and 1.

The user first performs steps in FIG. 2A2I using these Pivot Dimension Record Indexes and obtains a resulting record index of 22. The user then performs the steps in FIG. 2A3I using the record index 22 obtained in the previous step to determine that the row index and column index that correspond to the record index 22 are 3 and 4, respectively.

The fact that the provided record index of 22 corresponds to the row and column indexes of 3 and 4 can be confirmed as the record at index 22 in view 506 has the value 220 associated with row and column indexes of 3 and 4. This is the same value at row index 3 and column index 4 visible in the Pivot Table view 407.

Thus, the invention allows for quickly determining the row and column index within a pivot frame if provided the values of the pivot dimension record indexes of the desired cell.

FIG. 2A5II characterizes the method by which the pivot dimension record indexes, or the underlying record indexes in the reference data table of each pivot dimension, can be determined if provided a corresponding record index.

In one embodiment of this invention, a user may want to determine the array of Pivot Dimension Record Indexes 1, 0, 1 and 1 508 if provided a record index of 22 507 in the pivot frame. The user first calculates the pivot lengths of the pivot frame 2A52001. Based on the reference data tables provided in FIG. 2A, the pivot lengths of the pivot table in FIG. 4, which is also represented as a pivot frame in FIG. 5, is the array with elements 2, 3, 2 and 3. This is because the vertical pivot dimension v0 corresponds to the table v0 2A2003, which has 2 entries, the vertical pivot dimension v1 corresponds to the table v1 2A2004, which has 3 entries, the horizontal pivot dimension h0 corresponds to the table h0 2A2001, which has 2 entries and the horizontal pivot dimension h1 corresponds to the table h1 2A2002, which as 3 entries. The order of the Pivot Length elements is determined by a sorting algorithm, such as the one in 2A22.

The record index in the Reference Data Table of each Pivot Dimension is then calculated 2A52002. This may be done using the algorithm in FIG. 2A5I.

The first element of the Pivot Lengths array is 2, which represents the length of vertical pivot dimension “v0.” Therefore, we first calculate the Pivot Dimension index in the underlying reference data table 2A2003 of “v0.” The product of all Pivot Length elements with an index greater than 0 is equal to 3×2×3=18. The record index, 22, is then divided by 18. The result, 1.22, is rounded down the nearest whole number 1. The pivot dimension index in the reference data table underlying “v0” is calculated by taking the modulo of 1 and the current Pivot Lengths element, 2, resulting in 1.

The second element of the pivot lengths array is 3, which represents the length of vertical pivot dimension “v1.” Therefore, we are calculating the pivot dimension index in the underlying reference data table 2A2004 of “v1.” The product of all Pivot Length elements with an index greater than 0 is equal to 2×3=6. The record index, 22, is then divided by 6. The result, 3.67, which is rounded down to the nearest whole number 3. The pivot dimension index in the reference data table underlying “v1” is calculated by taking the modulo of 3 and the current Pivot Lengths element, 3, resulting in 0.

The third element of the Pivot Lengths array is 2, which represents the length of horizontal pivot dimension “h0.” Therefore, we are calculating the pivot dimension index in the underlying reference data table 2A2001 of “h0.” The product of all pivot length elements with an index greater than 0 is equal to 3. The record index, 22, is then divided by 3. The result, 7.33, is rounded down to the nearest whole number 7. The pivot dimension index in the reference data table underlying “h0” is calculated by taking the modulo of 7 and the current pivot lengths element, 2, resulting in 1.

The fourth element of the Pivot Lengths array is 3, which represents the length of horizontal pivot dimension “h1.” Therefore, we are calculating the pivot dimension index in the underlying reference data table 2A2002 of “h1.” Since 3 is the last element of the pivot lengths array, we divide the record index, 22, by 1. The result, 22, is already a whole number. We arrive at the pivot dimension index in the reference data table underlying “h1” by taking the modulo of 22 and the current pivot lengths element, 3, which is 1.

The value of each pivot dimension is obtained by performing a lookup on the reference data table underlying each pivot dimension using the indexes derived from 2A52002. Thus, the invention allows for quickly determining the values of each pivot dimension within a pivot frame if provided the corresponding record index.

The disclosed technology includes an efficient method for computing horizontal and vertical pivot dimensions of a cell by arbitrary row and column in constant time. This can be achieved by observing the deterministic relationship of data in finance. The user may set up the pivot frame as shown on FIG. 49A. Note that the horizontal pivot dimension time period, which contains values “jan”, “feb” and “mar” 4902 is repeated for each outer horizontal pivot dimensions “2000” and “2001”, and the same is true for the vertical pivot dimension coa which contains values “rev”, “cogs”, and “gp” repeated downward 4901. We compute an array of the cumulative product lengths, where each element in the array represents the product of all inner dimension sizes. In our embodiment where the innermost horizontal pivot dimension period has size 3, and the outer horizontal Pivot Dimension year has size 2, the resulting array of product lengths is [3, 6]. Note that an element at position i in the array represents the product of the sizes of pivot dimensions from 0th position up to ith position. We also compute a similar array for the vertical pivot dimension, which in this embodiment, is also [3, 6]. These arrays allow us to compute any pivot dimension, given an arbitrary row and column, in constant time.

In the embodiment illustrated in FIG. 49B if the user wants to query for the cell at row 2 and column 4, we calculate the horizontal and vertical pivot dimensions as follows: for each horizontal pivot dimension up to the total number, take the floor division of column 4 to the element in the cumulative product array [3, 6] for the horizontal direction. For the innermost horizontal pivot dimension, take the modulo arithmetic of its size. In this example, for the first element in the array, 4 modulo 3 equals 1, so the corresponding horizontal dimension is “feb”, indexed 1 in dimension period. For the second element in the array 3, 4 can be divided by 3 no more than 1 time, so the corresponding horizontal dimension is “2001”, indexed 1 in dimension year. If there is an additional outer horizontal pivot dimension, namely timeline with values “prediction” and “actual”, then the pivot frame is as illustrated in FIG. 50. The horizontal cumulative product array becomes [1, 3, 6, 12]. For example, column 9 divides 6 equals 1, so the corresponding outermost horizontal pivot dimension is “actual”, indexed 1, column 4 divides 6 equals 0, so the associated dimension is “prediction”, indexed 0. Note that the last element, 12, in our cumulative product array is the length of horizontal pivot dimensions. The process for calculating the pivot dimension, given any row, is similar for the vertical direction and can be deduced from the invention as described above. Thus, the disclosed technology allows for quick determination of the values of each pivot dimension within a pivot frame if provided the corresponding row and column numbers of the pivot frame.

The disclosed technology includes a method to calculate an arbitrary section of a pivot frame given any start row, end row, start column and end column of the section of interest. This invention also takes filtering and sorting into consideration by computing two arrays of visible coordinate indices for the horizontal and vertical directions. This invention allows one to return any arbitrary section of a pivot frame almost instantaneously. The coordinate of any cell is computed using these two arrays.

Consider a case where the user wishes to filter data in “jan” and “feb” in the pivot table of FIG. 50. The filtered data is represented with grey highlighting 5001. The array [0, 1, −1, 3, 4, −1] is computed for the horizontal direction and represents the indices of visible columns. The array [0, 1, 2, 3, 4, 5] is computed for the vertical direction and represents the indices of visible rows. The pivot frame after applying the filter {period: [jan, feb]} is shown in FIG. 51.

A user may wish to query data starting from row 2 to row 4, and from column 0 to column 2, both with zero indexing. After filtering, the corresponding matrix coordinate indices in the format (row, column) is shown below. Note that the entries −1 in the computed coordinate index array are not included because they indicate data that has been filtered out.

| | | | |
|---|---|---|---|
| (0, 0) | (0, 1) | (0, 3) | (0, 4) |
| (1, 0) | (1, 1) | (1, 3) | (1, 4) |
| (2, 0) | (2, 1) | (2, 3) | (2, 4) |
| (3, 0) | (3, 1) | (3, 3) | (3, 4) |
| (4, 0) | (4, 1) | (4, 3) | (4, 4) |
| (5, 0) | (5, 1) | (5, 3) | (5, 4) |

Using our two arrays for visible rows and columns from filtering, a start row of 2 corresponds to row indexed 2 5103, and an end row of 4 corresponds to row indexed 4 5104, since there is no filtering that occurs on the vertical pivot dimensions, indices for the vertical pivot dimension still appear sequentially. On the horizontal pivot dimensions, however, a start column of 0 corresponds to column indexed 0 5101, and an end column of 2 corresponds to column indexed 3 5102. The section of the grid that should be returned to the user is represented with dashed lines in FIG. 51. FIG. 52 further illustrates how the query rows and columns are mapped to the filtered and sorted arrays, representing visible data.

Obtaining the value of a cell may trigger other cells to be calculated, some of these cells may not belong in the original request but nevertheless will be calculated. In addition, some of these cells may be part of other tables that are visible in the user software environment, in which case the user's display must be updated.

Thus, an embodiment of the invention reduces the number of calculations and effectively, the total calculation time required to obtain visible cell values within a pivot frame, by initiating queries for user-specified ranges of cells by record index. Applying filters to this data and further data transformation do not require recalculations of the entire pivot frame, but only cells propagated in the visible request.

Users of software applications that generate pivot tables have the desire to filter data in order to present only the information relevant to their analyses. Disclosed is a method to quickly filter a pivot frame based on user-defined criteria.

In describing this method to filter a pivot frame, we introduce the concepts of conditions, expressions, missing matrixes, provided matrixes and combined matrixes. In this section, we present an overview of these concepts and how they relate to one another, and in the subsequent section, we describe the application of these concepts through a series of examples.

As mentioned, the method described herein involves conditions. A condition is a set of user-defined rules or expressions. A condition is applied to each pivot frame represented to the user. For each dimension within the internal, tabular representation of a pivot frame, there is a corresponding expression. An expression comprises a dimension ID, comparison operator and value. The dimension ID may be associated with a pivot dimension or a non-pivot dimension. An expression associated with a pivot dimension determines the record indexes of the underlying reference data table of the pivot frame. An expression associated with a non-pivot dimension determines which values of the dimension, rather than record indexes, to include. Only the equality operator (=) may be used as a comparison operator in expressions associated with pivot dimensions. Expressions associated with non-pivot dimensions are compatible with the following operators, in addition to the equality operator: >, <, >=, <=, !=. The value in an expression associated with a pivot dimension is either an integer equal to a record index from the dimension's underlying reference data table (e.g., “dim_id=1”) or the wildcard operator (*), which signifies “any” record index from the dimension's underlying reference data table (e.g., “dim_id=*”). The value in an expression associated with a non-pivot dimension is either 1) a string of text or a number, either of which represents a specific value within the dimension (e.g., “dim_id=‘Acme’”), or 2) the wildcard operator, signifying “any” value within the dimension. The expressions within a condition are joined by one or more instances of the AND and/or OR operators to form a complete condition. The examples provided in the subsequent section illustrate how conditions are constructed as a consequence of the user's desired filter specifications.

In the process of filtering a pivot frame, a condition is used to construct a missing matrix and a provided matrix. A missing matrix is a two-dimensional matrix made up of the Cartesian product of all pivot dimensions where the corresponding expressions were not supplied specific values (i.e., the expressions were supplied “*”). For a given condition, if all expressions were supplied specific values, the resulting missing matrix would be an empty set.

A provided matrix is a two-dimensional matrix in which each column represents a pivot dimension associated with an expression that was supplied a specific value (e.g., the expression was supplied the integer “1”). For a given row in a provided matrix, the value in each column will match the value specified in the associated expression. The number of rows in a provided matrix is determined by the number of rows in its missing matrix counterpart. Where N is equal to the number of rows in the missing matrix, the number of rows in the provided matrix is the greater of N and one. However, if there are no pivot dimensions associated with an expression that was supplied a specific value (i.e., every pivot dimension in the tabular, internal representation of the pivot frame is represented in the missing matrix), the provided matrix is an empty set.

The missing matrix and provided matrix are combined to produce a new matrix called the combined matrix, in which each column corresponds to a pivot dimension from the internal, tabular representation of the relevant pivot frame. All pivot dimensions from the internal, tabular representation of the pivot frame are represented in the combined matrix. The order of columns in the combined matrix adheres to the order dictated by the pivot dimension sorting algorithm defined in FIG. 2A2II. The values of a given column of the combined matrix are equal to those of the column, from either the missing matrix or provided matrix, associated with the same pivot dimension.

Each row of the combined matrix represents a record from the internal, tabular representation of the pivot frame. As previously mentioned, for a given row in the combined matrix, each column corresponds to a pivot dimension from the internal, tabular representation of the pivot frame. the value in each column is equal to a record index from the corresponding pivot dimension's underlying reference data table. Thus, we can apply the method of FIG. 2A2II to the values in each row of the combined matrix to determine the corresponding record indexes from the internal, tabular representation of the pivot frame. Then, using the forementioned record indexes, we can populate the data table or pivot table-like representation of the pivot frame with the data relevant to the user.

In this section, we provide examples of how a user may filter a pivot frame. Examples 1-4 describe cases in which the dimension ID in each Expression is associated with a pivot dimension, and all expressions are joined by the AND operator. Examples 5-6 describe cases in which the dimension ID in each Expression is associated with a pivot dimension, and some expressions are joined by the OR operator (instead of the AND operator). Examples 7-8 describe cases in which an expression is associated with a non-pivot dimension.

### Example 1

In one embodiment of the invention, a user may not wish to apply any filters to a pivot frame shown in FIG. 2C1. The resulting condition is illustrated in FIG. 2C2. The condition includes three expressions given there are three dimensions in the pivot frame 2C1 (“dept,” “coa” and “period”) and all expressions are joined by the AND operator. Each Expression is set to include all record indexes (*) from its corresponding pivot dimension's underlying reference data table. Therefore, the missing matrix, illustrated by FIG. 2C3, is the Cartesian Product of the following:
[0, 1]—list of all record indexes from the reference data table underlying the pivot dimension “dept”
[0, 1, 2]—list of all record indexes from the reference data table underlying the pivot dimension “coa”
[0, 1]—list of all record indexes from the reference data table underlying the pivot dimension “period”

Given that no expressions in this example were supplied a specific value (e.g., “dept=1”), the provided matrix is an empty set. Thus, the combined matrix is the same as the missing matrix of FIG. 2C3. The missing matrix's columns (and, by extension, the combined matrix's columns) adhere to the order dictated by the pivot dimension sorting algorithm: “dept,” “coa,” “period.”

We may now apply the sorting method described in FIG. 2A2II to the values in each column of a given row of the combined matrix of FIG. 2C3 to determine the corresponding record index from the internal, tabular representation of the pivot frame shown in FIG. 2C1. Consider the row C3001 in FIG. 2C3. From its values of 1, 2 and 0, which correspond to the Pivot Dimensions “dept,” “coa” and “period” respectively, we can determine that its corresponding record index from the internal, tabular representation of the PivotFrame is 10, as shown with element 4001 in FIG. 2C4.

We provided this example for explanatory purposes—in practice, if all expressions in a condition are associated with a pivot dimension and the value supplied for each is *, all record indexes of the internal, tabular representation of the pivot table are returned (i.e., the user bypasses the creation of the missing matrix, provided matrix and combined matrix). Thus, given the pivot frame of FIG. 2C1 and the condition illustrated in FIG. 2C2, the user would be provided with the values of the column 2C4002 of FIG. 2C4.

### Example 2

In another embodiment of the invention, a user may wish to apply filters to the pivot frame of FIG. 2C1 such that the underlying record index of each pivot dimension's reference data table is equal to 1. The resulting condition is in FIG. 2C5. The condition has three expressions given there are three dimensions (“dept,” “coa” and “period”) and all expressions are joined by the AND operator. Each expression is set to include the record index 1 of each pivot dimension's underlying reference data table. Given that the expressions were supplied specific values (i.e., 1), the missing matrix is an empty set.

The provided matrix is illustrated in FIG. 2C6. The provided matrix one row since the number of rows in the missing matrix is zero. As previously mentioned, the number of rows in the provided matrix is the greater of the number of rows in the missing matrix (in this case, zero) and one. There are three columns; as previously mentioned, each column corresponds to a pivot dimension associated with an expression that was supplied a specific value. The value in each column, 1, is the value the user supplied to each pivot dimension's associated expression.

Since the missing matrix is an empty set, the combined matrix is the same as the provided matrix of FIG. 2C6. The provided matrix's columns (and, by extension, the combined matrix's columns) adhere to the order dictated by the pivot dimension sorting algorithm: “dept,” “coa,” “period.”

We may now apply the method of FIG. 2A2II to the values in each column of a given row of the combined matrix of FIG. 2C6 to determine the corresponding record index from the internal, tabular representation of the pivot frame of FIG. 2C1. Consider the only row of the combined matrix of FIG. 2C6—from its values of 1, 1 and 1, which correspond to the pivot dimensions “dept,” “coa” and “period” respectively, we can determine that its corresponding record index from the internal, tabular representation of the pivot frame is 9, as shown in FIG. 2C7.

### Example 3

In another embodiment of the invention, a user may wish to apply filters to the pivot frame of FIG. 2C1 such that the underlying record indexes of the pivot dimensions “dept” and “coa” are equal to 1, and the underlying record index of the pivot dimension “period” is equal to any record index (*). All expressions are joined by the AND operator. The resulting condition is illustrated by FIG. 2C8. The resulting missing matrix is shown in FIG. 2C9, which is the Cartesian product of the following:
[0, 1]—list of all record indexes from the reference data table underlying the pivot dimension “period”

The provided matrix is illustrated in FIG. 2C10. The provided matrix has two rows since the number of rows in the missing matrix is two. There are two columns; as previously mentioned, each column corresponds to a pivot dimension associated with an expression that was supplied a specific value. The value in each column, 1, is the value the user supplied to the expressions associated with the pivot dimensions “dept” and “coa.”

We now combine the missing matrix of FIG. 2C9 with the provided matrix of FIG. 2C10 to construct the combined matrix. The columns of the combined matrix must adhere to the order dictated by the pivot dimension sorting algorithm. In this example, the order is as follows: “dept,” “coa,” “period.” The first column of the combined matrix is taken from the first column of the provided matrix, which corresponds to the pivot dimension “dept.” The second column of the combined matrix is taken from the second column of the provided matrix, which corresponds to the pivot dimension “coa.” The third column of the combined matrix is taken from the only column of the missing matrix, which corresponds to the Pivot Dimension “period.” The resulting combined matrix is illustrated in FIG. 2C11.

We may now apply the method described in FIG. 2A2II to the values in each column of a given row of the combined matrix of FIG. 2C11 to determine the corresponding record index from the internal, tabular representation of the pivot frame of FIG. 2C1. Consider the row 2C11001—from its values of 1,1 and 0, which correspond to the Pivot Dimensions “dept,” “coa” and “period” respectively, we can determine that its corresponding record index from the internal, tabular representation of the PivotFrame is 8, as shown as element 2C12001 of FIG. 2C12.

### Example 4

In another embodiment of the invention, a user may wish to apply filters to the pivot frame of FIG. 2C1 such that the underlying record index of the pivot dimension “dept” is equal to 1, and the underlying record indexes of the pivot dimensions “coa” and “period” are equal to any record index (*). All Expressions are joined by the AND operator. The resulting condition is illustrated in FIG. 2C13. Therefore, the missing matrix is shown in FIG. 2C14, as the Cartesian product of the following:
[0, 1, 2]—list of all record indexes from the reference data table underlying the pivot dimension “coa”
[0, 1]—list of all record indexes from the reference data table underlying the pivot dimension “period”

The provided matrix is illustrated in FIG. 2C15. The provided matrix has six rows since the number of rows in the missing matrix is six. The provided matrix has one column since there is only one pivot dimension associated with an expression that was supplied a specific value. The value in each row, 1, is the value the user supplied to the expression associated with the pivot dimension “dept.”

We now combine the missing matrix of FIG. 2C14 with the provided matrix of FIG. 2C15 to construct the combined matrix. As previously mentioned, the columns of the combined matrix must adhere to the order dictated by the pivot dimension sorting algorithm. In this example, the order is as follows: “dept,” “coa,” “period.” The first column of the combined matrix is taken from the only column of the provided matrix, which corresponds to the pivot dimension “dept.” The second column of the combined matrix is taken from the first column of the missing matrix, which corresponds to the pivot dimension “coa.” The third column of the combined matrix is taken from the second column of the missing matrix, which corresponds to the pivot dimension “period.” The resulting combined matrix is illustrated in FIG. 2C16.

We may now apply the method described in FIG. 2A2II to the values in each column of a given row of the combined matrix 2C16 to determine the corresponding record index from the internal, tabular representation of the pivot frame of FIG. 2C1. Consider the row 2C16001—from its values of 1,0 and 0, which correspond to pivot dimensions “dept,” “coa” and “period” respectively, we can determine that its corresponding record index from the internal, tabular representation of the pivot frame is 6, as shown as element 2C17001 of FIG. 2C17.

### Example 5

The preceding examples assume that all expressions are joined by the AND operator. We can also handle cases where two or more expressions are joined by the OR operator.

For each expression joined by an instance of the OR operator, an additional provided matrix and intermediary combined matrix are created. All intermediary combined matrixes are consolidated to produce a final combined matrix. We then apply the method of FIG. 2A2II to the values in each row in the final, combined matrix.

To demonstrate, in another embodiment of the invention, a user may wish to the pivot frame of FIG. 2C1 such that the underlying record index of the pivot dimension “dept” is equal to any record index (*), the underlying record index of the pivot dimension “coa” is equal to 1 or 2, and the underlying record index of the pivot dimension “period” is equal to 1. The resulting condition is illustrated in FIG. 2C18. The two expressions associated with the pivot dimension “coa” are joined by the OR operator. One may visualize this condition as a formulaic expression, such as that illustrated by the following:

(dept=*) AND ((coa=1) OR (coa=2)) AND (period=1)

The missing matrix, illustrated in FIG. 2C19, is the Cartesian Product of the following:
[0, 1]—list of all record indexes from the Reference Data Table underlying the Pivot Dimension “dept”

Given that the condition includes two Expressions joined by the OR operator, two provided matrixes are created. Each provided matrix incorporates one of the two expressions associated with the pivot dimension “coa.” There are two rows in each of the provided matrixes since the number of rows in the missing matrix is two. The first provided matrix is illustrated in FIG. 2C20. In this provided matrix, the first column corresponds to the pivot dimension “coa,” and its values are 1s. The second provided matrix is illustrated in FIG. 2C21. In this provided matrix, the first column also corresponds to the pivot dimension “coa,” and its values are 2s. The second column of each provided matrix corresponds to the pivot dimension “period,” and its values are 1s.

Each provided matrix is combined with its own respective copy of the missing matrix, in accordance with the process described herein, resulting in two intermediary combined matrixes of FIG. 2C22 and FIG. 2C23. The final combined matrix is constructed by concatenating the two intermediary combined matrixes vertically, resulting in the matrix of FIG. 2C24.

### Example 6

In another embodiment of the invention, a user may wish to apply filters to the pivot frame of FIG. 2C1 such that the underlying record indexes of the pivot dimensions “dept” and “coa” are equal to any record index (*), and the underlying record index of the pivot dimension “period” is equal to 0 or 1. The resulting condition is illustrated in FIG. 2C25. The two expressions associated with the pivot dimension “period” are joined by the OR operator. One may visualize this condition as a formulaic expression, such as that illustrated by the following:

(dept=*) AND (coa=*) AND ((period=0) OR (period=1))

The missing matrix, illustrated in FIG. 2C26, is the Cartesian product of the following:
[0, 1]—list of all record indexes from the reference data table underlying the pivot dimension “dept”
[0, 1, 2]—list of all record indexes from the reference data table underlying the pivot dimension “coa”

Given that the condition includes two expressions joined by the OR operator, two provided matrixes are created. Each provided matrix incorporates one of the two expressions associated with the pivot dimension “period.” There are six rows in each of the provided matrixes since the number of rows in the missing matrix is six. The first provided matrix is illustrated in FIG. 2C27. In this provided matrix, the only column corresponds to the pivot dimension “coa,” and its values are 0s. The second provided matrix is illustrated in FIG. 2C28. In this provided matrix, the only column corresponds to the pivot dimension “period,” and its values are 1s.

Each provided matrix is combined with its own respective copy of the missing matrix, in accordance with the process described herein, resulting in two intermediary combined matrixes in FIG. 2C29 and FIG. 2C30. The final combined matrix is constructed by concatenating the two intermediary combined matrixes vertically, resulting in the matrix shown in FIG. 2C31.

We may now apply the method described in FIG. 2A2II to the values in each column of a given row of the combined matrix 2C31 to determine the corresponding record index from the internal, tabular representation of the pivot frame.

### Example 7

Expressions may also be associated with non-pivot dimensions. The process of filtering in such cases is largely similar to the processes described in the preceding examples. First, the missing matrix, provided matrix and combined matrix are constructed only considering the expressions associated with pivot dimensions. Then, for each row of the combined matrix, we 1) apply the method described in FIG. 2A2I to derive the corresponding record index from the internal, tabular representation of the pivot frame and 2) use the forementioned record index to retrieve the corresponding value from the non-pivot dimension. Finally, we iterate over the rows in the matrix resulting from the preceding steps and eliminate rows where the expression corresponding to the non-pivot Dimension does not evaluate to true. We iterate over each row in this matrix since non-pivot dimensions do not share the deterministic nature of pivot dimensions.

In one embodiment of the invention, a user may wish to apply filters to the pivot frame of FIG. 2C32, which includes a non-pivot dimension “vendor.” The user would like to apply filters such that the underlying record indexes of pivot dimensions “dept,” “coa” and “period” are equal to any record index (*), and the value in the non-pivot dimension “vendor” is equal to “Acme.” The resulting condition is illustrated in FIG. 2C33.

Similar to Example 1, the missing matrix, illustrated in FIG. 2C34, is the same as the combined matrix since the provided matrix is an empty set. We apply the method described in FIG. 2A2I to determine the record index from the internal, tabular representation of the pivot frame of FIG. 2C32 for each row of the missing matrix 2C34. The result is the matrix illustrated in FIG. 2C35. Then, we use the forementioned record indexes to retrieve the corresponding values of the non-Pivot Dimension “vendor,” resulting in the matrix illustrated in FIG. 2C36.

We then iterate over each row in FIG. 2C36 and eliminate those where the value in the non-Pivot Dimension “vendor” is not equal to “Acme.” The final result is the final matrix illustrated in FIG. 2C37.

### Example 8

Expressions for non-Pivot Dimensions using other comparison operators (>, <, >=, <=, !=) receive the same treatment as those that use the equality operator (=). For example, in another embodiment of the invention, a user may wish to apply filters to the pivot frame of FIG. 2C38, which includes a non-pivot dimension “cost.” The user would like to apply filters such that the underlying record index of the pivot dimension “dept” is equal to 1, the underlying record indexes of pivot dimensions “coa” and “period” are equal to any record index (*), and the value in the non-pivot dimension “cost” is greater than 1500. The resulting condition is illustrated by 2C39.

The missing matrix, provided matrix and combined matrix are respectively illustrated in FIG. 2C40, FIG. 2C41 and FIG. 2C42. We apply the method described in FIG. 2A2I to determine the record index from the internal, tabular representation of the pivot frame of FIG. 2C38 for each row of the combined matrix. The result is the matrix illustrated in FIG. 2C43. Then, we use the aforementioned record indexes to retrieve the corresponding values of the non-pivot Dimension “cost,” resulting in the matrix illustrated in FIG. 2C44. We then iterate over each row in FIG. 2C44 and eliminate those where the value in the non-Pivot Dimension “cost” is not greater than 1500. The final result is a matrix illustrated in FIG. 2C45.

The key attribute of the disclosed pivot frame is that we can obtain the value of any arbitrary cell very quickly. The foregoing discussion detailed methods to translate a user visible row and column view of a cell in a pivot frame from a UI perspective, into the record index of the cell. With the computed record index and the dimension where the cell is located, this invention obtains the value of the cell efficiently.

Given a table and the row and column information, we can compute the record index of the cell and which dimension it resides in. Using the record index and dimension, and other unique information of the table, such as its table name and model name, we can produce a lookup key to the cache. FIG. 2D1 illustrates this process. Element (2)(d)100 shows a request for the desired cell by its record index and dimension. It is determined whether the cell is in the cache at element (2)(d)102. If so ((2)(d)102—Yes), the value is returned from the cache (2)(d)104. If not ((2)(d)102—No) it is determined if the cell is in a pivot table (2)(d)2001. If the cell is in a pivot table ((2)(D)2001—Yes) it is determined if the cell is in the ID dimension (2)(d)106. If so ((2)(d)106—Yes), the record index is returned (2)(d)2003. If not ((2)(d)106—No), it is determined if the cell is in a pivot dimension (2)(d)108. If so ((2)(d)108—Yes), the cell's record index is converted into an array of integers using a specified function (2)(d)2005. Then an element in the array is selected (2)(d)2006. These operations are more fully characterized in FIG. 2D2.

If the cell is not in a pivot table ((2)(D)2001—No), it is determined if the cell contains a user provided value (2)(d)3003. If so ((2)(d)3003—Yes), the value is provided (2)(d)110. If not ((2)(d)3003—No), it is determined if the cell's dimension contains a conditional formula (2)(d)112. If not ((2)(d)112—No), the cell is cached as having no value (2)(d)114. If so ((2)(d)112—Yes), it is determined if the cell's record value matches the method's condition (2)(d)116. If so ((2)(d)116—Yes), the formula is evaluated and the result is cached (2)(d)3006. If not ((2)(d)116—No), the cell is cached as having no value (2)(d)114.

If the referenced table is a pivot table, the operations of FIG. 2D2 are followed:
1. Check to see if the Dimension is the ID Dimension. If it is, then return the record index 2D2003.
2. Check to see if the Dimension is one of the Pivot Dimensions. If not 2D2004, then proceed to Step 3(c) in FIG. 2D3, and each step listed below it.
3. If so, convert the cell's record index into an array of integers using the RecordIdxToPdimIdxs function 2D2005 and proceed to the next step.
4. Select the element in the array above that corresponds to the index of the cell's Pivot Dimension 2D2006 and proceed to the next step.
5. Return the value of the cell in the Pivot Dimension's reference field corresponding to the record index equal to the value above 2D2007.

If the referenced table is a Tabular Table, proceed with the Steps as outlined in FIG. 2D3:
1. Check to see if the cell has a value provided by the user 2D3002. If so, return the value 2D3003.
2. Check to see if the value of the cell is obtained through a Conditional Formula 2D3004. If not, then cache the cell as having no value 2D3008 and return.
3. If so, check to see if the cell's record values match the Method's Condition 2D3005. If not, cache the cell as having no value 2D3007.
4. If so, evaluate the formula and cache the cell with its result. 2D3006.

Thus, there is a fast way to obtain a cell value in a pivot frame. A cache is used to hold the current value of a cell, which returns the value in as short as O(1) time. Otherwise, there are steps to produce the value, depending on the location of the cell in the table, and what type of table it is, as described above.

Summarizing data and applying formulas requires the management of different selections of cell groups, and the method by which to accomplish this determines the speed and cost of calculation. Disclosed is a method to select a group of cells in a pivot frame, based on one or more pivot frame values selected by user, by resolving a query based on values selected. The invention optimizes selections of cell groups by observing those values and returning a matrix of record indices and effectively reduces time and cost of selecting those relevant cells.

Based on the conditions set by a user, the invention processes each request in the form of a select statement and generates each attributable cell to this request in the form of record indices. Consider the operations of FIG. 2E1. The user selects one or more values from the pivot frame 2E1001. The relevant pivot dimensions are determined, as well as a list of conditions set by the user. By generating a list of conditions 2E1002, a provided matrix of record indices may be generated by evaluating each condition by pivot dimension and desired value 2E1003. We then generate a missing matrix by using a Cartesian product of all record indices from all pivot dimensions that are not selected by the user 2E1004. To create a complete matrix which will be viewed as the list of record indices per selected cell, the provided matrix and missing matrix are combined to return the relevant selected group of record indices 2E1005, and the algorithms specified in FIG. 2A3 and FIG. 2A5 may be used to determine the row/column coordinates and value of each cell 2E1006.

In one embodiment of this invention, a user may create a pivot frame as illustrated by FIG. 2E2 provide a condition to select a group of cells where inner Horizontal Pivot Dimension (h1) is equal to “jan”. The condition, based on Pivot Dimension (h1), comparison (=) and value selected (“sm”), will be used to generate a provided matrix containing record index captured by this condition, as illustrated by FIG. 2E3.

In order to generate the missing matrix, we must iterate through the pivot frame and observe all pivot dimensions that were not identified in the conditions set by the user, which in this example are the pivot dimensions: h0, v0, and v1. By collecting the record indices for each pivot dimension missing from the request (h0, v0, v1), as illustrated by the ID column for each of the pivot dimension's referenced data tables in FIG. 2A, we should take the Cartesian Product of those record indices, effectively constructing the missing matrix, as illustrated by FIG. 2E4.

To generate the complete matrix, we must combine the provided matrix and the missing matrix by Cartesian product, as illustrated by FIG. 2E5.

By following the method to determine each row and column given each record index as set forth in FIG. 2A3 and the method to determine each value given each record index as set forth in FIG. 2A5, the user can determine which cells and which values in the pivot frame are now selected, as illustrated by FIG. 2E6.

As another example of this embodiment, a user may provide conditions to select the cell group where outer Vertical Pivot Dimension (v0) is equal to “sm” while inner Horizontal Pivot Dimension (h1) is equal to “jan”. Indicating more conditions limits the search space of relevant cells and cells that strictly meet the criteria set are returned.

The conditions (v0=“sm”, h1=“jan”) will be used to generate a provided matrix containing the record indices captured by this condition, as illustrated by FIG. 2E7.

In order to generate the missing matrix, we must iterate through the pivot frame and observe all pivot dimensions that were not identified in the conditions set by the user, which in this example are the pivot dimensions: v1 and h0. By collecting the record indices for each pivot dimension missing from the request (v1, h0), as illustrated by the ID column for each Pivot Dimension's referenced data tables in FIG. 2A, we should take the Cartesian product of those record indices, effectively constructing the missing matrix, as illustrated by FIG. 2E8.

To generate the complete matrix, we must combine the provided matrix and the missing matrix by Cartesian Product, as illustrated in FIG. 2E9.

By following the method to determine each row and column given each record index as set forth in FIG. 2A3 and the method to determine each value given each record index as set forth in FIG. 2A5, the user determines which cells and which values in the pivot frame are now selected, as illustrated by FIG. 2E10.

Thus, disclosed are techniques to select a group of cells either programmatically via a SELECT function in a conditional formula, or manually by a user using a UI, for example, using drag and select. The invention limits the search space of cell group selection to relevant cells based on the conditions applied and returns results in O(n) time where n is the number of cells selected when certain conditions are met, regardless of the size of pivot frame to which it is being applied. Through queries and matrix construction, we reduce the magnitude of calculations that occurs when the user provides different pivot dimension values as conditions for selection.

Existing software applications that generate pivot tables do not allow users to create dimensions whose values depend on pivot dimensions. We have invented a method to create dimensions that are linked to pivot dimensions, which we refer to as linked pivot dimensions.

Linked pivot dimensions provide unique advantages, as they allow users to represent hierarchies within associated pivot dimensions, enhance a pivot frame's level of detail and can be used to filter a pivot frame.

The values of a linked pivot dimension do not repeat for a given value of its corresponding pivot dimension. For a given record within the internal, tabular representation of a pivot frame, the value in a linked pivot dimension's column represents a record index from its underlying reference data table. That value is the same as that in the column corresponding to the pivot dimension with which the linked pivot dimension is associated.

In one embodiment of the invention, a user would like to add a linked pivot dimension to the internal, tabular representation of the pivot frame illustrated in FIG. 2F1. The pivot frame in FIG. 2F1 has two Pivot Dimensions, “coa” and “period.” The underlying reference data tables of the pivot dimensions “coa” and “period” are in FIG. 2F2 and FIG. 2F3, respectively. The record indexes of the two forementioned reference data tables comprise the values corresponding to the pivot dimensions “coa” 2F1001 and “period” 2F1002 in the pivot frame of FIG. 2F1.

The user would like to add a linked pivot dimension “section” to the pivot frame of FIG. 2F1 that is linked to the pivot dimension “period.” We add a dimension to the internal, tabular representation of the pivot frame of FIG. 2F1 representing the linked pivot dimension “section.” The resulting internal, tabular representation of the pivot frame is illustrated in FIG. 2F4.

The pivot and linked pivot dimensions underlying the resulting pivot frame of FIG. 2F4 are summarized in FIG. 2F5. The linked pivot dimension “section” is linked to the pivot dimension “period” (linked dimension ID=“period”) and references the dimension “section” from the reference data table underlying the pivot dimension “period” of FIG. 2F3 (fetch dimension ID=“section”). Conceptualized alternatively, the linked pivot dimension “section” retrieves its data in a similar manner to that of the pivot dimension “period,” whereby the reference table ID is “period.” However, the reference dimension ID of the pivot dimension “period” (“id”) is replaced by the fetch dimension ID “section.”

Since the linked pivot dimension “section” is linked to pivot dimension “period,” the values in the “section” column 2F4002 of FIG. 2F4 reference those in the “period” column 2F4001. Thus, the values of the linked pivot dimension “section” do not repeat for each value of the pivot dimension “section.”

FIG. 2F6 illustrates a data table representation of the internal, tabular representation of the pivot frame illustrated by FIG. 2F4. Consider the row 2F6001—the values corresponding to the pivot dimension “period” (“feb”) and the linked pivot dimension “section” (“hist”) share the same record index (“1”) from the underlying reference data table of FIG. 2F3. For the same record index of the underlying reference data table, a linked pivot dimension allows the user to retrieve the value of a different dimension (fetch dimension) than that corresponding to its pivot dimension counterpart (reference dimension).

Linked pivot dimensions may be used to filter a pivot frame. In a filter condition, any specifications provided for a linked pivot dimension are represented through the expression associated with its pivot dimension counterpart.

In another embodiment of the invention, a user may wish to apply filters to the pivot frame illustrated in FIG. 2F7. The pivot frame of FIG. 2F7 has a linked pivot dimension, “manager,” which is linked to the pivot dimension “dept.” The underlying reference data table shared by the linked pivot dimension “manager” and pivot dimension “dept” is illustrated in FIG. 2F8. The user would like to apply filters such that the underlying record index of the linked pivot dimension “manager” is equal to 1, and all expressions of the filter condition are joined by the AND operator. The resulting condition is illustrated in FIG. 2F9.

As mentioned previously, any filter specifications provided for a linked pivot dimension are represented through the expression associated with its pivot dimension counterpart. Given that the pivot dimension “dept” is associated with the linked pivot dimension “manager,” we set the expression associated with pivot dimension “dept” to equal the underlying record index 1 2F9001 in FIG. 2F9.

FIG. 2F10 illustrates the resulting, filtered data table representation of the pivot frame illustrated in FIG. 2F7 based on the condition of FIG. 2F9.

It is desirable to summarize the values from a data source, such as a data table, into a generalized view while retaining the structure and integrity of the original data source. The disclosed technology allows users to create a pivot frame by selecting the dimensions of a data table and defining them as pivot dimensions, thus propagating each of them as values.

Consider the pivot frame of FIG. 3A8. One or more reference data tables provide the requisite source data to the pivot frame's pivot dimensions. FIG. 3A1 outlines the operations. The user must first create a data table 3A1001 by selecting the “Create New Table” option from the application's user interface, upon which they will be prompted with a form exemplified in FIG. 3A2. The user provide an “ID” 3A2001, which serves as an internal, unique identifier for the Data Table; “Name” 3A2002, which is the identifier visible to the user; and an optional “Description” 3A2003. The new Data Table is created once the user selects the “Create” button 3A2004 after completing the form.

After a data table is created, a user may populate it with data 3A1002. A newly created data table has a dimension named “ID” with a single cell shown in FIG. 3A3. There are multiple ways for the user to populate a data table, and to provide a summary of all possible methods would be outside of the scope of this description. The manual way to enter values into a data table entails the user selecting an available cell and enter a value by typing with the user's keyboard then pressing Ctrl+Shift+Plus Sign (+) when finished. As mentioned, there is only one available cell for newly created Data Tables, as exemplified by element 3A3001 of FIG. 3A3.

The user may add additional dimensions to a data table. After right-clicking their mouse on any cell within a data table, the user will be prompted with a menu exemplified in FIG. 3A4, from which the user should select the “New Dimension” option. The user will then be prompted with a form similar to that illustrated in FIG. 3A5, in which the user is prompted to provide the new dimension with a unique “ID” 3A2001 and “Name” 3A2002. Just as for data tables, the ID serves as an internal, unique identifier, while the name is visible in the table presented to the user through the application's visual interface. After setting both “ID” and “Name” to “account,” the user may select the “Create” button 3A2004 to add a new dimension to the Data Table.

The user, by following the aforementioned steps regarding entering data and creating new dimensions, may populate a Data Table such as that illustrated by FIG. 3A6.

By selecting the form for pivot settings as illustrated by FIG. 3A7, the user can view each dimension they've added to the data table and indicate which will be oriented horizontally or vertically, and which will populate its values, effectively as its cell dimension. By “drag and drop” interaction, the user may drag each dimension listed by name from available dimensions 3A7001 of FIG. 3A7 to any of the pivot dimensions below to identify that dimension as such.

One caveat of creating a pivot frame is that at minimum, one vertical pivot dimension and one horizontal pivot dimension is required to create a pivot frame. The user may identify more than one vertical pivot dimension and horizontal pivot dimension to create a pivot frame, as well as one or more vertical or horizontal frame dimensions.

If the user decides to mouse-select the dimension “account” and drag into the window for vertical dimensions 3A7002, they will identify that dimension as a vertical pivot dimension. If the user decides to mouse-select the dimension “periods” and drag into the window for horizontal dimensions 3A7003, they will identify that dimension as a horizontal pivot dimension. Finally, if the user decides to mouse-select the dimension “amount” and drag into the window for Cell Dimension 3A7004, they will identify that dimension as the cell dimension of the pivot frame. After providing a name and selecting a Create button, the user effectively creates a new pivot frame, which is exemplified by FIG. 3A8.

Thus, a pivot frame can be created from a data table by indicating its dimensions as the pivot dimensions of a pivot frame. Multiple pivot frames can be created from an existing data table, using the same dimensions as indicated or by identifying different pivot dimensions per pivot frame. At least one vertical pivot dimension, horizontal pivot dimension and cell dimension is required to be identified to create a pivot frame.

In a pivot frame, it is desirable for the user to compute the value of a cell within the cell dimension using a formula, similar to a programming language expression or statement. A conditional formula is a formula associated with a set of cells that includes a set of optional conditions. A conditional formula's conditions determine whether the formula is applicable to a certain cell or cell group.

Multiple conditional formulas may be applied to a set of cells. If more than one conditional formula is applied to a specific cell or group of cells, the most recently specified conditional formula will be used and visible to the user.

When the user elects to view a pivot frame representation through the application's user interface, the contents of the cells that comprise the pivot frame representation are calculated through the method described in FIG. 2D. Each individual cell's value may be obtained through the evaluation of a conditional formula.

The format of a conditional formula is similar to programming language expressions and allows for native function calls, user-written function calls, operators (such as +, *, /, etc.) and comments. A conditional formula is much more expressive and free-form than comparable formulas featured in existing pivot table software. AI/Deep Learning functions may also be used.

Native function calls include, but are not limited to, string functions, mathematical functions, time functions, financial functions, reference functions, AI/Deep Learning functions and SELECT functions (e.g., a function that obtains an array of values from a set of cells selected through the conditions specified in the SELECT function call).

In one embodiment of the invention, a user wishes to prepare a pivot frame as shown in FIG. 3B2 by summarizing the pivot frame's data through the application of a conditional formula provided in FIG. 3B5.

The user generates a Pivot Table-like representation in FIG. 3B3 of the internal, tabular representation of the pivot frame of FIG. 3B2 by following the steps from FIG. 3A. As shown in FIG. 3B1, the user then selects any cell from the pivot frame's cell dimension 3B3001, and scrolls to the formula Console as illustrated in FIG. 3B6. The user enters the formula from FIG. 3B5 into the formula input box 3B6001 of FIG. 3B6. Then, from the dropdown list illustrated by 3B6002, the user selects the cell dimension of the pivot frame to which the formula should apply. In our example, “amount” is the appropriate cell dimension to select. In order to complete the conditional formula, the user must add a unique name 3B6003 to identify the conditional formula and select save 3B6004 to apply it. The resulting pivot table-like representation is illustrated in FIG. 3B4.

A user may determine whether a cell was populated via a conditional formula by selecting a cell from the target pivot frame's cell dimension then scrolling to the formula console illustrated in FIG. 3B6, where the user may view any conditional formula that may have been applied to that selected cell. For example, if the user were to select cell 3B4001 of FIG. 3B4, they would see that the formula of FIG. 3B5 was applied and used to generate the value in the cell 3B4001 since the formula would appear in the console's formula input box 3B6001.

We use a given cell's position in relation to the associated pivot dimension values to determine the focal values of the internal, tabular representation of the target pivot frame to use in the evaluation of a conditional formula. Consider the cell 3B4001, whose location is where the vertical pivot dimension equals “3000” and the horizontal pivot dimension equals “01/01/2020.” We evaluate the conditional formula by referencing the internal, tabular representation of the pivot frame of FIG. 3B2, summing all values from the “amount” dimension where the pivot dimension “account” is equal to “3000” and the pivot dimension “period” is equal to “01/01/2020.” The result, 100, is returned as the cell's value 3B4001.

By iterating through each cell of a data table or pivot table-like representation of a pivot frame and performing the steps outlined above for each individual cell in the cell dimension, one populates the contents of a pivot frame.

In a pivot frame, it is desirable for the user to compute all non-value objects of a cell in the cell dimension. A conditional object is associated with a set of cells and includes a set of optional conditions. The optional conditions in a conditional object limit whether the object will be applied to a cell attributed to that dimension.

Objects that may be applied to each cell group include, but are not limited to, characters such as currency signs (e.g., ‘$’) and the number of decimal places to include, style settings such as font size and font color, cell graphs (e.g., pie or bar), and tasks.

Much like Conditional Formulas, multiple conditional objects may be active for a dimension for a given time. If more than one conditional object is applicable for a cell, the last specified conditional object is used.

To populate a pivot frame with a conditional object, the user interface first requests the value of a cell and then any objects layered onto that cell, which may be obtained through a conditional object. A user may populate a group of cells within a pivot frame as illustrated in FIG. 3B4 with a conditional object of cell bar graph type such as the following:
Type: “cell bar graph”, dim: “Amount”, condition: “period”=03/01/2020

When a user selects a cell, such as 3C2001 in FIG. 3C2 in the pivot frame and determines it to be from a cell dimension 3C1001 of FIG. 3C1, it is determined whether the cell has been populated by a conditional object. By observing the conditional object as listed above has been used to generate an object inside of the pivot frame 3C1002 with one condition attributed to the object 3C1004, the user must determine that the conditional object applied to return an object inside of cell must occur where each condition is met 3C1005. Because the condition is applicable to all cells where “period” is exactly equal to 03/01/2020, therefore the condition is met for cell 3C1006, the object (cell bar graph) from must be returned. The complete cell group from the pivot frame that is populated as a result of this conditional object is illustrated in FIG. 3B4.

It is desirable for a user to be able to enter a value into a cell, overriding a value provided by a conditional formula. In some scenarios, a user may wish to override a projected value and provide an arbitrary value to see how that affects the rest of the table.

A user may have a pivot frame as illustrated in FIG. 3D2, which contains a horizontal frame dimension with value “historical,” with associated cells from cell dimension that take values from cells with historical data, and value “forecast,” with associated cells from cell dimension are the result of a formula projecting and returning value. A user may provide another value to a given cell 3D3001 of FIG. 3D3, and thus, after converting the row and column of the cell into record index and dimension in the tabular form step 3D1002 of FIG. 3D1, may use the row number (0) as the record index and column number (4) as the dimension index 3D1003 to generate a unique key 3D1004. By storing this key in a hash table 3D1005, we may retrieve the value of this cell and lookup the value in the data structure.

Instead of recalculating the entire range of cells that exist within a pivot frame each time a value or formula is updated, dependencies can be established to target precisely the cells or methods that are dependent on the object being updated, thus, reducing the cost associated with such an action.

An embodiment of the invention extends the pivot frame to attribute a cell or method (conditional formula or conditional object) to a dependency when its returned value depends on either the value or attributed pivot dimension of another cell in the pivot frame. By tracking each cell's dependencies, we can effectively reduce the number of cells that need to be updated when a cell's value is changed by user, thus, reducing the time required to recalculate.

Forgoing pivot dimension values, each cell within a pivot frame is viewed as either a value entered by the user (or populated through data upload) or a value computed by a user-defined method, thus, dependent on the value of another cell. The types of dependencies that we can trace from each cell appears as illustrated in FIG. 3E1.

For the purpose of dependency tracking, an object that might have changed is the same as that of the object that has changed, and thus, there is no distinction when both are traced. The result of this may say, “then mark the objects that depend on this as changed”, which will trigger the dependency change step for those objects.

In one embodiment, an individual cell within a pivot frame may have a direct or indirect dependency to other cells that correlate to its value. Given a destination cell “cell A,” which processes the value of another cell, “cell B,” in its formula to return and populate its value, “cell B” holds a direct dependency on “cell A” to populate the cell value.

In one example of this embodiment, given a pivot frame as illustrated by FIG. 3E3, a user has one cell “cell B” within a pivot frame populated by an arbitrary value added by user, such as 50 3E3001. The pivot frame also includes another cell, effectively “cell A” 3E3002, populated by a formula evaluating that cell directly, such as the following:

“cell B”+30

As a result, the cell 3E3002 has a direct dependency to “cell B” 3E3001. When “cell B” is changed by the user and calculation of the pivot frame is initiated, rather than eliminate every single cached cell stored in memory regarding the pivot frame, to recalculate and propagate the correct results, we simply observe the tracked dependency and replace values of cells tracked in this dependency, recalculating and propagating the updated results.

If “cell B” 3E4001 is dependent on another cell, “cell C” 3E4002, to generate its value of 50 (which is no longer arbitrary), using a formula such as the following:

“cell C”+30

the evaluated cell, “cell A” 3E4003, shares an indirect dependency to “cell C” 3E4002 and thus, a chained dependency is present. As a result, if the user were to change the arbitrary value inside of “cell C” to 30, the cells directly and indirectly should be recalculated upon recalculation of the pivot frame, as illustrated by FIG. 3E5.

In another embodiment of this invention, a method within a pivot frame such as a conditional formula may have a direct dependency to the values of one or more other cells. Given a method which holds conditions on the value of another cell, “cell B,” the method is declared to have a direct dependency on cell(s). In this embodiment, multiple methods may have a direct dependency on the same cell, and multiple cells may affect one method.

In an example of this embodiment, given a pivot frame as illustrated by FIG. 3E6, a user may have one cell “Cell B” within their pivot frame populated by an arbitrary value added by user, such as 50 3E6001. The pivot frame may also include another cell, effectively “Cell A” 3E6002, populated by a conditional formula “Method X” which evaluates the value of “cell B” and returns the value for “cell A” based on that result 3E6003. The conditional formula shares a direct dependency with “cell B” and thus, when the user changes the arbitrary value inside of “cell B” to 40 as illustrated by FIG. 3E7, we may recalculate the method that is dependent on the updated cell, rather than recalculating every method that populates values for the pivot frame.

In another embodiment, a method within a pivot frame such as a conditional object may share a direct dependency to a group of cells based on the pivot dimension. Given a method which is conditioned to apply to a strict group of cells, such as “Cell Group E,” the cell group is declared to have a direct dependency on the method.

In an example of this embodiment, given a pivot frame as illustrated by FIG. 3E61, a user may set a Conditional Object format “Method Y” of Euro (€), conditionally applied onto a group of cells which the inner horizontal pivot dimension record index is 1 3E6001, and another conditional object format “Method Z” of USD ($), conditionally applied onto a group of cells which the inner horizontal pivot dimension record index is 2 3E6002. If a conditional object format such as “Method Y” is altered to Yen (¥), as illustrated in FIG. 3E71, and the pivot frame is recalculated, only the cell group dependent on conditional object format 3E7001 is recalculated.

Thus, the disclosed technology supports updates to the contents of a pivot frame by observing the dependency associated with each object and tracing all dependent objects, to supply updates accordingly. The database cache server manages the cache such that only those objects dependent on the one being updated is required to be cleared and replaced with the correct result. This technique supports the growth of data stored inside of a pivot frame to greater magnitudes, with lower calculation costs whenever an object is updated.

In many pivot table software applications the setting of one or more filters typically requires an entire recalculation of the target pivot table, which is costly in terms of memory and time (especially when working with large data sets). An aspect of the disclosed technology is a method to apply filters to the values presented by a pivot frame's pivot dimensions and linked pivot dimensions.

FIG. 4A2 discloses a method by which a user may apply a filter to a pivot frame. A user may want to apply filters to the pivot frame illustrated in FIG. 4A3 such that only the cells corresponding to the “jan” and “feb” values of the horizontal pivot dimension “period” are visible. Through the application's visual interface, the user may locate the target pivot frame's filter settings by clicking any cell within the pivot frame's grid, causing a menu bar to appear. By selecting “jan” and “feb” from the menu bar with a mouse, the user sends a request to the application's database containing an object (“{period: [jan, feb]}”) that describes the filters, or pivot frame values, that should be visible to the user of the pivot frame. In addition to the horizontal pivot dimension “period”, there is another horizontal pivot dimension “year” in the pivot frame of FIG. 4A3, which is not included in the aforementioned filter object. Therefore, no values associated with the horizontal pivot dimension “year” will be filtered out of, or excluded from, the pivot frame represented visually to the user. Also, since no vertical pivot dimensions were included in the filter object alluded to in this example, no values of either of the two vertical pivot dimensions “department” and “account” will be filtered out.

When the application's database receives a filter object from the application's user interface, an algorithm is applied that determines the content of the pivot frame to return and display to the user. First, the algorithm iterates over all columns and checks if any dimension ids associated with that column should be visible after filtering. Using the pivot frame of FIG. 4A3, the first column is associated with two dimensions year and period, the algorithm looks at the filter 4A2001{period: [jan, feb]} and determines that it does not include the year dimension, so that horizontal pivot dimension is skipped. The next dimension is period, and the first column's id jan is included in the period filter, so the column is visible. Next, the algorithm proceeds to check for any Horizontal frame filters 4A2002 that excludes the column. In this case, there are none, so the index 0 is pushed to an array that represents the indices of visible columns after filtering. Similarly, the column numbered 5 4A3001 of FIG. 4A3 at the topmost row corresponds to ids mar and 2001, these ids are checked against the user defined filter, and since mar is associated with dimension period but is not included in the filter {period: [jan, feb]}, the column index 5 is not included in the array. In step 4A2003 of FIG. 4A2, the coordinate indices of the filtered columns are added to an array that represents the visible horizontal pivot dimensions. A filter {period: [jan, feb]} would result in the coordinate indices [0, 1, −1, 3, 4, −1], where −1 indicates that a column has been filtered out. The process is repeated for the vertical pivot dimensions.

By using the arrays of horizontal and vertical coordinate indices, the coordinates of the missing matrix can be calculated by taking the first index in the filtered vertical pivot dimension index array and joining that with all indices in the filtered horizontal pivot dimension array to get the first row of data coordinates. By supplying the application's database with a filter object specifying that the user only wants the values “jan” and “feb” of the horizontal pivot dimension “period” to be visible in the pivot frame of FIG. 4A4, the resulting pivot frame will include only the grey shaded values in FIG. 4A4.

If the user were to specify filters for a vertical pivot dimension, the process would be similar to that of applying a filter to a horizontal pivot dimension. In our previous example, in which we specified filters for the “period” pivot dimension, we did not specify any vertical pivot dimension filters. Thus, the result was the following array of coordinate indices: [0, 1, 2, 3, 4, 5]. Together with the array [0, 1, −1, 3, 4, −1], the first entry of the computed missing matrix is the value at row 0, column 0, and the last entry is the value at row 5, column 4. The expected outcome is illustrated in FIG. 4A4.

Much like filtering data, sorting data by user-defined criteria in a pivot table typically requires a recalculation of all objects in order to propagate the information by the user's desired view. Disclosed is a method of sorting data in a pivot frame that avoids costly recalculations, whereby the sorting order can be specified by column dimension.

A user may have a pivot frame such as illustrated in FIG. 43A, in which “price” and “amount” are two vertical pivot dimensions. The user may wish to sort the data in this pivot frame such that 1) the values corresponding to the “amount” pivot dimension are ascending and 2) the values corresponding to the “price” pivot dimension are also ascending. Following the steps outlined in FIG. 42, an algorithm is applied to FIG. 43A, which looks at the column amount, appends a sorting value into a vector, and sorts the data according to ascending order. By utilizing this vector of sorting values, the algorithm can determine the new order of row indices after sorting.

Following the embodiment of FIG. 43A, after sorting with the key amount, the order of data is shown in FIG. 43B where data rows become tea, juice, water, and coffee respectively and the computed rows indices are [1, 2, 0, 3]. Then, the algorithm repeats the same series of steps for the column price by ascending order. After sorting with the key price, the order of data is shown in FIG. 43C, where the data rows represent tea, water, coffee, and juice in respective order, and the computed row indices are [1, 0, 3, 2]. The result gives the correct order of visible row indices according to the sorting order. When there are two products with the same price values such as tea and water, their order is determined based on previous sorting keys, or amount in our embodiment.

Thus, by generating a vector of sorting values based on the dimensions attributed to the user's defined filter, determining the new order of row indices per column sorts the pivot frame, which is much quicker than iterating through each cell and recalculating.

While pivot frames are tools that generate summarized views of datasets and may condense data into cross-sections that are more easily understand and processed by a user, it may still be desirable to further group data. The disclosed technology includes a method to reduce arbitrary data from a table with user defined pivot dimensions into tensors. The algorithm groups data by the innermost pivot dimension, which is defined as that dimension closest to the data cells in a pivoted view. In one embodiment, a pivot frame is constructed as shown in FIG. 4D1. The innermost horizontal pivot dimension is element 4D1002, and the innermost vertical pivot dimension is element 4D1001. The grouping type can be horizontal grouping, vertical grouping or horizontal and vertical grouping (both). The grouping specifications can also be an arbitrary number of pivot dimensions, in which case data is reduced to a tensor instead of an array.

FIG. 4D2 outlines the steps for grouping a pivot frame. After the data has been filtered 4D2001 to arrays that contain relevant coordinate indices for horizontal and vertical dimensions, the next step 4D2002 populates the data grid with visible entries. In one embodiment, as shown in FIG. 4D4, the user may choose to group data vertically where the coa dimension is reduced. The data grid now contains 6/3=2 rows where 3 is the innermost vertical dimension length, and each entry now contains an array of size 3 with data values for rev, cogs, and gp. Our method populates the data grid depending on the user's viewing window, and this allows for an extremely fast response, since only what is required is returned. The grid size is calculated by dividing the total number of dimensions by the innermost reduced dimension size. Following the embodiment on FIG. 4D4 without filtering, the number of data entries is (2*3)*(2*3)=36. A vertical grouping returns 36/3=12 arrays of size 3, a horizontal grouping returns 36/3=12 arrays of size 3, and both grouping returns 36/(3*3)=4 arrays of size 9.

In one embodiment of a vertical grouping, the user may filter for “jan” and “feb” columns and resize their viewing window and scroll to display only data of the third column. Following the filtering method described previously, the horizontal coordinate index array [0, 1, −1, 3, 4, −1] is returned. Since the “mar” columns are filtered out, the entry at the mar column position is −1 and is skipped over. The third column has been mapped to column “jan” (column index 3) during filtering. The algorithm then iterates through all rows of column 3 to return the array [30, 90, 150] for “rev”, “cogs”, “gp” of department “sm” and the array [210, 270, 330] for department “rd”. Again, note that the arrays contain 3 elements, where 3 is the length of the innermost vertical pivot dimension.

In another embodiment where the user wants to group the pivot table by both horizontal and vertical grouping, the user may filter for “jan” and “feb” columns, and “rev” and “gp” rows. Using our filtering algorithm, we compute the horizontal coordinate index array [0, 1, −1, 3, 4, −1] and the vertical coordinate index array [0, −1, 2, 3, −1, 5]. Now, grouping by both directions returns 4 arrays of size 4 each. The data entries returned are illustrated in FIG. 4D4, where the entries included in the filter are in grey. For each visible cell, the algorithm iterates through the innermost vertical pivot dimension and the innermost horizontal pivot dimension, only returning the items that have not been filtered out. The algorithm determines if an entry should be returned by looking at the previously computed coordinate index arrays. For example, a value of “cogs” for “jan” is not included because the value “cogs” has an index of 1, and at index positioned 1 in our vertical coordinate index array [0, −1, 2, 3, −1, 5], there is a −1 which means the row has been filtered out. Essentially, we only include in each array the data whose value in the coordinate index arrays computed by our filtering method is not −1.

After the grid has been populated with cell data, the algorithm populates the vertical header and frame 4D2003 depending on what is visible on the viewing window. From the first to the last visible row, each vertical header and frame are populated with their dimension ids. The algorithm calculates the correct position for each vertical header and frame by adding the number of horizontal header and frame to the column. In our embodiment on FIG. 4D4, the row “sm”−“rev” is indexed 0, and adding 3 for the number of horizontal pivot dimensions and frames, we get to the correct row indexed 3 on the grid. In a similar process, 4D2004 populates the horizontal header and frame.

Thus, the inner pivot dimension may be grouped by its visible entries which provides additional segmentations of data to be analyzed by the user. By only processing the visible entries of a pivot frame in the grouping algorithm, calculation costs may be greatly reduced.

It is desirable to have flexibility in appending new values to a pivot frame, as well as updating and removing values in an intuitive and flexible manner. Disclosed is a method that allows users to create, update and remove a pivot frame's pivot dimensions.

FIG. 5A1 illustrates a pivot frame with “account” as a vertical pivot dimension 5A1001, “periods” as a horizontal pivot dimension 5A1002, and “amount” as the cell dimension 5A1003. A user may want to create a pivot dimension and include it as part of an existing pivot frame such as that in FIG. 5A1 and may do so by following the steps outlined in FIG. 5A7.

Consider an example in which a user may want to add a pivot dimension to the pivot frame illustrated in FIG. 5A1 that represents the different departments included on the user's income statement, i.e., the records included in the departments data table in FIG. 5A2, in order to construct a pivot frame such as illustrated in FIG. 5A3. The departments data table FIG. 5A2 is an example data table with one dimension (“ID”) 5A2001, whereby each record 5A2002 is a department represented in an example user's income statement. The cell containing “ID” 5A2001 is a data table dimension header.

In order to add a pivot dimension to a user's pivot frame, the user must right-click a cell dimension 5A1003 within the pivot frame. Upon the user's right-click, they will be shown the options listed in FIG. 5A4, from which the user will select “New Referenced Dimension” 5A4001 option 5A7002 of FIG. 5A7. Upon selecting “New Referenced Dimension” 5A4001, the user will be shown a “New Referenced Dimension” form such as that illustrated in FIG. 5A5.

The user will fill out the “New Referenced Dimension” form 5A7003. The user will provide an ID 5A5001 for the new pivot dimension, which may be thought of as a permanent identifier. The ID must be unique; no two pivot dimensions within a pivot frame may have the same ID. The user will also provide a Name 5A5002 for the new pivot dimension, which, like the ID, is an identifier for the Pivot Dimension. However, the name is visible to the user in the visual interface and is not required to be unique amongst a pivot frame's pivot dimensions, while the ID is used for internal purposes and must be unique to a pivot frame. Unlike the ID, the name may be changed by the user, and the steps to do so will be covered later in this section.

In FIG. 5A5, the user must also select a reference model 5A5003, a reference table 5A5004 and a reference dimension 5A5005. The definition of reference dimension is different than that of a pivot dimension in that it is a dimension from a data table that a pivot dimension references. Thus, the concepts of reference dimension and pivot dimension are interrelated. For example, if a user wanted to add a pivot dimension to the pivot frame from FIG. 5A1 that has the departments from the data table FIG. 5A2, the user would identify the reference model and reference table corresponding to the departments data table and select “ID” 5A2001 as the reference dimension. The user may elect to give the new pivot dimension an ID of “department” 5A5001 and name of “department” 5A5002. Once the user has made a selection for reference dimension 5A5005, they must click the “Create” button on the form 5A5006, and a pivot dimension will be created and made available for use in the target pivot frame thereafter. If the target pivot frame is represented as a tabular table, the newly created pivot dimension will be included in the pivot frame automatically.

When a pivot dimension is made available for use in a pivot frame that is represented as a pivot table, it becomes available as an option in the “Available Dimensions” 5A6001 section of the Pivot Settings panel illustrated by FIG. 5A6. To use a pivot dimension in a pivot frame, the user must select the pivot dimension from “Available Dimensions” 5A6001 using their mouse 5A7004 and drag the selected Dimension 5A7005 into either the Vertical Dimensions 5A6002 box or Horizontal Dimension box 5A6003. For example, to use a newly created “department” Pivot Dimension in the P-pivot frame illustrated by FIG. 5A1, the user must click and drag “department” from the Available Dimensions section of the Pivot Settings panel 5A6001 and release their mouse over the Vertical Frame Dimensions 5A6002 section of the Pivot Settings panel of FIG. 5A6. The resulting pivot frame is illustrated in FIG. 5A3.

If a user would like to update a pivot dimension, the target pivot frame must be in tabular form. The pivot frame in FIG. 5A9 is a tabular representation of that in FIG. 5A1. Consider FIG. 5A10 as an example end result of updating the “periods” Pivot Dimension from FIG. 5A9 to reference the Data Table in FIG. 5A8 instead of that in FIG. 5A2.

FIG. 5A9 contains a row of pivot headers 5A9001, which include “account,” “periods,” and “amount.” To update a pivot dimension, the user selects the pivot header corresponding to the pivot dimension included in a pivot frame that the user would like to modify. Upon the user's selection, they are prompted with a form titled “Edit Reference Dimension” as shown in FIG. 5A11, which is similar to the “New Reference Dimension” form illustrated in FIG. 5A5, except that it will contain the existing pivot dimension settings. Another difference from FIG. 5A5 is that the “ID” may not be changed for existing pivot dimensions.

Consider an example in which a user would like to modify a pivot dimension called “periods” in the pivot frame FIG. 5A1. The user clicks the cell in the pivot frame containing “periods” 5A9002 in FIG. 5A9 and would be prompted with an “Edit Reference Dimension” form illustrated by FIG. 5A11, which would be populated with the existing pivot dimensions settings. As mentioned previously, the user may modify the Name, Reference Model, Reference Table and/or Reference Dimension and select “Update” to save their changes. The existing pivot dimension was created with a reference to the data table illustrated by FIG. 5A2, but the user would like to use that illustrated by FIG. 5A8, so the user would select the Reference Model, Reference Table, and Reference Dimension appropriate to the table illustrated by FIG. 5A8. The modifications are saved once the user selects “Update” 5A11003 and the pivot frame will update accordingly to reflect the changes FIG. 5A10.

To remove a pivot dimension from a pivot frame, from the pivot settings panel FIG. 5A6, the user must search for the pivot dimension in question in either the vertical dimensions 5A6002 or horizontal dimensions sections 5A6003, select it, drag it over the available dimensions 5A6001 section of the pivot settings panel FIG. 5A6, and release their mouse. This method removes the pivot dimension from the pivot frame, while allowing the user the option to use it again in the future, as its association to the pivot frame is not permanently severed.

To permanently remove a pivot dimension from a pivot frame, the user must use their mouse to select the pivot header corresponding to the pivot dimension included in a pivot frame that the user would like to remove. For example, if a user wanted to delete the “periods” pivot dimension from the pivot frame in FIG. 5A8, they would select the pivot header cell containing “periods” 5A9002. Upon the user's selection, they are prompted with an “Edit Reference Dimension” form FIG. 5A11. The user must select “Remove” 5A11002 from the form, upon which the pivot dimension is permanently removed from a pivot frame and will no longer be an available Pivot Dimension option.

The ability to create, update and remove pivot dimensions adds flexibility to the pivot frame and therefore enhances the value provided by it to the user. By allowing the user multiple options to append new dimensions to a pivot frame, each user is allowed greater freedom to define their own ways of generating and updating data accordingly.

The nature of pivoting data typically requires that the underlying dataset be unified to retain its structure. Disclosed is a method to associate a data table as a pivot dimension. This invention allows a user to quickly append new pivot dimensions and associated values to a pivot frame without following further complex workflows to associate new data.

In addition to the method to create a pivot dimension, a user may also create a pivot dimension by associating a data table as a pivot dimension. The invention is the process by which a data table can be associated as a pivot dimension through a “drag-and-drop” motion with a computer mouse.

To associate a data table as a pivot dimension, a user must use their mouse to select the cell containing the “ID” dimension header of a data table, drag the selected cell to hover over a pivot frame, and release the selected cell over the pivot frame. For example, consider a pivot frame illustrated in FIG. 5A1 and a data table illustrated in FIG. 5A2. The user selects the “ID” cell 5A2001, drags it over the pivot frame in FIG. 5A1 and releases the cell over the pivot frame. Upon release, the user will be shown a form such as shown in FIG. 5A5.

The instructions from this point onward for associating a data table as a pivot dimension are identical to those from FIG. 5A7 starting with step 4 5A7003.

The ability to associate a Data Table as a Pivot Dimension adds flexibility to the PivotFrame and therefore enhances the value provided by it to the user.

An aspect of the invention is a method to visually interface with conditional formulas of a table using what we call a console to create, update, or remove conditional formulas. The formula console is a visual interface that provides the user with the necessary input items to conditionally apply a formula to cells meeting condition criteria set by the user. Since tables can be infinite in size, the formula console visual interface enables users to target cells based on the applied dimension and condition criteria.

FIG. 5C1 illustrates the interface for the formula console and the related inputs necessary to apply a conditional formula to a cell or group of cells. Element 5C1001 illustrates the interface for a free form input box where a user can enter a formula. Element 5C1002 illustrates the interface for providing the name of this formula to determine the purpose for this table, which must be unique per table. Element 5C1003 illustrates the interface for a user to determine which table dimension to apply the conditional object and a drop down to provide the available dimensions. Element 5C1004 illustrates the interface to automate the creation of conditions for a pivot table. A user selects line items within the pivot frame and provides the user with the conditions that meet the criteria of a cell. Element 5C1005 illustrates the interface to manually create conditions and determine the criteria for cells or group of cells in the specified dimension. Element 5C1006 illustrates the button to add a condition after it has been defined. Element 5C1007 illustrates the interface to create or update a conditional formula. Element 5C1008 illustrates the removal interface for a condition, and element 5C1009 illustrates an interface designed to create a net new conditional formula.

Our formulas allow for free form expression meaning a user can flag a line or multiple lines of a formula that should not be evaluated during calculation. This is so that comments or documentation can be incorporated in the formula itself to explain the intent of portions of the formula. The visual interface displays the text in a green color to indicate that the conditional formula will be calculated. A user can exclude an individual line by using the characters “//” This will exclude anything after that character within the individual line. For multiple line exclusions the user will include the characters “/*” to identify the start of the exclusion for calculation and the characters “*/” to identify the end.

FIG. 5C2 illustrates the steps to create a conditional formula using the console.

FIG. 5C3 illustrates a user interface to prompt a user to define the condition criteria 5C2007 in the formula console 5C1005. The condition is defined by selecting the dimension, logic symbol, and then providing relevant input. Equals comparison 5C3001 can apply to strings, dates, and numbers as the condition to ensure it is exact whether the evaluated cells contain strings, dates or numbers, but the other symbols for Greater than or Less than comparison apply only to numbers or dates 5C3002-3006 where numerical evaluation is applicable. Multiple criteria can be set by a user as the “+” interaction is designed to add more than one condition 5C1006.

In one embodiment of this invention, a user may want to set a conditional formula and update specific cells of a data table with a single condition. FIG. 5C4 illustrates a data table named “Ledger” and with the Dimensions of “id”, “dept”, “coa”, “period”, and “amount,” after following steps outlined in FIG. 5C2001-5C2003. User populates the data with values in “id”, “dept”, “coa”, “period” and with no values in the cells of the “amount” Dimension 5C4001.

The user wants to add the formula 10*2 in the “amount” dimension where the dimension “period” is “=” (exactly equal) to “jan.” FIG. 5C5 illustrates an example formula console with a completed conditional formula following the steps found in FIG. 5C2 and FIG. 5C3. The user selects the “+” button to add the condition criteria of dimension “period” is “=” to “jan”, and the resulting “1” that appears to the right of button 5C1006, signify condition criteria has been successfully added to the conditional formula.

FIG. 5C6 illustrates the cells that exactly match the condition criteria of value inside of dimension “period” being “=” (exactly equal) to “jan” 5C6001 in the console illustrated by FIG. 5C5. Note that if the conditions are blank in the defined area 5C1005, the conditional formula would apply to all cells within the “amount” dimension, as illustrated by FIG. 5C6002.

FIG. 5C7 illustrates the output of the conditional formula created in FIG. 5C5 in the relevant cells of the “amount” dimension 5C7001.

In another embodiment of the invention, a user may want to update a conditional formula and add documentation related to the formula in the input box 5C1001. The user selects a cell containing conditional formula 5C7001 to see the conditional formula in the console illustrated in FIG. 5C5. With the console opened, the user may edit the formula in the console and write the following:
Line one: user writes “//Susy told me to use this calculation on 1/1/2020”—Not Calculated
Line two: user writes the formula “10*1000”—Calculated Line three: user writes “/*Note that this is the old calculation”—Not Calculated
Line 4: user writes “10*2*/”.—Not Calculated

FIG. 5C8 illustrates the above actually written out inside of the console. Note that lines one, three and four will not be evaluated for calculation because they have been effectively commented out from formula calculation. The user may select the save icon illustrated by FIG. 5C1007 and will complete the update of the Conditional Formula 5C2008 by clicking the save icon.

The resulting output of the “Ledger” Table based on the conditional formula in FIG. 5C8 is illustrated by FIG. 5C9. The results on the conditional formula can be found in cells illustrated by FIG. 5C9001.

In another embodiment of this invention, a user may want to set a conditional formula and update specific cells of a data table with multiple conditions.

FIG. 5C4 illustrates a data table called “Ledger” constructed with dimensions “id”, “dept”, “coa”, “period”, and “amount.” In this scenario, the user populates each cell in the dimensions “id”, “dept”, “coa” and “period” with values and with no values in the cells of the “amount” dimension 5C4001.

The user may create a conditional formula with 10*2 in the “amount” dimension and set multiple condition criteria onto the condition, where the dimension “period” is “=” to “jan”, where the dimension “dept” is “=” to “sm”, and where the dimension “coa” is “=” to “rev.” FIG. 5C10 illustrates an example formula console with a completed conditional formula following the steps found in FIG. 5C2 and FIG. 5C3. After the user has selected the “+” button for each condition criteria, note that the “3” 5C10001 appears, to signify that 3 criteria have been added. Element 5C10002 shows the details for criteria added in the conditional formula. FIG. 5C11 illustrates the output of the conditional formula in the related cells of the “amount” Dimension.

In another embodiment of the invention, a user may want to highlight cells of a pivot table and automatically generate condition criteria for a conditional formula. In all the previous embodiments, condition criteria are manually provided by the user. This embodiment enables a user to select pivot frame items, which highlight relevant cells per the intersection of dimensions in a pivot frame, and the console will automatically populate the condition criteria for those highlighted cells by selecting the target icon 5C1004.

FIG. 5C12 illustrates a pivot table with this highlight interaction. The user may click on the line item “gp” 5C12001 from vertical pivot dimension “coa”, and the pivot table will have all relevant cells highlighted. The user then goes to the console as illustrated in FIG. 5C13 and clicks on the button 5C13001 to automate criteria creation, which may result in the criteria illustrated by element 5C13002.

FIG. 5C14 illustrates a pivot table with this highlight interaction based on selections of a pivot tables vertical and horizontal pivot dimension line items. The user clicks on the vertical pivot dimension line item “cogs” 5C14001 and horizontal pivot dimension “mar” 5C14002. Now the pivot table has all relevant cells highlighted. The user then goes to the console in FIG. 5C15 and clicks on element 5C15001, which generates the conditional criteria illustrated by element 5C15002.

The disclosed console for conditional formulas allows the user to define a customized set of conditions to apply functions to data. Based on a current selection, additional tools automate the creation of conditions. Many conditional objects may be created by the user to define data as desired. One Conditional Object may have many conditions.

The invention includes a method to visually interface with conditional objects of a table using a console. Through the console a user can create, update, or remove conditional objects. The console for conditional objects behaves similarly to conditional formulas except there are specific console interfaces for each conditional object type. This enables users to define tasks, comments, styles, formats, and graphs to cells or groups of cells.

FIG. 5D1 illustrates the interface for the console and the related inputs necessary to apply a conditional object to a cell, a group of cells, or to multiple groups of cells within a table. Element 5D1001 illustrates each conditional object type as an available selection to display the relevant fields for defining and applying the conditional object. Element 5D1002 illustrates the interface by which a user can provide the name for a conditional object to identify its purpose for this table, which must be unique per table, to correctly store it in memory. Element 5D1003 illustrates the interface for a user to determine which table dimension to apply the conditional object onto, with a drop down to provide each available dimension for selection. FIG. Element 5D1004 illustrates the interface to automate the creation of conditions for a pivot frame. A user may select an individual cell within the pivot frame and the interface will be visually updated with the conditions that meet the criteria of a selected cell. Element 5D1005 illustrates the interface to manually create conditions and determine the criteria for which cell, group, or groups of cells that each condition will apply onto within the specified dimension. Element 5D1006 illustrates the button that, when selected, will add a condition after it has been defined. Element 5D1007 illustrates the interface that, when selected, will create or update a conditional object. Element 5D1008 illustrates the interface that, when selected, will remove the conditional object as it is displayed on the console, and element 5D1009 illustrates an interface designed to create a new conditional object.

FIG. 5D2 illustrates the steps to create a Conditional Object using the Console. The figure further illustrates the visual interaction when defining a conditional object through the console. The condition is defined by selecting a dimension, selecting the appropriate logic symbol (>, <, >=, <=or =) and providing relevant input to define the criteria 5D2007. Multiple criteria can be set by a user. The “+” interaction is designed to add individual condition criteria and allow the user to define more than one condition criteria.

The console is a visual interface that provides the user with the necessary input items to conditionally apply a conditional object to cells which meet the condition criteria set by the user. Since tables can be infinite in size, the console visual interface enables users to target specific cells based on the applied dimension and condition criteria as specified.

In one embodiment of this invention, the user may want to set a conditional object format for each value contained inside of a cell, a group of cells, or to multiple groups of cells using the Console.

FIG. 5D4 illustrates the console for conditional object formats after the user has selected one of the displayed, preset formats 5D2004. The user may click on one of the displayed options in Console 5D1001 to determine which format to apply and complete the steps in FIG. 5D2.

FIG. 5D5 further describes the types of format settings as illustrated by FIG. 5D4 and with examples of resulting cell values by appearance, based on the creation of the conditional object format. Note that the invention is not limited to the preset formats found in FIG. 5D4. A window 5D4009 illustrates the code that will be saved with each conditional object format that is selected, in the form of JSON. This window is populated with code corresponding to format as the user selects one or more formats 5D4001-4008, or as the user edits the code manually to add, edit or remove formats.

FIG. 5D6 further illustrates examples of formats applied to numerical cell values in each individual data table dimension after each conditional object format has been created by user. Element 5D6001 illustrates a number format without decimal places, element 5D6002 illustrates a dollar currency format with two decimals, and element 5D6003 illustrates a date format of YYYY/MM/DD. All formats are applied to cells containing numerical values.

In another embodiment of the invention, the user may want to set a conditional object style for each numerical or non-numerical value contained inside of a cell, a group of cells, or to multiple groups of cells using the console. Styles manipulate cells or contents of cells such as fonts, colors, alignment, sizing, bold, italicize, underline, etc.

FIG. 5D7 illustrates the conditional object console for styles and displays preset styles for a user to select 5D2004. The user may click on one of the displayed options in console element 5D1001 to determine which style to apply and to complete the steps in FIG. 5D2.

FIG. 5D8 further describes the types of style settings for FIG. 5D7. The figure includes examples of the conditional object styles that can be applied. Note that the invention is not limited to the preset styles found in FIG. 5D4.

Element 5D7005 illustrates the code that will be saved with the conditional object, which is populated as a user selects one or more style options 5D7001-7004, or as the user edits the code manually to add, edit or remove styles.

FIG. 5D9 illustrates examples of styles applied within a table after a conditional object style has been created by the user through the console. Element 5D9001 illustrates a style created by user to align the content of the “alignment” Dimension. Element 5D9002 illustrates a style created by user to add borders of each cell of the “border” Dimension. Element 5D9003 illustrates a style created by user to increase the font size of the contents in each “font size” dimension. FIG. 5D9004 illustrates a style created by a user to bold, italicize, and underline the contents of each cell of the “border italicize underline” Dimension. Element 5D9005 illustrates a style created by a user for background color of each cell in the “color” dimension.

In another embodiment of this invention, a user may want to set a cell graph in place, beside, or in front of each numerical value contained inside of a cell, a group of cells, or to multiple groups of cells using the console. FIG. 5D10 illustrates processing operations for a conditional object type.

Defining each cell graph depends on two data points: a cell value and a maximum value provided by the user. When the two data points are compared, the size, positioning, layout and/or color (based on the type selected by user) of cell graph is determined and generated. Each cell graph type is affected differently based on the maximum value defined by either default or by user, as illustrated in FIG. 5D11.

The default cell graph setting for maximum is the largest observed value from the entire range of cell values selected by the user after defining condition criteria, and generates each graph using the cell value compared against the maximum value.

FIG. 5D11 illustrates the console at the point in which each cell graph type has been selected and the related settings for each cell graph type. Element 5D11001 illustrates the cell graph buttons on the console. Element 5D11002 illustrates graph settings for each type of cell graph. The graph settings displayed to the user in the console are dependent on the type of cell graph selected. Each setting allows the user to modify cell graphs to their specification, altering visual characteristics, i.e., fill color, which apply to every cell graph generated per type.

FIG. 5D12 represents the table results of conditional object cell graphs illustrated in 5D11. FIG. 5D13 describes each Cell Graph within 5D12.

In another embodiment of this invention, a user may want to set a task or comment within a cell or groups of cells using the console. FIG. 5D14 illustrates step 5D2004 for a conditional object.

FIG. 5D15 illustrates a console for creating a conditional object for tasks. To support different conditions that a user may be required to set in terms of formatting the desired data in a table, conditional objects and the console for conditional objects allow the user the freedom to define a customized set of conditions by which to apply styles, formats, cell graphs and tasks onto data, regardless of size. Based on current selection, additional tools automate the creation of conditions. Many conditional objects may be created by the user to define data in a desired manner. One Conditional Object may have many conditions.

Existing software applications that generate pivot tables do not allow users the ability to create dimensions whose values depend on pivot dimensions. An embodiment of the invention is a method to create, update and remove linked pivot dimensions from pivot frames.

As mentioned previously, a linked pivot dimension is a special type of dimension in a pivot frame that is linked to a pivot dimension. Consider a pivot frame in tabular form that has a user's income statement information, as illustrated if FIG. 5E1. The user may wish to add a linked pivot dimension to the pivot frame called “Frame,” which is linked to the pivot dimension “periods” that references the table represented in FIG. 5E2. The user may do so by following the steps outlined in FIG. 5E7. Adding the linked pivot dimension produces an embodiment of the invention, exemplified by the pivot frame in FIG. 5E4. The invention is the process by which a pivot frame can be constructed with a linked pivot dimension.

The user may add a linked pivot dimension if a pivot frame includes a pivot dimension that references a data table with one or more dimensions in addition to the “ID” dimension. Consider the pivot frame illustrated in FIG. 5E1, which includes a pivot dimension “periods” referencing the “ID” dimension from the table illustrated by FIG. 5E2. A user could add a Dimension to the data table of FIG. 5E2 called “Frame” for example using step 5E7001 of FIG. 5E7. This represents whether a month in the “ID” column corresponds to a historical period (“hist”) or a future projection period (“fcst”). FIG. 5E3 is an example of such resulting Data Table. Given the addition of the “Frame” dimension to the table illustrated in FIG. 5E2 to produce that in FIG. 5E3, the user would now be able to add a linked pivot dimension to the pivot frame representing the “Frame” dimension from data table of FIG. 5E3. This is achieved by performing a horizontally-oriented lookup on the pivot frame's “periods” pivot dimension.

Continuing our example, the user may add “Frame” as a linked pivot dimension to the pivot frame FIG. 5E1 by navigating their mouse to any Cell Dimension 5E1001 within the pivot frame and right-clicking, which is step 5E7002 of FIG. 5E7. The user will be prompted with a table of options as listed in FIG. 5E5, from which the user must select “New Linked Dimension”, which is step 7003 of FIG. 5E7. Upon this selection, the user will be shown a “New Linked Dimension” form such as that illustrated in FIG. 5E6.

The user will fill out the “New Referenced Dimension” form 5E7004. The user will specify an ID for the new linked pivot dimension, which may be thought of as a permanent identifier. The ID must be unique; no two linked pivot dimensions within a pivot frame may have the same ID. This rule also applies to pivot dimensions (i.e., linked pivot dimensions and pivot dimensions may not share IDs within the same pivot frame). The user will also provide a Name for the new linked pivot dimension, which, like the ID, is an identifier for the pivot dimension. However, the Name is visible to the user in the visual interface and is not required to be unique amongst a pivot frame's linked pivot dimensions, while the ID is used for internal purposes and must be unique to a pivot frame. Unlike the ID, the name may be changed by the user, and the steps to do so will be covered later in this section. The user must also select the 1) pivot dimension to which the linked pivot dimension will be linked and 2) the dimension from the data table underlying the aforementioned pivot dimension for which the user would like to add as a linked pivot dimension.

In our example, the user wishes to add the “Frame” dimension 5E3001 from the “Periods” Data Table FIG. 5E3 as a Frame dimension. The user must select 1) the “Periods” dimension as the pivot dimension to which the new linked pivot dimension will be linked and 2) the “Frame” Dimension from the data table underlying the “Periods” Pivot Dimension (the “Periods” Data Table FIG. 5E3). To create the linked pivot dimension, the user must select the “Create” button on the form in FIG. 5E6, after which the linked pivot dimension becomes available for inclusion within the pivot frame. If the target pivot frame is represented as a tabular table, the newly created linked pivot dimension will be included in the pivot frame automatically.

Like pivot dimensions, when a linked pivot dimension is made available for use in a pivot frame represented as a pivot table, it becomes available as an option in the “Available Dimensions” section of the pivot settings panel represented in FIG. 5A6. To use a linked pivot dimension in a pivot frame, the user must select the linked pivot dimension from “Available Dimensions” using their mouse, which is step 5E7005, and drag the selected linked pivot dimension, which is step 5E7006, into either the vertical frame dimensions box 5A6004 of FIG. 5A6 or Horizontal Frame Dimension box 5A6005 of FIG. 5A6. For example, to use a newly created “Frame” linked pivot dimension in the pivot frame illustrated in FIG. 5E1, the user would find, click and drag “Frame” from the Available Dimensions section of the Pivot Settings panel (an example of which is FIG. 5A6) and release their mouse over the vertical frame dimensions section 5A6004 of the pivot settings panel.

To update a linked pivot dimension, the target pivot frame must be represented as a tabular table. FIG. 5E9 is a tabular version of the pivot frame in FIG. 5E4. We will use FIG. 5E9 as an example. The user must use their mouse to select the linked pivot header cell corresponding to the linked pivot dimension included in a pivot frame that the user would like to modify. Upon the user's selection, they are prompted with a form titled “Edit Linked Dimension”. Consider an example in which a user would like to modify a linked pivot dimension called “Frame” in a pivot frame such as shown in FIG. 5E9. The user would click the cell in the pivot frame containing “Frame” 5E9001 and would be prompted with a “Edit Linked Dimension” form 5E8, which would be populated with the linked pivot dimension's existing settings. The user may modify the name, pivot dimension to which the linked pivot dimension is linked, and the dimension from the data table underlying the pivot dimension. To save changes made, the user must select “Update” 5E8002, and the linked pivot dimension and pivot frame will update accordingly.

To remove a linked pivot dimension from a pivot frame, from the pivot settings panel FIG. 5A6, the user must find the linked pivot dimension in question in either the vertical frame dimensions 5A6004 or horizontal frame dimensions 5A6005 sections of the pivot settings panel, select it, drag it to hover over the Available Dimensions section of the Pivot Settings panel 5A6001, and release their mouse. Following these steps allows the user to remove the linked pivot dimension from the pivot frame, while retaining the option to use it in the future, as an available linked pivot dimension option for the pivot frame.

To permanently remove a linked pivot dimension from a pivot frame, the user must use their mouse to select the linked pivot header cell corresponding to the linked pivot dimension included in a pivot frame that the user would like to remove. Upon the user's selection, they will be prompted with a form titled “Edit Linked Dimension,” similar to that illustrated in FIG. 5E8. The user must select “Remove” 5E8001, upon which the linked pivot dimension will deleted and cease to have an association with the pivot frame.

The fact that a linked pivot dimension is linked to a pivot dimension provides unique advantages in terms of the functionality available to a user. Some existing pivot table software applications allow the user the ability to create the equivalent of linked pivot dimensions, but they constrain the user to define such a dimension as being linked specifically to a pivot dimension.

When dealing with many different datasets residing in one location, updating one table may cause all other tables in the same location to update accordingly, which may be unnecessary in many cases. We have invented a way for the user to define when a table or set of tables should be calculated and in what sequence it should be calculated within an instance and branch. Each table can be assigned a property called calculation type, which is a string provided by the user.

By default, all tables have the calculation type of “auto”. The user can then choose when to calculate all tables of a selected calculation type and specify a sequence in which calculation types should be calculated.

Note that while the current software design limits calculation type to be applied to a table or a set of tables, the invention covers the case where the calculation type is applied to a subset of a table, or subsets of tables.

FIG. 6A1 describes the method by which a calculation type property is evaluated to calculate tables within a Branch. FIG. 6A2 Illustrates the criteria for calculation of Step 3-5 (6A1003-1005) of FIG. 6A1.

In one embodiment of the invention, a user may want to set a calculation type to control calculation for a single data table within a branch. FIG. 6A3 Illustrates the steps involved in creating a calculation type for a table. The user first creates a table 6A3001 and populates data into that table 6A3002. An example table is illustrated in FIG. 6A4. The first dimension contains the id record, while the second dimension contains a list of customers, with values 1, 2, 3 and 4 denoting each. The third dimension contains values for each month period, such as jan—denoting the month of January, feb—denoting the month of February, and mar—denoting the month of March.

The user creates a dimension for reporting in a Table 6A3003. An example of this can be found in the Data table FIG. 6A5. Note this example, creates a new dimension called “segments” 6A5001.

The user creates a conditional formula for the new dimension 6A3004, defining logic for the conditional formula, and applying it to relevant cells. An example of the logic used for a conditional formula can be found in FIG. 6A6, which defines each segment by setting a threshold 6A6001 on the value of the “amount” dimension by record. The user creates a conditional formula using this logic and applies this formula to all the cells of the “segments” dimension 6A5001. The output of this conditional formula is in the “segments” dimension which it is applied onto, as represented in FIG. 6A7.

However, larger data tables with many records and calculations can cause performance issues if cells of a table are often changed. As a result of the default calculation type “auto”, recalculation will happen with user input. A user will want to make changes to a table but may not want the table to recalculate until the user is finished applying all changes to the cells of the table.

The user will need to create a calculation type, apply created calculation type to the table 6A3005 and provide a name for the calculation type. After doing so, the user will now have control of when a calculation type will recalculate the cells of a table. After providing a name for the calculation type such as “data,” the user will save it and apply it to the data table. The user can attempt to update the conditional formula logic of FIG. 6A6 and the resulting cells of the Table FIG. 6A5 will still be the same as if the table was not recalculated.

The user updates the conditional formula 6A3006 to initiate calculation of the specified calculation type. An example of this would be the user initiating calculation type “data” of table FIG. 6A5. The results of the table will now recalculate using the updated conditional formula logic of FIG. 6A6 and the output the Table FIG. 6A7.

The embodiment above is limited to a single data table, but a user is not limited to a single calculation type per table. The user can assign the same calculation type and initiate recalculation for multiple tables (pivot frames or data tables) in a branch.

In another embodiment of this invention, the user may want to set calculation types on multiple Tables. A user creates a pivot frame FIG. 6A10. The user creates a conditional formula to SUM the data table cells of the “amount” dimension of FIG. 6A9 by “periods” and “segments.” Then the user assigns the calculation type of the “customer analysis” pivot frame to “data.”

The user changes the conditional formula logic illustrated in FIG. 6A8 to logic as illustrated in FIG. 6A6. Both FIG. 6A9 and FIG. 6A10 cells will remain the same until the user initiates the calculation type “data.” The user initiates the calculation type “data” and the data table illustrated in FIG. 6A9 will recalculate and result in a data table as illustrated in FIG. 6A7. FIG. 6A10 recalculates to a pivot frame as illustrated in FIG. 6A11.

In another embodiment, the user may want to sequence the calculation types of tables. A user may want to change the pivot table of FIG. 6A11 calculation type from “data” to “pivot” and keep calculation type for the data table of FIG. 6A7 as “data.” The user changes the conditional formula logic illustrated in FIG. 6A6 to FIG. 6A8. Both FIG. 6A7 and FIG. 6A11 cells will remain the same until the user initiates the calculation types “data” or “pivot.”

The user initiates the calculation type “data” and the data table illustrated in FIG. 6A7 will recalculate and return the new results of FIG. 6A9 based on the updated calculation type. The user initiates the calculation type “pivot” and the pivot table illustrated in FIG. 6A11 recalculates the result shown in FIG. 6A10.

Updating part of a pivot table typically causes the entire table to be recalculated once the user has finished updating, causing extended calculation times to occur where they may not be desired. We have invented a method for the user to define when a subset of a pivot frame should be calculated, and in what sequence it should be calculated. Each pivot frame can be assigned one or more conditional objects, collectively, a conditional stack, and each conditional stack can be assigned a property called calculation type.

Note that while the current software design limits calculation type to be applied to a pivot frame or a set of pivot frames, the invention covers the case where the calculation type is applied strictly to a subset of a pivot frame, or subsets of pivot frames.

In one embodiment of this invention, a user may wish to set a calculation type on a single conditional stack of a pivot frame. FIG. 6B1 Illustrates the steps involved in creating a calculation type for a conditional stack of a pivot frame. In one example of this embodiment, a user may create a pivot frame such as the one illustrated in FIG. 6A10 and set its calculation type to “pivot”. A conditional stack may be generated by creating one or more conditional objects attributed to that pivot frame 6B1002.

To apply a conditional stack onto pivot frame, the user may create one conditional object format of left-aligning values in all cells of a pivot frame where “period” is equal to “jan,” and one conditional object cell bar graph to all cells where “period” is equal to “feb”, as illustrated in FIG. 6B2. By creating these two conditional objects, the user generates a conditional stack. The user may create and set a calculation type such as “stack1” onto this conditional stack to determine when to initiate its calculation 6B1003 and thus, each time the Calculation Type “stack1” is initiated, the pivot frame itself shall not be recalculated, while the conditional stack that is applied onto the pivot frame is recalculated 6B1004.

A user may update the conditional formula logic to introduce more values in “segments” and append new values to the pivot frame's reference data table, as illustrated in FIG. 6B3 and FIG. 6B4, respectively. By initiating the “pivot” calculation type, the pivot frame will grow, as illustrated in FIG. 6B5, however the conditional stack remains the same until its respective calculation type is initiated. Only once the user initiates the calculation type attributed to conditional stack, the conditional objects are updated in the pivot frame, as illustrated in FIG. 6B6.

As the value of a cell may be obtained through the application of a conditional formula, which may reference values from other cells, and which the process repeats, it is desirable to be able to see the chain of cells that are accessed that lead to the calculations of the cell. We have invented a method to view each chain of cells that lead to an individual cell's calculation in pivot frame, thus enabling auditing capabilities and returning any reference values that contribute to calculation.

In one embodiment, a user may have a pivot frame in pivot form which contains arbitrary values set by historical data 6C2001 and values generated as a result of conditional formula applied 6C2002 of FIG. 6C1.

In evaluating the cell from cell dimension where horizontal pivot dimension equals “forecast” and where vertical pivot dimension equals “rd,” 6C2003 we may determine that the cell value is the result of a formula summing all historical data where vertical pivot dimension equals “rd” 6C1002. By determining that the values of the previous two cells, as shown visually, are accessed inside of the formula used to populate it, we must store the addresses of each cell 6C1003 and 6C1004 to the trace structure of the evaluating cell which, when evaluated, allows the user to audit the cell and trace its calculation to the other cells that are used to generate its value.

In another example of this embodiment, the user may evaluate the cell from cell dimension where horizontal pivot dimension equals “forecast2” and where vertical pivot dimension equals “rd” 6C2004. The formula used to return its value takes the value from cell where horizontal pivot dimension equals “forecast” and where vertical pivot dimension equals “rd,” and multiplies it by 1.2, or increases by 20%. In addition to storing the address of the cell referenced 6C2003, we must recursively perform the same operation 6C1005 on that cell to determine its immediate children. Due to being computed by two other cells, the addresses for the two cells referenced in cell 6C2003 (and noted above) must be stored as well. By auditing this cell, the user will be able to trace the immediate children of the evaluating cell, and the immediate children of the cell referenced in it.

Cells in a cell dimension of a pivot frame may obtain their values by applying a conditional formula. A common operation in a conditional formula is the SELECT operation, which returns a subset of cells in a dimension of (usually another) table that satisfies some conditions. The condition can be null, and all of the cells in that dimension will be returned.

For example, given a ledger with financial records and a pivot frame such as an income statement, where the cell dimension is called “amount”, each cell “c” in “amount” is computed by this formula:

SELECT all “amount” entries in “ledger” WHERE
the ledger entry's period equals to the period where “c” is in, AND
the ledger entry's dept equals to the dept where “c” is in and SUM these entries

The exact format of the formula depends on the software, and different conditions maybe specified.

In this example, to compute every cell in the cell dimension, the algorithm needs to examine each record in the ledger. The runtime is O(n*k) where n is the size of the ledger and k is the size of the pivot frame. In the Big-O notation, it is simplified as O(n\hat{ }2), which is an exponential function.

To reduce search time, indexing can be used where an index of a dimension of a table returns the set of the record indexes that match the input key. For example, once an index is created for the ledger's “period” dimension, then when the algorithm needs to find “where period equals to Jan 2020”, it will be a single lookup operation that returns all the record indexes in the ledger that match the condition, using an efficient data structure such as a hash table. The total runtime is now O(n) since indexing lookup can be made very fast using an efficient data structure.

This is a significant saving in runtime performance. Indexing is normally done explicitly by a user. However, indexing takes computer resources and may also introduce performance degradation since a table's indexes must be rebuilt whenever the table's structure or data is changed, and therefore adding an index may degrade UI responsiveness while the user is working.

The disclosed technology performs auto-indexing on a table's dimensions based on their usage in conditional formulas and that they satisfy certain criteria.

In FIG. 6D2 step 1 is a SELECT operation [1001]. In step 2 the top-level conditions are evaluated to determine whether auto-indexing should be performed [1002]. For example, if the conditional formula has conditions that are rarely true, or if the memory usage is too high, then auto-indexing should not be done. The exact metrics depend on the system configuration and software design.

Step 3 deduces all the dimensions that are referenced in the SELECT operation

Step 4 applies metrics to determine which dimensions should be auto-indexed [1004]

The criteria may be similar to those in step 2, but it may also include other conditions. The exact metrics depend on the system configuration and software design.

In step 5, indexing is done on the qualifying Dimension [1006]. There are additional opportunities to increase the performance of SELECT operations. The base data set, whether it is a ledger or other raw form of data, can have many records; a million and much more is possible. There are cases where a SELECT would select the entire set of records. For example:

SELECT all “amount” entries in “ledger”

With this operation, all cells in the “amount” Dimension are selected. From the theory of statistic, if the data in the selected cells follow a Normal Distribution or Gaussian Distribution, a smaller random sample can be taken from the set of record indexes, with little impact on the quality of resulting data analysis.

When statistical sampling is used, then the runtime is O(k) where k is the sample size used, and usually significantly smaller than n, the total number of indexes.

Referring to FIG. 6E1 and FIG. 6E2, the process starts with a user writing a SELECT function with statistical sampling operation in their formula [1001]. This can be implemented as either a separate function, e.g., SELECTSAMPLE, or a parameter for the SELECT function. The user may do this because they know that the data obeys or probably obeys the Normal Distribution law, and that without using statistical sampling, the entire set of all indexes will be used.

Next is the start of the SELECT sampling function [1002]. First it determines the total number of records. The function derives a sample size [1003]. Assuming a Normal Distribution, a hardcoded sample size of 1000 can be used, giving approximately 95% confidence level and 5% confidence interval (also known as the margin of errors). Or the function may accept a desirable confidence level and confidence interval as parameters from the user and use a statistical formula to compute the desirable sample size.

If the sample size does not meet certain criteria, such as not less than ½ of the number of all records, then proceed to Step 5 in FIG. 6E2 using the set of all indexes. Otherwise, proceed to obtain a subset of the records as follows.

In step 4, sample size entries will be randomly selected from the set of all the indexes. This could use any of the random algorithms. Steps 4a to 4c details one algorithm, but others are possible.

A SELECT statement returns the set of entries in a table that satisfies certain conditions. Within a formula, there may exist multiple calls to SELECT statements with the same conditions and other parameters. For example, a formula may appear as follows:

CALL FUNCTION kmeans with
first argument=SELECT Dimension “D1” from “tabular table A” WITH conditions
second argument=SELECT Dimension “D2” from “tabular table A” WITH conditions
. . . other arguments . . .

The actual placements or orders of the arguments do not matter, and the SELECT functions may even be arguments for two different functions, instead of the same function. The important point is that both SELECT functions have same Conditions and parameters other than the Dimension they are selecting on.

When there are multiple SELECT operations with the same conditions, with a normal SELECT function, each operation produces the same set of records. However, with a sampling SELECT function, there is no such guarantee. Therefore, for sampling SELECT to work correctly under this scenario, the sampling SELECT function must be defined such that given the same parameters and conditions, they return the same set of record indexes.

Disclosed are methods that extend the pivot frame and related inventions to run on multiple computer servers, and the ability to aggregate data from multiple external database servers without having to pull in all of the data from the external databases.

As documented so far, the pivot frame descriptions assume that in the case of a large data table such as a ledger, it is incorporated into the pivot frame software environment. This would typically be done as a data import or data ingestion function.

This approach limits the amount of data the software system can handle by the amount of storage available on the system running the pivot frame software. Particularly in the field of “big data”, it is desirable to be able to analyze massive amount of data, often spread across multiple servers and running different database software, located anywhere in the world. Toward this end, we have invented additional methods to handle “big data” within the pivot frame framework.

This collection of inventions proposes using different servers to perform functions needed by pivot frame software in novel ways. Instead of actualizing a large data table such as a ledger, a large data table can be implemented virtually as data records randomly accessed from an external database server on an as-needed basis. The invention uses a database cache server to manage transaction requests between the pivot frame software performing calculations on the models and multiple external database servers.

A single database cache server can handle multiple external database servers. Additional database cache servers can be deployed to handle additional external database servers when the capacity is exceeded.

To take advantage of this invention, the software implementing the pivot frame allows a “virtual Data Table” to be created. That is, instead of constructing the data table in the server's storage units, the data table's contents and other properties such as the table length, are fetched through the database cache server on an as-needed basis.

FIG. 7A1 illustrates the dataflow between the pivot frame calculation engine 1001, the database cache server 1002 and the external database servers 1003. A server 1001 running pivot frame software, and in particular, the calculation engine portion of the software, wishes to get data from an external data server (one of the many such servers denoted by 1003).

The transaction goes through the database cache server 1002 which contains information on how to locate the external database servers 1003. The database cache server runs software that interfaces with the external database servers 1003, and with the correct software protocols suitable for the particular server and external database. The software also implements the mapping between data format requested by 1001 and the data provided by 1003.

FIG. 7A2 details the steps in this invention. A request comes from a server running pivot frame software 1001 that needs a data record from a database, which is received by the database cache server 1002.

Next, if the requested data record is in the database cache server's cache, then it shall be returned immediately.

Otherwise, in step 3, the database cache server determines which external database server 1003 is being referenced and determines which data record is needed from the external database table. This results in an external database request, the format of which is dependent on the external server and database.

It is often the case that a model would only need certain fields in the actual database records. Also, the name of the fields maybe different between the model and the actual data table column labels, for example, “COA” instead of “Chart of Accounts”. Lastly, other data transformations might be needed; examples include eliminating invalid characters or normalizing the numerical data, etc. All of these issues would be handled by a software component in the database cache server 1002.

In step 4, the external database request is sent to the external database server using protocols defined by the database and the server. For example, it could be in the form of a web server request using a REST API.

In step 5 response data from the external database server is parsed and translated into the fields needed by the requester. The result is then sent back.

In the final operation of FIG. 7A2, the database cache server manages the data from the external database server in its internal cache to maximize performance and minimize storage needs. This could be in the form of using a standard cache replacement policy, such as deleting entries that have not been referenced for a long period of time.

Cached data can be stored in a database in the database cache server using a standard database engine, such as MySQL.

FIG. 7A3 is an example of a database record reference to an external database server from the pivot frame calculation engine. This is just one example, while some other formats are possible. The reference consists of a special character, i.e., the ‘$’ symbol, followed by the fields in FIG. 7A3, as illustrated in the first row of FIG. 7A3. The rest of FIG. 7A3 describes each field of the reference in detail.

To take advantage of the distributed processing to analyze massive amount of data, we invented a way to partition the computational requirements to build and update a model such that multiple servers can be used. Such a server is known as a compute node, or compute node server.

Each pivot frame can be handled by a different compute node. However, extending calculation type for this invention gives the user greater control while using an existing process. A software embodiment of the invention may estimate the number of cells included in a calculation type and warns the users if the number exceeds the computing capacity of a compute node so that the user may assign some of the cells to a different calculation type.

Referring to FIG. 7B1 and FIG. 7B2, an initial step is a request to get the value of a cell [1001], let us call it cell “C”, in a cell dimension of a pivot frame. Values of cells in a non-cell dimension in a pivot frame will be computed using other procedures.

Next, the Calculation Type of cell C is characterized as CT [1002]. The compute node that handles the CT is identified and designated CN [1003]. A request is sent to CN to compute a value for cell “C” [1004]. CN returns the value of cell “C” and the value is returned to the original requester [1005].

In this invention, one or multiple cache servers can cache the value of a cell in the cell dimension of a pivot frame, eliminating the need to perform calculation of the cell. This allows for analysess of large amounts of data while maximizing performance.

A software cache is commonly used in software programs. It can be implemented as a hash table, a tree, or other data structures. The purpose of a cache is to store units of data, typically in the form of key and a value. All of the keys in a cache must be unique—that is, only one value can be associated with a single key, and the value can be anything that the software implementation of the cache can handle.

Caching routines and libraries would typically provide functions to add an entry, lookup an entry given a key, and removing an entry. Additional routines might be provided.

In this invention, we combine caching with the compute node and improve the response time of a compute node significantly.

The cache can be located in the same processing unit of the compute node, or it can be located in a separate cache server. In the latter scenario, a cache server can cache cell values for multiple compute nodes. The decision (of which approach to take) depends on the system characteristics, and other factors of the implementation.

To cache a value, a unique key is constructed, which is the first step in FIG. 7C2. Next, the key is checked to see if it exists in the cache [1002]. If the cache is managed by a cache server, then a request is sent to the cache server. Otherwise, the cache in the compute node checks to see if the key exists. If the key does not exist, the cell value is calculated. In step 4, the computed value is stored in the cache [1004]. In the final step, the cached value is returned [1005].

One or more users may require the ability to replicate a model or set of models and manage in one control system and may also require the ability to combine different models to generate a complete dataset. We have invented a way for the user to replicate a version or versions of a branch by mirroring and recreating the same user-initiated commands or list of actions in an instance that built the contents of the original branch. The original branch is referred to as a parent branch, and a copy is referred to as a child branch. A child branch reflects actions of the parent branch at the point where branching occurred.

FIG. 8A1 describes the method by which a versions and sub-versions are created within in an Instance. FIG. 8A2 illustrates a list of Actions of a Branch 8A2001-2006. Note that each Actions specifies the Model and Table.

FIG. 8A3 illustrates the Table and each Branch Action of FIG. 8A2. Creating a Child Branch 8A1005 will take the list of actions created inside of a parent branch and copy the list of actions to a new child branch. FIG. 8A4 illustrates the list of actions of this child branch. Note that this is a copy of FIG. 8A2, but functions as its own branch with a list of actions called “Child Branch.” FIG. 8A5 illustrates the table generated from performing the actions of this Child Branch 8A4001-4006.

In one embodiment of this invention, a user may want to create a child branch for development purposes, with the intent that the parent branch is unaffected by user changes. FIG. 8A6 illustrates the list of actions of the child branch, which is replicated from the parent branch, and in which a user makes updates to the records of the “IS” Table 8A6008-6010.

FIG. 8A7 illustrates the list of Actions of the parent that is performed again in the child branch 8A6001-6006. FIG. 8A8 illustrates the Actions performed on the table that relates to the record changes of the “IS” table of the Child Branch 8A6007-6009. Note that the parent branch will remain unchanged and FIG. 8A5 illustrates the “IS” table as created through the actions of the parent branch.

In another embodiment of this invention, a user may want to create an additional child branch from another child branch. FIG. 8A9 illustrates actions of a new child branch called “Child Branch 2” from its parent branch, “Child Branch.” The other user creates further Actions to make updates to the records of the “IS” Table.

“Parent Branch”, “Child Branch”, and “Child Branch 2” all are separate lines of development with the same set of actions up until the point a user requests a Branch. FIG. 8A10 illustrates the tree associated with branching and the associated list of actions for each branch.

In another embodiment of this invention, a user may want to create a secondary child branch from the parent branch. FIG. 8A11 illustrates the creation of a sibling branch and the tree associated with branching and the associated list of actions for each branch.

When one or more users provides different actions, there are many cases in which they may make a mistake or decide to correct an action that causes inefficiency but are limited in their current software application to undoing only the actions that have taken place during their current session, or only undo a limited number of actions in total. We have invented a way for the user to manipulate past actions of an instance by removing, replacing, or editing the user-initiated commands or list of actions that generate the contents of a branch. Our invention enables user to change parameters of past Actions, rebuild a branch while ignoring a “removed” action, or actions.

FIG. 8B1 describes the method by which a user can modify past Actions of an Instance. FIG. 8B2 illustrates a list of actions of an instance a user may initiate inside of Parent Branch 8B2001-2003. Note that each action specifies the model and table in which they are occurring. As changing the list of actions in a branch may cause corruption due to dependencies of each action 8B1005, the user will stop the branch to make any changes. Once user modification is complete 8B1006, the user may start the Branch 8B1006, which will rerun each Action of the Branch sequentially with the specified changes.

In one embodiment of this invention, a user may want to edit the parameters, formula, or value of an action or multiple actions of another user. FIG. 8A2 illustrates the Actions of “Parent Branch,” where the user may want to change the name of all department records; for them to be written out instead of utilizing abbreviations. The user may accomplish such changes by stopping the branch, selecting each action ID individually, and modifying the intended values.

FIG. 8B2 illustrates the modifications to record values 8A2004-2006 of FIG. 8A2. FIG. 8B3 illustrates the modified list of actions and FIG. 8B4 illustrates the new table resulting from restarting the “Parent Branch”. Note that in this example, only the value is changed, but this invention is not limited to only changes to values, as the user may update any part of an action.

In another embodiment of this invention, a user may wish to remove a specific action from the list of actions by flagging it for removal. FIG. 8B5 illustrates a list of actions from a Branch with an action flagged for removal 8B5007. FIG. 8B6 illustrates the resulting table after stopping and restarting the parent branch. Note that the branch ignores any actions that are flagged for removal, but this method alone does not actually remove the flagged action from the list.

In another embodiment of this invention, a user may want to remove multiple actions from the list by flagging the items intended for removal. FIG. 8B7 illustrates a list of actions with multiple actions flagged for removal 8B7007-7009. FIG. 8B8 illustrates the resulting table after stopping and restarting the parent branch. Note that the branch ignores any actions that are flagged for removal, but that this method alone does not actually remove the flagged action from the list of actions.

We have invented a method for the user to go back to a specific action and point in time of a branch, by specifying an action ID associated with a timestamp. The user will specify the action ID, and, upon restart of this branch, the branch will ignore subsequent action IDs that occur after this selection.

FIG. 8C1 describes the method by which a user can revert to a specified point in time. FIG. 8C2 illustrates a list of actions of a branch 8C1001-1004. The user may stop the branch and select the desired Action ID to revert to 8C1005. The user may restart the branch, which will rerun each action until the selected Action ID and flag each subsequent action for removal, thus ignoring them while actions are rerun. FIG. 8C3 illustrates the table of the branch before an action ID is chosen.

In one embodiment of this invention, a user may select an action created the previous day and revert back to the point in which the selected action is the latest. In one example of this embodiment, the last action for the previous day is Action ID “5” 8C4006. The user would select that Action ID, stop the branch, and rerun the branch. FIG. 8C4 illustrates the resulting list of actions for the branch. Note the following actions after Action ID “5” is now flagged for remove 8C4007-4009. FIG. 8C5 illustrates the table of the branch after an action ID is chosen.

We have invented a way for the user to merge child branches to parent branches by looking at the differences between the list of actions and inserting those differences into the parent branch.

FIG. 8E1 describes the method by which a user can merge a child branch into a parent branch. FIG. 8E2 illustrates the tree of child branches with the related list of actions for each branch.

In one embodiment of this invention, a user may want to merge a child branch to its parent, in which the parent is a child branch of the root parent branch. FIG. 8E1 illustrates the user merging a Child Branch to its Parent 8E1007. In this example “Child Branch” is the parent and “Child Branch 2” is its child. Comparing the list of Actions in FIG. 8A4 and FIG. 8A6, “Child Branch 2” has an additional three actions not created in its parent, “Child Branch,” prior to merge.

FIG. 8A7 and FIG. 8A2 are compared for differences in actions upon merge 8E1007, in which 8A9007-9009 illustrates the differences between the compared lists, and those Actions are added to “Child Branch.” FIG. 8E3 illustrates the updated Parent Branch (“Child Branch”) list of actions. Note that 8E3007-3009 are the new actions from the merged “Child Branch 2”.

FIG. 8E4 illustrates the updated tree after the merge of “Child Branch 2” into its parent, “Child Branch.” Note that “Child Branch 2” is no longer present in the tree, as the “Child Branch 2” has been merged with the parent. FIG. 8E3 is now the resulting list of actions for “Child Branch.”

In another embodiment of this invention, a user may want to merge a child branch into its parent, upon merge of its own relevant children. FIG. 8E2 illustrates a child branch merging its own children into one branch, and FIG. 8E5 illustrates the child branch then merging to its parent. 8E5001 illustrates the user merging 8E1007 a child branch to its parent. In this example, “Parent Branch” is the parent, and “Child Branch” is the child. Comparing the list of actions FIG. 8A2 and FIG. 8A3, “Child Branch” has an additional three actions not found in “Parent Branch,” prior to merge.

FIG. 8E6 illustrates the updated tree after the merge of “Child Branch.” Note that “Child Branch” is no longer present in the tree, as the “Child Branch” has been merged into its parent. FIG. 8E3 is now the resulting list of actions for “Parent Branch.”

As a user builds a model using the pivot frame software, they will inadvertently introduce mistakes that are corrected or introduce inefficient ways of doing things. For example, a user may create a table, change their minds, and then delete the table. As such, any sequence of actions may contain redundant actions, inefficient sequence, etc. All of these activities are recorded in the list of actions so that the list may be edited and replayed later to reconstruct the model.

It is desirable to eliminate inefficiency in a list of actions so that when a model is recreated by replaying a list of actions, it would be as efficient as possible.

Replaying a list of Actions would produce a model identical to the one created originally by the user. Given a list of actions, we can examine the list of actions and make changes including:
1. Removing an action.
2. Moving an action from one location on the list to another.
3. Changing an action.

The goals of such changes are that replaying the changed list takes less time to run than without any of those changes, and that replaying the changed list produces a final model that is exactly the same as defined in the original list. The fundamental axiom is that as long as changing an action does not change the final model, even if the intermediate models are different, the change is acceptable. This is similar to optimizing a set of instructions performed by a computer language compiler.

These optimizations can be done when the user invokes a command to optimize the actions, or through other conditions and mechanisms.

In FIG. 8F2 the first step is to start with a list of Actions [1001]. Optimizations are performed on the list. The specific optimizations are listed in In FIG. 8F3:
FIG. 8F3 Opt. 1, if an action is between a table creation and a table deletion, and that it has no effect on the final model, then it can be removed. Additionally, if there are no actions left between a table creation and a table deletion, then both of those two actions can be deleted.
FIG. 8F3 Opt. 2, if there are multiple data uploads to a data table, and if there are no actions between the uploads that would affect the final model, then the uploads can be merged into a single upload.
The data for each upload action must be merged in order so the resulting data table appears exactly the same.
FIG. 8F3 Opt. 3, if there are multiple actions that set user-provided values onto the same table, they can be merged into a single action that sets multiple values at once as long as the final model is unchanged.
In a typical software embodiment of the pivot frame inventions, the UI usually allows the user to update one cell at a time, and their corresponding actions can possibly be merged into a single action.
FIG. 8F3 Opt. 4, there are Actions that do not contribute to the structure or content of the model can be moved to another location in the action list, i.e., to the end, or optionally be run in a separate programming thread since it does not affect the data that is displayed to the users.

In FIG. 8F2 Step 3, the original action list is replaced by the optimized list.
In sum, embodiments of the invention can be characterized as follows.
1. Pivot frames are disclosed.
2. They look like pivot tables, but you can put formulas conditionally inside of them—e.g., “where department=R&D and line=revenue the formula should be x+y*z”.
3. These formulas can reference data within the pivot table itself, other regular tables, or other “pivot frames”.
4. The challenge in doing this in the prior art is that the computation becomes very slow.
5. We noticed that in analytical models a lot of the data is the result of some formula. It is estimated that approximately 90% of cells in a model are the result of a formula versus provided by the user as assumptions or from a CSV file.
6. The disclosed technology allows one to define a pivot table that is arbitrarily large in terms of number of dimensions and total rows and columns. We have made pivot tables that are 60 mm by 60 mm cells with >1 trillion underlying cells.
7. The fact that the underlying number of cells is >1 trillion does not matter. It could be 10 or 1 trillion—the computation speed is the same O(1). We generate any portion of both pivot tables in essentially the same time.
8. This is very useful.
9. The way to think about it is compression:
   1. We basically take a pivot table of arbitrarily large dimensions and describe it in the smallest way possible—what are the reference tables that corresponds to pivot headings, and what are the formulas and where are they supposed to be placed—that's it.
   2. We have created a data structure and corresponding set of algorithms that allows us to “decompress” any portion of that pivot table in O(1) time.
   3. So, if a table has 1 trillion underlying cells, and if we know the information in step 1, any given cell at any location and an answer is provided in O(1) time.
10. The way we achieve this is:
   1. We observe that a pivot table can be represented as a table with records.
   2. We observe that if we represent a pivot table as a table with records, and if we sort the columns by a deterministic algorithm (as simple as alphabetical), a pattern emerges for the indexes of each value in the columns that correspond to a pivot dimension. This pattern is the Cartesian product of the lengths of the reference tables of each pivot dimension.
   3. We also noticed that we do not need to calculate the Cartesian product—we only need to know that the pattern exists.
   4. We can obtain any portion of an arbitrarily large pivot table with simple arithmetic.
   5. We can filter the pivot table with simple arithmetic.
   6. The formulas in the pivot table can reference cells in other pivot tables extremely fast using only simple arithmetic.
11. So, we were able to make all of the key parts fast:
   1. Representing any portion of a pivot table.
   2. Filtering a pivot table.
   3. Having formulas in a pivot table that reference cells in other pivot tables.
12. The data structure we solved for is the “pivot frame” and its dual representation as a pivot table or a data table with records.
13. The algorithms we solved for relate to:
   1. Referencing a cell (from row and column to record index, record index to row and column, pivot dimension record indexes to record index and so on).
   2. Filtering pivot tables.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A non-transitory computer readable storage medium with instructions executed by a processor to:
ingest source data tables received from a network connected source data machine;
derive from the source data tables a pivot frame with
(1) an index column with index column values representing each unique combination of records in the source data tables,
(2) pivot dimension columns forming a deterministic matrix where each row of the deterministic matrix represents a unique combination of records in the source data tables, and
(3) a value column with individual values assigned to corresponding index column values;
receive a definition of a desired pivot table from a network connected client machine;
retrieve from the pivot frame pivot values that fulfill the definition of the desired pivot table to form a pivot table with unique pivot table row and column values;
associate the index column values with the unique pivot table row and column values; and
supply the pivot table to the network connected client machine.

2. The non-transitory computer readable storage medium of claim 1 wherein the pivot frame table includes conditional formulas.

3. The non-transitory computer readable storage medium of claim 1 wherein the pivot frame table includes conditional objects.

4. The non-transitory computer readable storage medium of claim 1 wherein the conditional objects include a style definition.

5. The non-transitory computer readable storage medium of claim 1 wherein the conditional objects include a format definition.

6. The non-transitory computer readable storage medium of claim 1 wherein the conditional objects include a task definition.

7. The non-transitory computer readable storage medium of claim 1 wherein the conditional objects include a permission definition.

8. The non-transitory computer readable storage medium of claim 1 wherein the conditional objects include a graph.

9. The non-transitory computer readable storage medium of claim 1 wherein the conditional objects include validated data.

10. The non-transitory computer readable storage medium of claim 1 wherein the operation to retrieve from the pivot frame pivot table values utilizes cartesian product processing.

11. The non-transitory computer readable storage medium of claim 1 wherein the operation to retrieve from the pivot frame pivot table values utilizes matrix multiplication.

12. The non-transitory computer readable storage medium of claim 1 further comprising instructions executed by the processor to form first mappings between pivot table headings and pivot frame index column values.

13. The non-transitory computer readable storage medium of claim 10 further comprising instructions executed by the processor to form second mappings between pivot table headings and pivot dimension columns.

14. The non-transitory computer readable storage medium of claim 11 wherein the operation to form first mappings and second mappings utilizes multiplication.

15. The non-transitory computer readable storage medium of claim 11 wherein the operation to form first mappings and second mappings utilizes addition.

16. The non-transitory computer readable storage medium of claim 11 wherein the operation to form first mappings and second mappings utilizes a modulo operation.

17. The non-transitory computer readable storage medium of claim 11 wherein the operation to form first mappings and second mappings utilizes subtraction.

18. The non-transitory computer readable storage medium of claim 11 wherein the operation to form first mappings and second mappings utilizes division.

19. The non-transitory computer readable storage medium of claim 11 wherein the operation to form first mappings and second mappings utilizes a whole number with any associated fraction removed therefrom.

20. The non-transitory computer readable storage medium of claim 1 further comprising instructions executed by the processor to access a selected cell in the pivot table, where the selected cell references another cell or set of cells in another table.

21. The non-transitory computer readable storage medium of claim 1 further comprising instructions executed by the processor to filter the pivot table.

22. The non-transitory computer readable storage medium of claim 1 further comprising instructions executed by the processor to create linked pivot dimensions with values dependent upon pivot dimensions.

23. The non-transitory computer readable storage medium of claim 1 further comprising instructions executed by the processor to sort data in the pivot frame using a specified column dimension.

24. The non-transitory computer readable storage medium of claim 1 further comprising instructions executed by the processor to a derive a parent branch and a child branch.
